(19) United States
(12) Patent Application Publication
(10) Pub. No.: US 2010/0143616 A1
(43) Pub. Date: Jun. 10, 2010

(54) HEAT-SENSITIVE TRANSFER IMAGE-RECEIVING SHEET AND METHOD OF PRODUCING THE SAME

(75) Inventors: Ryuji Shinohara, Minami-ashigara-shi (JP); Hiroshi Takehara, Minami-ashigara-shi (JP); Kazuaki Oguma, Minami-ashigara-shi (JP); Takuya Arai, Minami-ashigara-shi (JP); Yoshio Ishii, Minami-ashigara-shi (JP); Yoshihisa Tsukada, Minami-ashigara-shi (JP); Hisashi Mikoshiba, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/996,769

(22) PCT Filed: Jul. 25, 2006
(86) PCT No.: PCT/JP2006/315094

§ 371 Date: Apr. 25, 2008

(30) Foreign Application Priority Data
Jul. 25, 2005 (JP) 2005-215040
Jul. 26, 2005 (JP) 2005-216078
Jul. 27, 2005 (JP) 2005-217593
Sep. 5, 2005 (JP) 2005-256698

(51) Int. Cl. B41M 5/52; B05D 3/00; B32B 37/00

(52) U.S. Cl. 428/32.5; 428/32.39; 427/385.5; 156/60

(57) ABSTRACT

A heat-sensitive transfer image-receiving sheet having a receptor layer comprising: (a) a polymer or latex polymer including a unit having ultraviolet absorbing ability, or (b) a latex polymer and a water-soluble polymer; and a method of producing the same.

### TECHNICAL FIELD

The present invention relates to a heat-sensitive transfer image-receiving sheet used by superposing it on a heat-sensitive transfer sheet (ink sheet) containing dyes. Particularly, the present invention relates to a heat-sensitive transfer image-receiving sheet having high image fastness. Further, the present invention relates to a heat-sensitive transfer image-receiving sheet that is reduced in transferability changes over time, and that can form a recording image reduced in variation of transferred image over time. Further, the present invention relates to a heat-sensitive transfer image-receiving sheet that has high sensitivity and is free from image defects. Further, the present invention relates to a method of producing the heat-sensitive transfer image-receiving sheet.

### BACKGROUND ART

Various heat transfer recording methods have been known so far. Among these methods, dye diffusive transfer recording systems attract remarkable attention as a process that can produce a color hard copy having image qualities closest to that of silver salt photography (see, for example, “Information Recording (hard copy) and New Development of Recording Materials” published by Toray Research Center Inc., 1993, pp. 241-285; and “Development of Printer Material” published by CMC Publishing Co., Ltd., 1995, p. 180). This system is also more advantageous than silver salt photography, because it is a dry system, it enables direct visualization from digital data, and it makes reproduction simply.

In this dye diffusive transfer recording system, a heat-sensitive transfer sheet (hereinafter referred to as an ink sheet) containing dyes is superposed on a heat-sensitive transfer image-receiving sheet (hereinafter referred to also as an image-receiving sheet), and then the ink sheet is heated by a thermal head exothermically controlled by electric signals, in order to transfer the dyes contained in the ink sheet to the image-receiving sheet, thereby recording image information. Three colors: cyan, magenta, and yellow, are used by being overlapped onto one other to record, thereby enabling transferring and recording a color image having continuous variations in color densities.

However, current heat-sensitive transfer image-receiving sheets have the problem that they are deteriorated in the light resistance of an image transferred thereto, so that the visibility of the transferred image is deteriorated during storage, and therefore, no beautiful image can be maintained for a long period of time. This is because a large amount of dye exists in the vicinity of the surface of a receptor layer, and is therefore adversely affected by light with ease. To solve such a problem, for example, JP-A-2-141287 (“JP-A” means unexamined published Japanese patent publication) discloses a method in which a releasing agent layer, containing an ultraviolet absorber and stabilizing agents such as an antioxidant, is formed on the surface of a dye receptor layer of an image-receiving sheet. However, such a method, in which an ultraviolet absorber is simply added to a dye receptor layer, has the problem that the stabilizing agent bleeds out and is lost, or the agent is transferred to the ink sheet when the dyes are transferred, or the agent is volatized or decomposed by heat, with the result that the effect of the agent is reduced with time.

Also, in currently used heat-sensitive transfer image-receiving sheet, a polyester resin having good capability of being dyed is used in the dye receiving layer, but it has some problems. When a transfer operation is carried out under heating using a thermal head, the so-called fusing phenomenon: of the ink sheet sticking to the image-receiving sheet, occurs, and the ink sheet tends to stick to the image-receiving sheet, which causes line defects (sticking) on the surface of the image-receiving sheet when the ink sheet is peeled off, and color bleeding of an image occurs when the image is stored under a high-temperature and high-humidity condition. To solve such a problem, there are, for example, disclosures in JP-A-6-166272 or JP-A-7-40670, in which a dyeing resin, comprising a polyester resin and a vinyl chloride/vinyl acetate copolymer in a fixed ratio, or a vinyl chloride/styrene type copolymer, is used. However, the image-receiving sheet disclosed in these references has failed to solve the above problem concerning light resistance.

On the other hand, an example of fields in which new applications of this dye diffusive transfer recording system are being developed, is that of heat transfer recording labels, or heat transfer recording tags, for use in POS (Point Of Sales) systems. It is relatively unusual for this system to be used in severe conditions for a long period of time, in current food label applications and cloth tag applications. However, opportunities to use this system have increased in distribution management applications such as delivery labels and air baggage tags, and it is demanded of this system to enable precise recording of, for example, bar codes, and to provide a high-quality image. Also, it is desired to improve the paper strength of heat transfer recording image-receiving paper, because there is the case in which a recording material is exposed to severe conditions.

JP-A-6-336089 discloses that crepe paper or extensible paper is used as a support of the image-receiving sheet. However, when this crepe paper or extensible paper is used as the support, there is the problem that moisture is absorbed in the paper during the course of the process from coating step to drying step, and also the moisture remains in the paper after the paper is dried, causing a reduction in the sharpness of a receptor layer over time.

On the other hand, general paper may be used for the support of an image-receiving sheet in this dye diffusive transfer recording system, and it enables the image-receiving sheet to be produced at low costs. In an image-receiving sheet using such paper as the support, a layer having high cushion properties, such as a foaming layer made of for instance a resin and a foaming agent, is formed between the support and a receptor layer, to provide cushion properties, thereby improving the adhesion between an image-receiving sheet and an ink sheet. Also, an intermediate layer is further formed between this foam layer and the receptor layer, to prevent the foam layer from being broken by heating during printing. However, there are some problems in current image-receiving sheets because this intermediate layer is formed using an organic-solvent-type resin coating solution. The problems are that this coating solution breaks down air cells and voids in the foam layer, and therefore, desired cushion properties are not obtained, resulting in voids and density unevenness in the formation of an image, and also causing a reduction in the heat insulation of the foam layer, so that the calories required to transfer dyes are diffused in the direction of the backside of the image-receiving sheet, bringing about a reduction in sensitivity in printing.

For example, JP-A-8-25813 discloses that an aqueous-type coating solution is used to form an intermediate layer between a foam layer and a receptor layer, to utilize subtle irregularities of the foam layer as it is, as the surface form of the receptor layer. However, in this method, the receptor is applied, after the foam layer is applied on a support and then dried under heating, so that irregularities are formed on the surface of the receptor layer. Therefore, not only do many image defects arise but also the receptor layer has insufficient sensitivity and is expensive. Also, JP-A-11-321128 discloses that an intermediate layer containing, as its major components, hollow particles and a polymer resistant to an organic solvent, is formed between a support and a receptor layer, and also, JP-A-5-147364 discloses that a resin layer including a dye receptor layer is made to contain a hollow capsule. In these methods, however, the receptor layer is likewise applied after the intermediate layer and the resin layer are applied and dried under heating, and therefore, there is the problem that the not only do many image defects arise but also the receptor layer has insufficient sensitivity and is expensive.

### DISCLOSURE OF INVENTION

The present invention contemplates to provide a heat-sensitive transfer image-receiving sheet superior in image fastness and light resistance.

Further, the present invention contemplates to provide a heat-sensitive transfer image-receiving sheet that is reduced in transferability changes over time, and that can form a recording image reduced in variation of transferred image over time.

Further, the present invention contemplates to provide a heat-sensitive transfer image-receiving sheet that is highly sensitive and is free from image defects at low costs.

The inventors of the present invention have made earnest studies and, as a result, found that it is possible to prevent an ultraviolet absorber from bleeding out and being transferred to an ink sheet when transferring dyes, by compounding a polymer containing a unit ultraviolet absorbing ability in a receptor layer. The inventors have also found that image fastness and light resistance can be improved while preventing an ultraviolet absorber from being transferred to an ink sheet, by compounding a polymer or latex polymer less capable of being dyed comprising a unit having ultraviolet absorbing ability and a receptor polymer or latex polymer capable of being dyed in a receptor layer.

Further, the inventors of the present invention have found that the absorption of water in a support is prevented by using a waterproof material as the support, and the sharpness of an image over time can be stabilized by allowing a latex polymer and a water-soluble polymer to coexist in the receptor layer.

Further, the inventors of the present invention have found that a heat-sensitive transfer image-receiving sheet can be formed without any formation of irregularities on the surface of a receptor layer by applying at least one intermediate layer and the receptor layer on a support simultaneously as a multilayer, whereby an image-receiving sheet that has high sensitivity and is free from image defects can be formed at low costs.

The present inventions have been completed based on these findings.

According to the present invention, there is provided the following means:

(1) A heat-sensitive transfer image-receiving sheet having a receptor layer comprising:

(a) a polymer or latex polymer including a unit having ultraviolet absorbing ability, or

(b) a latex polymer and a water-soluble polymer.

(2) The heat-sensitive transfer image-receiving sheet according to the above item (1), wherein the receptor layer comprises the polymer including the unit having ultraviolet absorbing ability.
(3) The heat-sensitive transfer image-receiving sheet according to the above item (1), wherein the receptor layer comprises the polymer including the unit having an ultraviolet absorbing ability and a receptor polymer capable of being dyed.
(4) The heat-sensitive transfer image-receiving sheet according to the above item (3), wherein the receptor polymer capable of being dyed is a polymer comprising a vinyl chloride repeating unit as a main chain.
(5) The heat-sensitive transfer image-receiving sheet according to the above item (1), wherein the receptor layer comprises the latex polymer including the unit having ultraviolet absorbing ability and a receptor latex polymer capable of being dyed.
(6) The heat-sensitive transfer image-receiving sheet according to the above item (5), wherein the latex polymer including the unit having ultraviolet absorbing ability has a repeating unit less capable of being dyed than the receptor latex polymer capable of being dyed.
(7) The heat-sensitive transfer image-receiving sheet according to the above item (5), wherein the receptor latex polymer capable of being dyed is a latex polymer comprising a vinyl chloride repeating unit as a main chain.
(8) The heat-sensitive transfer image-receiving sheet according to the above item (1), wherein at least one said receptor layer comprising the latex polymer and the water-soluble polymer is formed on a waterproof support by application.
(9) The heat-sensitive transfer image-receiving sheet according to the above item (8), wherein the ratio of the water-soluble polymer is 30% by mass or less of all polymers contained in the receptor layer.
(10) The heat-sensitive transfer image-receiving sheet according to the above item (8), wherein a drying temperature of the heat-sensitive transfer image-receiving sheet after the application is Minimum Filmforming Temperature (MFT) or less.
(11) The heat-sensitive transfer image-receiving sheet according to the above item (8), wherein a coating layer formed on the support by application is hardened with a hardener.
(12) The heat-sensitive transfer image-receiving sheet according to the above item (8), wherein a coating layer formed on the support by application contains an emulsion.
(13) A heat-sensitive transfer image-receiving sheet comprising a support and at least one intermediate layer and a receptor layer which are formed in this order on the support, wherein the sheet is formed by applying the intermediate layer and the receptor layer simultaneously as a multilayer on the support.
(14) The heat-sensitive transfer image-receiving sheet according to the above item (13), wherein the intermediate layer contains a hollow polymer having a particle diameter of 0.1 to 20 μm.
(15) A method of producing a heat-sensitive transfer image-receiving sheet, the method comprising forming a receptor layer on a support by applying the following mixture (a) or (b):

(a) a mixture of a latex prepared by suspending a polymer containing a unit having ultraviolet absorbing ability in water, and a latex prepared by suspending a receptor polymer capable of being dyed in water, or

(b) a mixture prepared by dissolving a polymer containing a unit having ultraviolet absorbing ability and a receptor polymer capable of being dyed, in a solvent.

(16) The method of producing a heat-sensitive transfer image-receiving sheet according to the above item (15), the method comprising preparing a latex by suspending the polymer containing a unit having ultraviolet absorbing ability in water, while preparing other latex by suspending the receptor polymer capable of being dyed in water, and applying a mixture of both latexes on the support to form the receptor layer.
(17) The method of producing a heat-sensitive transfer image-receiving sheet according to the above item (15), the method comprising forming the receptor layer on the support by applying a mixture prepared by dissolving the polymer including a unit having an ultraviolet absorbing ability and the receptor polymer capable of being dyed, in a solvent.
(18) A method of producing a heat-sensitive transfer image-receiving sheet, the method comprising the steps:

applying a coating solution comprising a latex polymer and a water-soluble polymer, on a water proof support to form at least one receptor layer, and

drying the heat-sensitive transter image-receiving sheet after at least one rceptor layer is formed by application on the support at a temperature of Minimum Filmforming Temperature (MET) or less.

(19) The method of producing a heat-sensitive transfer image-receiving sheet according to the above item (18), wherein a hardener is added to the coating solution to be applied.
(20) The method of producing a heat-sensitive transfer image-receiving sheet according to the above item (18), wherein the coating solution contains an emulsion dispersion, and the coating solution is applied on the support.
(21) A method of producing a heat-sensitive transfer image-receiving sheet, the method comprising applying at least one intermediate layer and a receptor layer simultaneously as a multilayer on a support.

(Hereinafter, a first embodiment of the present invention means to include the heat-sensitive transfer image-receiving sheet and the method of producing a heat-sensitive transfer image-receiving sheet described in the items (2), (5) to (7), and (16) above.

A second embodiment of the present invention means to include the heat-sensitive transfer image-receiving sheet and the method of producing a heat-sensitive transfer image-receiving sheet described in the items (8) to (12), and (18) to (20) above.

A third embodiment of the present invention means to include the heat-sensitive transfer image-receiving sheet and the method of producing a heat-sensitive transfer image-receiving sheet described in the items (13), (14), and (21) above.

A fourth embodiment of the present invention means to include the heat-sensitive transfer image-receiving sheet and the method of producing a heat-sensitive transfer image-receiving sheet described in the items (3), (4), and (17) above.)

In the explanation of the embodiments in this specification, the description for one of the above first, second, third and forth embodiments can be applied to other embodiments, unless otherwise specified.

In the present invention, preferably in the first or fourth embodiment of the present invention, the “unit having ultraviolet absorbing ability” means a compound having ultraviolet absorbing ability and a structure containing a part of the compound.

Other and further features and advantages of the invention will appear more fully from the following description.

### BEST MODE FOR CARRYING OUT THE INVENTION

The present invention will be explained in detail.

The heat-sensitive transfer image-receiving sheet of the present invention is provided with a dye receiving layer (receptor layer) formed on a support. It is preferable to form an undercoat layer between the receptor layer and the support. As the undercoat layer, for example, a white background control layer, a charge control layer, an adhesive layer and a primer layer are formed. Also, a heat insulation layer is preferably formed between the undercoat layer and the support. In the present invention, preferably in the third embodiment of the present invention, each layer interposed between the support and the receptor layer is simply called “intermediate layer”, which includes the foregoing undercoat layer and heat insulation layer. The heat-sensitive transfer image-receiving sheet of the present invention, preferably the third embodiment of the present invention, comprises at least one receptor layer and at least one intermediate layer. Moreover, it is preferable that a curling control layer, a writing layer and a charge control layer are formed on the backside of the support. Each layer is applied using a usual method such as roll coating, bar coating, gravure coating and gravure reverse coating.

### (Receptor Layer)

The receptor layer serves to receive dyes transferred from an ink sheet and to maintain an image formed by these dyes. Therefore, a resin that is easily dyed (dyeability receiving polymer, or a receptor polymer capable of being dyed) is used in the receptor layer. As these resins of the receptor layer, following compounds may be used either singly or as mixtures though the present invention is not limited to following compounds: polyolefin resins such as polyethylenes and polypropylenes; halogenated resins such as polyvinyl chlorides and polyvinylidene chlorides; vinyl-series resins such as polyvinyl acetates and polyacrylates, and their copolymers; polyester-series resins such as polyethylene terephthalates and polybutylene terephthalates; polystyrene-series resins; polyamide-series resins; polycarbonates; phenol resins; polyurethanes; epoxy resins; polysulfones; butyral resins; melamine resins; polyvinyl alcohols; copolymers of olefins, such as ethylenes and propylenes, and other vinyl type monomers; vinyl chloride/vinyl acetate copolymers; styrene/acryl copolymers; ionomers; cellulose resins; natural rubbers; and synthetic rubbers. In the present invention, polymers having a vinyl chloride repealing unit as a main chain are particularly preferable. The receptor polymer used in the receptor layer may be a latex polymer, the latex polymer can be prepared from the foregoing compounds.

The degree of capability of being dyed is defined as follows. Four colors, specifically, yellow, magenta, cyan and black are output so as to form a solid image having 256 gradations on an image-receiving sheet, and the reflection density of the resulting image is measured to define a polymer providing an image having the highest reflection density as a receptor polymer having good capability of being dyed. It is necessary to pay special attention to the capability of being dyed of the receptor polymer because it varies depending on the type of printer and the type of ink sheet.

### <Ultraviolet Absorber>

Also, in order to improve light resistance in the present invention, preferably in the first or fourth embodiment of the present invention, a polymer containing a unit having an ultraviolet absorbing ability is preferably added to the receptor layer. Here, the unit having ultraviolet absorbing ability means a partial structure having ultraviolet absorbing ability. A partial structural formula of the partial structure having ultraviolet absorbing ability is known as a partial structure absorbing ultraviolet rays in an ultraviolet absorber. In the present invention, preferably in the third embodiment of the present invention, an ultraviolet absorber may be added to the receptor layer to improve ligh resistance. If this ultraviolet absorber is made to have a higher molecular weight, it can be secured to a receptor layer so that it can be prevented, for instance, from being diffused into an ink sheet and from being sublimated and vaporized by heating.

As the ultraviolet absorber, compounds having various ultraviolet absorber skeletons, which are widely used in information recording fields, may be used. Specific examples of the ultraviolet absorber may include compounds having a 2-hydroxybenzotriazole type ultraviolet absorber, 2-hydroxybenzotriazine type ultraviolet absorber or 2-hydroxybenzophenon type ultraviolet absorber skeleton. Compounds having a benzotriazole-type or a triazine-type skeleton are preferable from the viewpoint of ultraviolet absorbing ability (absorption coefficient) and stability, and compounds having a benzotriazole-type or benzophenone-type skeleton are preferable from the viewpoint of obtaining a higher-molecular weight and using in a form of a latex. Specifically, ultraviolet absorbers described, for example in JP-A-2004-361936 may be used.

The ultraviolet absorber preferably absorbs light at wavelengths in the ultraviolet region, and the absorption edge of the absorption of the ultraviolet absorber is preferably out of the visible region. Specifically, when it is added in the receptor layer to form a heat-sensitive transfer image-receiving sheet, the heat-sensitive transfer image-receiving sheet has a reflection density of, preferably, Abs 0.5 or more at 370 nm, and more preferably Abs 0.5 or more at 380 nm. Also, the heat-sensitive transfer image-receiving sheet has a reflection density of, preferably, Abs 0.1 or less at 400 nm. If the reflection density at a wavelength range exceeding 400 nm is high, it is not preferable because an image is made yellowish.

In the present invention, preferably in the first or fourth embodiment of the present invention, the ultraviolet absorber is preferably made to have a higher molecular weight. The ultraviolet absorber has an weight average molecular weight of preferably 10,000 or more, and more preferably 100,000 or more. As a means of obtaining a higher-molecular weight ultraviolet absorber, it is preferable to graft an ultraviolet absorber on a polymer. The term “graft” used herein means to form a covalent bond between an ultraviolet absorber compound molecule and a polymer as a principal chain, and it doesn't mean to conduct a graft polymerization of a polymer of an ultraviolet absorber compound on a polymer as a principal chain. In the present invention, preferably in the first or fourth embodiment of the present invention, the polymer preferably includes a unit having an ultraviolet absorbing ability, the ultraviolet absorber compound molecule may bond the polymer as the principal chain via a linkage group.

The polymer as the principal chain preferably has a repeating unit less capable of being dyed than the receptor polymer to be used together. Also, when the polymer is used to form a film, the film preferably has sufficient film strength. Also, the weight average molecular weight of the polymer, which is to be the principal chain, is preferably 10,000 to 1,000,000, and more preferably 20,000 to 500,000. Specific examples of the polymer, which is to be the principal chain, include, though not limited to, a polyvinyl chlorides, polyvinylidene chlorides, polyolefins, polycarbonates, polystyrenes, acryl resins, methacryl resins, polyamides, polyesters, acrylonitrile/butadiene/styrene (ABS) resins, thermoplastic polyurethane resins, vinyl chloride/vinylidene chloride/acrylonitrile copolymers, acrylonitrile/styrene (AS) resins, vinyl acetate resins, polyphenylene ethers, polysulfones, polyether sulfones, polyether ether ketones, and liquid crystal plastics.

As a method of grafting the ultraviolet absorber on the polymer which is to be the principal chain, the method described in, for example, each publication of JP-A-5-271203 and JP-A-2000-119262 can be used. The graft ratio of the ultraviolet absorber for the polymer principal chain is preferably 5 to 20% by mass and more preferably 8 to 15% by mass.

Also, it is more preferable that the polymer having an ultraviolet absorbing unit (the polymer grafted the ultraviolet absorber) is made to be used in a form of a latex. When the polymer is made to be used in a form of a latex, a water dispersion-system coating solution may be used in application and coating to form the receptor layer, leading to the possibility of cost reduction. As a method of making the latex polymer (polymer latex-wise), a method described, for example, in Japanese Patent No. 3,450,339 may be used. As the ultraviolet absorber used in a form of a latex, the following commercially available ultraviolet absorbers may be used which include ULS-700, ULS-1700, ULS-1383MA, ULS-1635 MH, XL-7016, ULS-933LP and ULS-935LH manufactured by Ipposha Oil Industries Co., Ltd.; and New Coat UVA-1025W, New Coat UVA-204W and New Coat UVA-4512M manufactured by Shin-Nakamura Chemical Co., Ltd. (all of these names are trade names).

When the polymer containing a unit having ultraviolet absorbing ability (the polymer grafted the ultraviolet absorber) is made to be used in a form of a latex, the receptor polymer capable of being dyed is likewise made to be used in a form of a latex, the both are mixed and then the mixture latex is applied, whereby a receptor layer, in which the ultraviolet absorber is uniformly dispersed, can be formed.

As the polymer ultraviolet absorber, commercially available ultraviolet absorbers may be used which include ULS-933LP, ULS-935LH and ULS-1935LH manufactured by Ipposha Oil Industries Co., Ltd.; Vanaresin UVA-1025S and Vanaresin UVA-1059G manufactured by Shin-Nakamura Chemical Co., Ltd.; and RSA-0002, RSA-0003, RSA-0005, RSA-0115, RSA-0124, RSA-0151, RSU-0017 and RSU-0115 manufactured by Yamanami Gosei Kagaku (all of these names are trade names).

The amount of the polymer containing a unit having ultraviolet absorbing ability (the polymer grafted the ultraviolet absorber) or its latex is preferably 5 to 50 parts by mass, and more preferably 10 to 30 parts by mass based on the receptor polymer capable of being dyed or its latex which are used to the receptor layer.

The polymer containing a unit having ultraviolet absorbing ability will be explained in more detail.

The polymer containing a unit having ultraviolet absorbing ability is preferably a polymer containing an ultraviolet absorber as its partial structure, and this ultraviolet absorber may be either an organic compound or an inorganic compound.

In the case of the organic ultraviolet absorber, those represented by the following Formulae (1) to (8) are preferable.

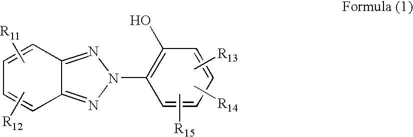

In formula (1), R₁₁, R₁₂, R₁₃, R₁₄, and R₁₅ may be the same or different and each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a Sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group.

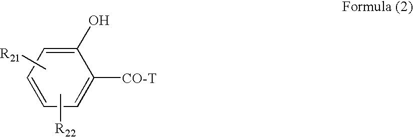

In formula (2), R₂₁ and R₂₂ may be the same or different and each independently represent a hydrogen atom, a halogen atom, an allyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group. T represents an aryl group, a heterocyclic group, or an aryloxy group. T preferably represents an aryl group.

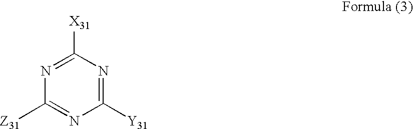

In the formula (3), X₃₁, Y₃₁ and Z₃₁ each independently represent a substituted or unsubstituted alkyl group, aryl group, alkoxy group, aryloxy group, alkylthio group, arylthio group or heterocyclic group. At least one of X₃₁, Y₃₁ and Z₃₁ represents a group represented by the following Formula (a).

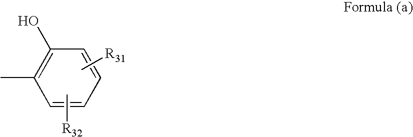

In formula (a), R₃₁ and R₃₂ each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group. Also, the neighboring R₃₁ and R₃₂ may be combined to form a ring.

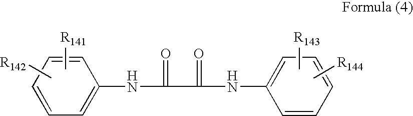

In formula (4), R₁₄₁, R₁₄₂, R₁₄₃, and R₁₄₄ each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an aryloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group.

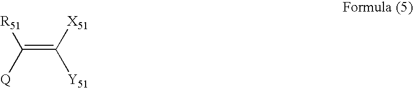

In the formula (5), Q represents an aryl group or a five- or six-membered heterocyclic group, R₅₁ represents a hydrogen atom or an alkyl group, X₅₁ and Y₅₁ respectively represent a cyano group, —COOR₅₂, —CONR₅₂R₅₃, —COR₅₂, —SO₂OR₅₂ or —SO₂NR₅₂R₅₃, wherein R₅₂ and R₅₃ respectively represent a hydrogen atom, an alkyl group or an aryl group. One among R₅₂ and R₅₃ preferably represents a hydrogen atom. Also, X₅₁ and Y₅₁ may be combined to form a five- or six-membered ring. When X₅₁ and Y₅₁ are respectively a carboxyl group, they may respectively have a salt form.

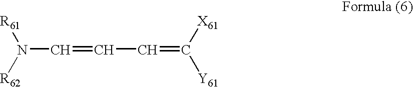

In the formula (6), R₆₁ and R₆₂ each independently represent a hydrogen atom, an alkyl group or an aryl group, or nonmetal atomic groups which are combined with each other to form a five- or six-membered ring. Also, any one of R₆₁ and R₆₂ may be combined with a methine group adjacent to the nitrogen atom to form a five- or six-membered ring. X₆₁ and Y₆₁ which may be the same or different, have the same meanings as R₅₁ and Y₅₁ respectively.

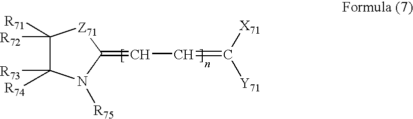

In the formula (7), R₇₁, R₇₂, R₇₃, and R₇₄ may be the same or different, and each independently represent a hydrogen atom, an alkyl group or an aryl group, provided that R₇₁ and R₇₄ may be combined with each other to form a double bond, wherein when R₇₁ and R₇₄ are combined with each other to form a double bond, R₇₂ and R₇₃ may be combined with each other to form a benzene ring or a naphthalene ring. R₇₅ represents an alkyl group or an aryl group, Z₇₁ represents an oxygen atom, a sulfur atom, a methylene group, an ethylene group, >N—R₇₆ or >C—(R₇₇)(R₇₈), where R₇₆ represents an alkyl group or an aryl group, and R₇₇ and R₇₈ may be the same or different, respectively represent a hydrogen atom or an alkyl group. X₇₁ and Y₇₁ may be the same or different, and have the same meanings as X₅₁ and Y₅₁ in the Formula (5). n denotes 0 or 1.

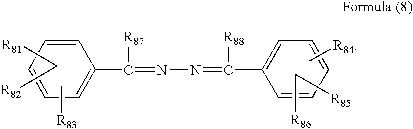

In formula (8), R₈₁, R₈₂, R₈₃, R₈₄, R₈₅, and R₈₆ each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group; R₈₇ and R₈₈ may be the same or different and each represent a hydrogen atom, an alkyl group, or an aryl group, and R₈₇ and R₈₈ may bond together to form a 5- or 6-membered ring.

In the formulae (1) to (8) and (a), each substituent in, for example, groups having an alkyl part, aryl part or heterocyclic part may be substituted with the following substituents. In the explanations of each group described in the Formulae (1) to (8) and (a), specific examples include exemplified groups of the corresponding groups among the groups shown below:

Such groups will be explained and exemplified hereinbelow.

Specific examples include: a halogen atom (e.g. a chlorine atom, a bromine atom, or an iodine atom); an alkyl group [which represents a substituted or unsubstituted linear, branched, or cyclic alkyl group, and which includes an alkyl group (preferably an alkyl group having 1 to 30 carbon atoms, e.g. a methyl group, an ethyl group, an n-propyl group, an isopropyl group, a t-butyl group, an n-octyl group, an eicosyl group, a 2-chloroethyl group, a 2-cyanoethyl group, or a 2-ethylhexyl group), a cycloalkyl group (preferably a substituted or unsubstituted cycloalkyl group having 3 to 30 carbon atoms, e.g. a cyclohexyl group, a cyclopentyl group, or a 4-n-dodecylcyclohexyl group), a bicycloalkyl group (preferably a substituted or unsubstituted bicycloalkyl group having 5 to 30 carbon atoms, i.e. a monovalent group obtained by removing one hydrogen atom from a bicycloalkane having 5 to 30 carbon atoms, e.g. a bicyclo[1,2,2]heptan-2-yl group or a bicyclo[2,2,2]octan-3-yl group), and a tricyclo or higher structure having three or more ring structures; and an alkyl group in a substituent described below (e.g. an alkyl group in an alkylthio group) represents such an alkyl group of the above concept, but it may include an alkenyl group or an alkynyl group]; an alkenyl group [which represents a substituted or unsubstituted linear, branched, or cyclic alkenyl group, and which includes an alkenyl group (preferably a substituted or unsubstituted alkenyl group having 2 to 30 carbon atoms, e.g. a vinyl group, an allyl group, a prenyl group, a geranyl group, or an oleyl group), a cycloalkenyl group (preferably a substituted or unsubstituted cycloalkenyl group having 3 to 30 carbon atoms, i.e. a monovalent group obtained by removing one hydrogen atom from a cycloalkene having 3 to 30 carbon atoms, e.g. a 2-cyclopenten-1-yl group or a 2-cyclohexen-1-yl group), and a bicycloalkenyl group (which represents a substituted or unsubstituted bicycloalkenyl group, preferably a substituted or unsubstituted bicycloalkenyl group having 5 to 30 carbon atoms, i.e. a monovalent group obtained by removing one hydrogen atom from a bicycloalkene having one double bond, e.g. a bicyclo[2,2,1]hept-2-en-1-yl group or a bicyclo[2,2,2]oct-2-en-4-yl group)]; an alkynyl group (preferably a substituted or unsubstituted alkynyl group having 2 to 30 carbon atoms, e.g. an ethynyl group, a propargyl group, or a trimethylsilylethynyl group); an aryl group (preferably a substituted or unsubstituted aryl group having 6 to 30 carbon atoms, e.g. a phenyl group, a p-tolyl group, a naphthyl group, an m-chlorophenyl group, or an o-hexadecanoylaminophenyl group); a heterocyclic group (preferably a monovalent group obtained by removing one hydrogen atom from a substituted or unsubstituted 5- or 6-membered aromatic or nonaromatic heterocyclic compound, which may be condensed with a benzene ring or the like; more preferably a 5- or 6-membered aromatic heterocyclic group having 3 to 30 carbon atoms, e.g. a 2-furyl group, a 2-thienyl group, a 2-pyrimidinyl group, a 2-benzothiazolyl group); a cyano group; a hydroxyl group; a nitro group; a carboxyl group; an alkoxy group (preferably a substituted or unsubstituted alkoxy group having 1 to 30 carbon atoms, e.g. a methoxy group, an ethoxy group, an isopropoxy group, a t-butoxy group, an n-octyloxy group, or a 2-methoxyethoxy group); an aryloxy group (preferably a substituted or unsubstituted aryloxy group having 6 to 30 carbon atoms, e.g. a phenoxy group, a 2-methylphenoxy group, a 4-t-butylphenoxy group, a 3-nitrophenoxy group, or a 2-tetradecanoylaminophenoxy group); a silyloxy group (preferably a silyloxy group having 3 to 20 carbon atoms, e.g. a trimethylsilyloxy group or a t-butyldimethylsilyloxy group); a heterocyclic oxy group (preferably a substituted or unsubstituted heterocyclic oxy group having 2 to 30 carbon atoms, e.g. a 1-phenyltetrazol-5-oxy group or a 2-tetrahydropyranyloxy group); an aryloxy group (preferably a formyloxy group, a substituted or unsubstituted alkylcarbonyloxy group having 2 to 30 carbon atoms, or a substituted or unsubstituted arylcarbonyloxy group having 7 to 30 carbon atoms, e.g. a formyloxy group, an acetyloxy group, a pivaloyloxy group, a stearoyloxy group, a benzoyloxy group, or a p-methoxyphenylcarbonyloxy group); a carbamoyloxy group (preferably a substituted or unsubstituted carbamoyloxy group having 1 to 30 carbon atoms, e.g. an N,N-dimethylcarbamoyloxy group, an N,N-diethylcarbamoyloxy group, a morpholinocarbonyloxy group, an N,N-di-n-octylaminocarbonyloxy group, or an N-n-octylcarbamoyloxy group); an alkoxycarbonyloxy group (preferably a substituted or unsubstituted alkoxycarbonyloxy group having 2 to 30 carbon atoms, e.g. a methoxycarbonyloxy group, an ethoxycarbonyloxy group, a t-butoxycarbonyloxy group, or an n-octylcarbonyloxy group); an aryloxycarbonyloxy group (preferably a substituted or unsubstituted aryloxycarbonyloxy group having 7 to 30 carbon atoms, e.g. a phenoxycarbonyloxy group, a p-methoxyphenoxycarbonyloxy group, or a p-n-hexadecyloxyphenoxycarbonyloxy group); an amino group (preferably an amino group, a substituted or unsubstituted allylamino group having 1 to 30 carbon atoms, or a substituted or unsubstituted arylamino group having 6 to 30 carbon atoms, e.g. an amino group, a methylamino group, a dimethylamino group, an anilino group, an N-methyl-anilino group, or a diphenylamino group); an acylamino group (preferably a formylamino group, a substituted or unsubstituted alkylcarbonylamino group having 1 to 30 carbon atoms, or a substituted or unsubstituted arylcarbonylamino group having 6 to 30 carbon atoms, e.g. a formylamino group, an acetylamino group, a pivaloylamino group, a lauroylamino group, a benzoylamino group, or a 3,4,5-tri-n-octyloxyphenylcarbonylamino group); an aminocarbonylamino group (preferably a substituted or unsubstituted aminocarbonylamino group having 1 to 30 carbon atoms, e.g. a carbamoylamino group, an N,N-dimethylaminocarbonylamino group, an N,N-diethylaminocarbonylamino group, or a morpholinocarbonylamino group); an alkoxycarbonylamino group (preferably a substituted or unsubstituted alkoxycarbonylamino group having 2 to 30 carbon atoms, e.g. a methoxycarbonylamino group, an ethoxycarbonylamino group, a t-butoxycarbonylamino group, an n-octadecyloxycarbonylamino group, or an N-methyl-methoxycarbonylamino group); an aryloxycarbonylamino group (preferably a substituted or unsubstituted aryloxycarbonylamino group having 7 to 30 carbon atoms, e.g. a phenoxycarbonylamino group, a p-chlorophenoxycarbonylamino group, or an m-n-octyloxyphenoxycarbonylamino group); a sulfamoylamino group (preferably a substituted or unsubstituted sulfamoylamino group having 0 to 30 carbon atoms, e.g. a sulfamoylamino group, an N,N-dimethylaminosulfonylamino group, or an N-n-octylaminosulfonylamino group); an alkyl- or aryl-sulfonylamino group (preferably a substituted or unsubstituted alkylsulfonylamino group having 1 to 30 carbon atoms, or a substituted or unsubstituted arylsulfonylamino group having 6 to 30 carbon atoms, e.g. a methylsulfonylamino group, a butylsulfonylamino group, a phenylsulfonylamino group, a 2,3,5-trichlorophenylsulfonylamino group, or a p-methylphenylsulfonylamino group); a mercapto group; an alkylthio group (preferably a substituted or unsubstituted arylthio group having 1 to 30 carbon atoms, e.g. a methylthio group, an ethylthio group, or an n-hexadecylthio group); an arylthio group (preferably a substituted or unsubstituted arylthio group having 6 to 30 carbon atoms, e.g. a phenylthio group, a p-chlorophenylthio group, or an m-methoxyphenylthio group); a heterocyclic thio group (preferably a substituted or unsubstituted heterocyclic thio group having 2 to 30 carbon atoms, e.g. a 2-benzothiazolylthio group or a 1-phenyltetrazol-5-ylthio group); a sulfamoyl group (preferably a substituted, or unsubstituted sulfamoyl group having 0 to 30 carbon atoms, e.g. an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, or an N—(N′-phenylcarbamoyl)sulfamoyl group); a sulfo group; an alkyl- or aryl-sulfinyl group (preferably a substituted or unsubstituted alkylsulfinyl group having 1 to 30 carbon atoms, or a substituted or unsubstituted arylsulfinyl group having 6 to 30 carbon atoms, e.g. a methylsulfinyl group, an ethylsulfonyl group, a phenylsulfinyl group, or a p-methylphenylsulfinyl group); an alkyl- or aryl-sulfonyl group (preferably a substituted or unsubstituted alkylsulfonyl group having 1 to 30 carbon atoms, or a substituted or unsubstituted arylsulfonyl group having 6 to 30 carbon atoms, e.g. a methylsulfonyl group, an ethylsulfonyl group, a phenylsulfonyl group, or a p-methylphenylsulfonyl group); an acyl group (preferably a formyl group, a substituted or unsubstituted alkylcarbonyl group having 2 to 30 carbon atoms, a substituted or unsubstituted arylcarbonyl group having 7 to 30 carbon atoms, or a substituted or unsubstituted heterocyclic carbonyl group having 4 to 30 carbon atoms, which is bonded to said carbonyl group through a carbon atom, e.g. an acetyl group, a pivaloyl group, a 2-chloroacetyl group, a stearoyl group, a benzoyl group, a p-n-octyloxyphenylcarbonyl group, a 2-pyridylcarbonyl group, or a 2-furylcarbonyl group); an aryloxycarbonyl group (preferably a substituted or unsubstituted aryloxycarbonyl group having 7 to 30 carbon atoms, e.g. a phenoxycarbonyl group, an o-chlorophenoxycarbonyl group, an m-nitrophenoxycarbonyl group, or a p-t-butylphenoxycarbonyl group); an alkoxycarbonyl group (preferably a substituted or unsubstituted alkoxycarbonyl group having 2 to 30 carbon atoms, e.g. a methoxycarbonyl group, an ethoxycarbonyl group, a t-butoxycarbonyl group, or an n-octadecyloxycarbonyl group); a carbamoyl group (preferably a substituted or unsubstituted carbamoyl group having 1 to 30 carbon atoms, e.g. a carbamoyl group, an N-methylcarbamoyl group, an N,N-dimethylcarbamoyl group, an N,N-di-n-octylcarbamoyl group, or an N-(methylsulfonyl)carbamoyl group); an aryl- or heterocyclic-azo group (preferably a substituted or unsubstituted aryl azo group having 6 to 30 carbon atoms, or a substituted or unsubstituted heterocyclic azo group having 3 to 30 carbon atoms, e.g. a phenylazo group, a p-chlorophenylazo group, or a 5-ethylthio-1,3,4-thiadiazol-2-ylazo group); an imido group (preferably an N-succinimido group or an N-phthalimido group); a phosphino group (preferably a substituted or unsubstituted phosphino group having 2 to 30 carbon atoms, e.g. a dimethylphosphino group, a diphenylphosphino group, or a methylphenoxyphosphino group); a phosphinyl group (preferably a substituted or unsubstituted phosphinyl group having 2 to 30 carbon atoms, e.g. a phosphinyl group, a dioctyloxyphosphinyl group, or a diethoxyphosphinyl group); a phosphinyloxy group (preferably a substituted or unsubstituted phosphinyloxy group having 2 to 30 carbon atoms, e.g. a diphenoxyphosphinyloxy group or a dioctyloxyphosphinyloxy group); a phosphinylamino group (preferably a substituted or unsubstituted phosphinylamino group having 2 to 30 carbon atoms, e.g. a dimethoxyphosphinylamino group or a dimethylaminophosphinylamino group); a silyl group (preferably a substituted or unsubstituted silyl group having 3 to 30 carbon atoms, e.g. a trimethylsilyl group, a t-butyldimethylsilyl group, or a phenyldimethylsilyl group).

Among the substituents, with respect to one having a hydrogen atom, the hydrogen atom may be removed and be substituted by any of the above-mentioned substituents. Examples thereof include: an alkylcarbonylaminosulfonyl group, an arylcarbonylaminosulfonyl group, an alkylsulfonylaminocarbonyl group, and an arylsulfonylaminocarbonyl group. Specific examples thereof include a methylsulfonylaminocarbonyl group, a p-methylphenylsulfonylaminocarbonyl group, an acetylaminosulfonyl group, and a benzoylaminosulfonyl group.

When the ultraviolet absorber represented by any one of the formulas (1) to (8) is a water-soluble dye, it is preferred to have an ionic hydrophilic group. The ionic hydrophilic group includes a sulfo group, a carboxyl group, a phosphono group, and a quaternary ammonium group. As the ionic hydrophilic group, a carboxyl group, a phosphono group, and a sulfo group are preferred, and a carboxyl group and a sulfo group are particularly preferred. The carboxyl group, phosphono group, and sulfo group may be in the state of a salt, and the examples of the counter ions for forming the salts include an ammonium ion, an alkali metal ion (e.g., a lithium ion, a sodium ion, and a potassium ion), and an organic cation (a tetramethylammonium ion, a tetramethylguanidium ion, and a tetramethylphosphonium ion).

Among ultraviolet absorbers represented by any one of the Formulae (1) to (8), those represented by any one of the Formulae (1) to (4) are preferable in the point that they themselves have high light fastness, and those represented by any one of the Formulae (1) or (3) are further preferable in view of absorbing characteristics. Among these absorbers, those represented by the Formulae (1) or (3) are particularly preferable. In the case where the ultraviolet absorber is used in a basic condition, on the other hand, compounds represented by any one of the Formulae (4) to (8) are preferable from the viewpoint of preventing coloring caused by dissociation.

Specific examples of the ultraviolet absorbers represented by any one of the Formulae (1) to (8) will be given below. However, these examples are not intended to be limiting of the present invention. Here, Ph represents a phenyl group and Me represents CH₃.

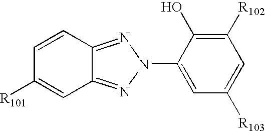

| | R₁₀₁ | R₁₀₂ | R₁₀₃ |
|---|---|---|---|
| 1-1 | H | H | t-C₈H₁₇ |
| 1-2 | H | t-C₄H₉ | CH₂CH₂CO₂H |
| 1-3 | H | C(CH₃)₂Ph | t-C₈H₁₇ |
| 1-4 | H | C(CH₃)₂Ph | C(CH₃)₂Ph |
| 1-5 | H | H | CH₂CH₂CO₂K |
| 1-6 | H | t-C₅H₁₁ | t-C₅H₁₁ |
| 1-7 | H | C₉H₁₉ | H |
| 1-8 | H | NHCOCH(CH₃)₂ | CH₃ |
| 1-9 | Cl | t-C₄H₉ | t-C₄H₉ |
| 1-10 | OCH₃ | t-C₄H₉ | CH₃ |
| 1-11 | Cl | t-C₄H₉ | CH₂CH₂CO₂C₈H₁₇ |
| 1-12 | H | C₁₂H₂₅ | CH₃ |
| 1-13 | SC₁₂H₂₅ | t-C₄H₉ | t-C₄H₉ |

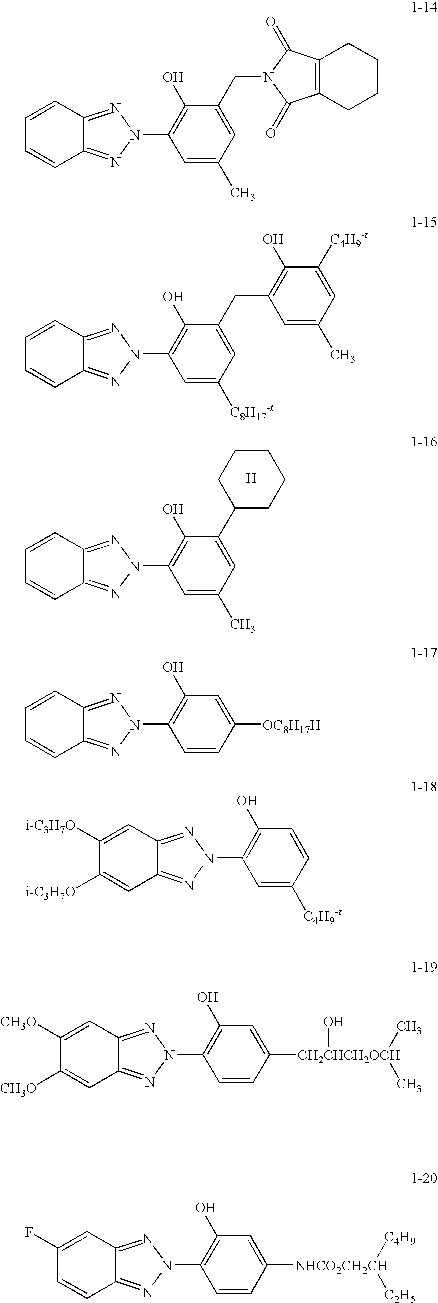

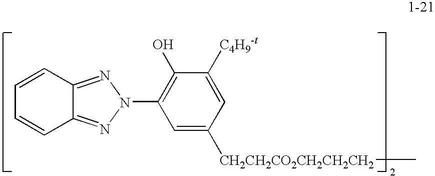

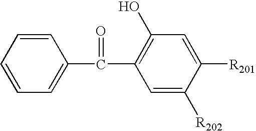

| | R₂₀₁ | R₂₀₂ |
|---|---|---|
| 2-1 | OCH₃ | H |
| 2-2 | OC₈H₁₇ | H |
| 2-3 | OCH₂Ph | H |
| 2-4 | OCH₂CO₂C₂H₅ | H |
| 2-5 | OH | COPh |
| 2-6 | O(CH₂)₃CO₂Li | H |
| 2-7 | OH | SO₃Na |
| 2-8 | OCH₃ | SO₃H |

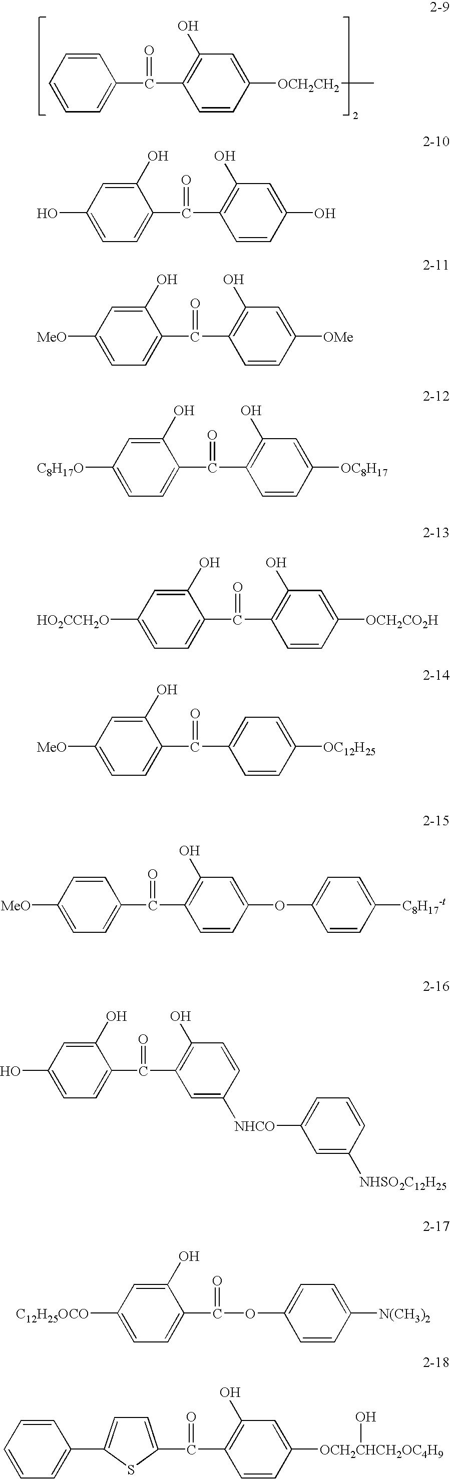

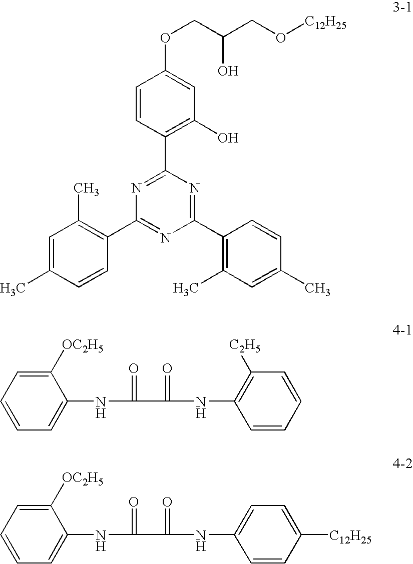

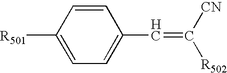

| | R₅₀₁ | R₅₀₂ |
|---|---|---|
| 5-1 | MeO | CO₂H |
| 5-2 | MeO | CO₂Na |
| 5-3 | MeO | CO₂C₁₀H₂₁ |
| 5-4 | Me | CO₂C₁₂H₂₅ |

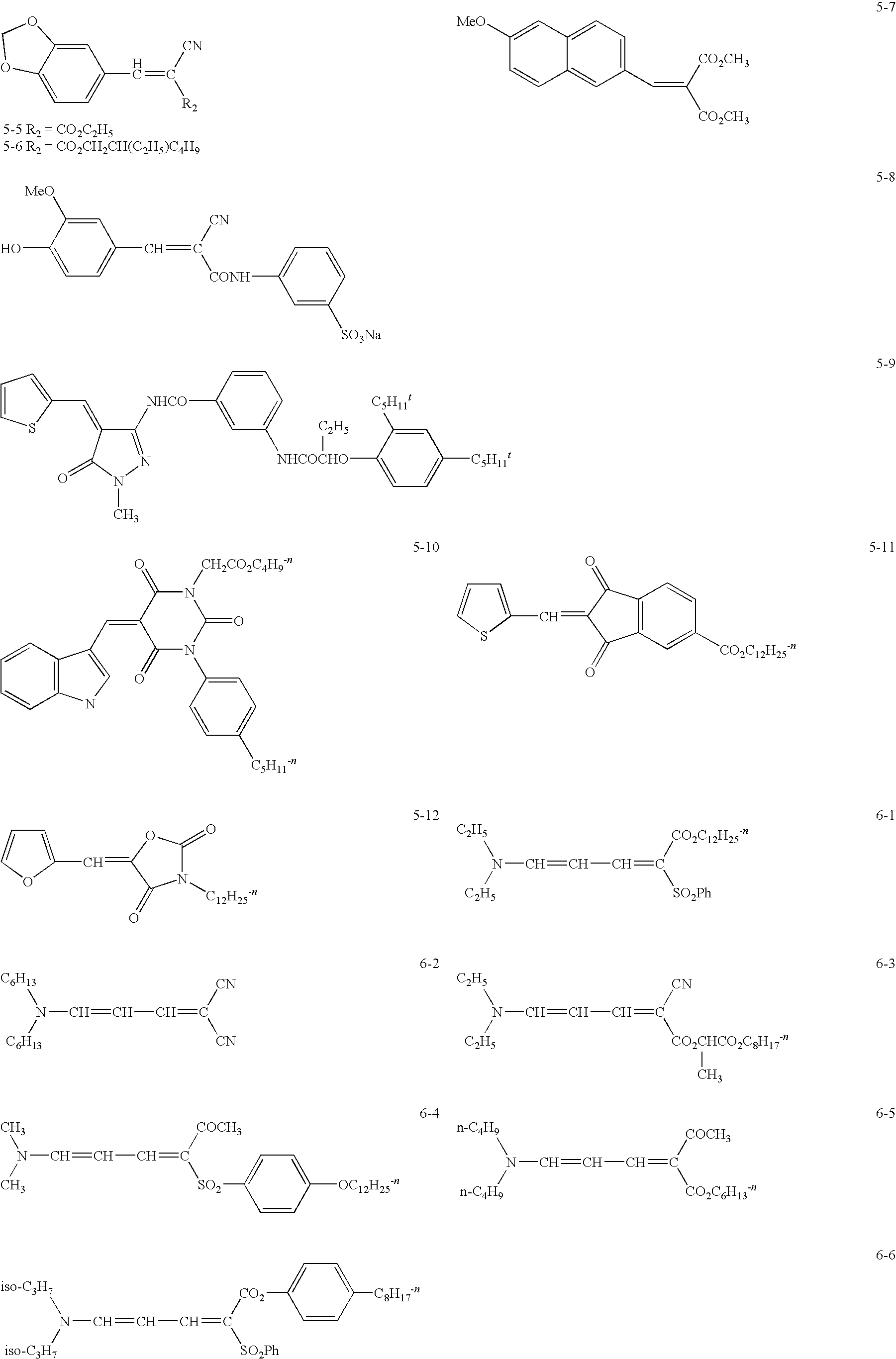

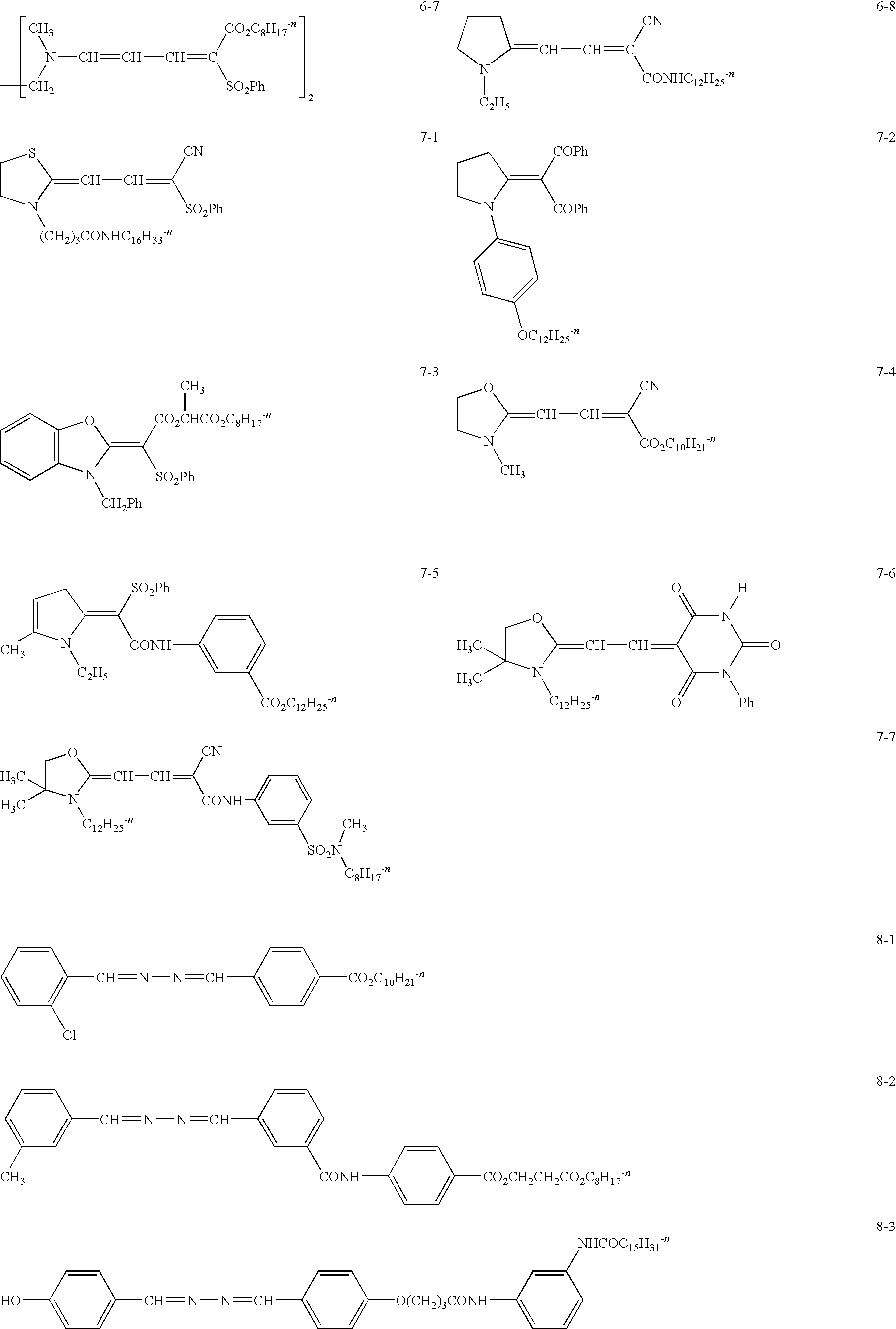

The compounds represented by any one of the formulae (1) to (8) can be synthesized by or according to any of the methods described, for example, in JP-B-48-30492 (“JP-B” means examined Japanese patent publication), JP-B-55-36984, JP-B-55-125875, JP-B-36-10466, JP-B-48-5496, JP-A-46-3335, JP-A-58-214152, JP-A-58-221844, JP-A-47-10537, JP-A-59-19945, JP-A-63-53544, JP-A-51-56620, JP-A-53-128333, JP-A-58-181040, JP-A-6-211813, JP-A-7-258228, JP-A-8-239368, JP-A-8-53427, JP-A-10-115898, JP-A-10-147577, JP-A-10-182621, JP-A-8-501291 (“JP-T” means searched and published International patent publication), U.S. Pat. No. 3,754,919, U.S. Pat. No. 4,220,711, U.S. Pat. No. 2,719,086, U.S. Pat. No. 3,698,707, U.S. Pat. No. 3,707,375, U.S. Pat. No. 5,298,380, U.S. Pat. No. 5,500,332, U.S. Pat. No. 5,585,228, U.S. Pat. No. 5,814,438, British Patent No. 1,198,337, European Patents No. 323408A, No. 520938A, No. 521823A, No. 531258A, No. 530135A, and No. 520938A.

Also, the structures, material properties and action mechanisms of typical ultraviolet absorbers are described in Andreas Valet, “Light Stabilizers for Paint”, issued by Vincentz.

The polymer containing a unit having ultraviolet absorbing ability used in the present invention, preferably in the first or fourth embodiment of the present invention, is one in which the chemical structure represented by any one of the above Formulae (1) to (8) is incorporated thereinto as its structural unit or a part of the structural unit. Ultraviolet absorbers having a chemical structure represented by the Formula (1) as a structural unit are disclosed in European Patent No. 747755, JP-A-8-179464, JP-A-6-82962, JP-A-4-193869, JP-A-3-139590, JP-A-63-55542, JP-A-62-24247, JP-A-47-560 and JP-A-58-185677, ultraviolet absorbers having a chemical structure represented by the Formula (2) as a structural unit are disclosed in JP-A-63-35660 and JP-A-2-180909, ultraviolet absorbers having a chemical structure represented by the Formula (3) as a structural unit are disclosed in European Patent No. 706083, ultraviolet absorbers having a chemical structure represented by the Formula (5) as a structural unit are disclosed in JP-T-4-500228 and JP-B-63-53541, ultraviolet absorbers having a chemical structure represented by the Formula (6) as a structural unit are disclosed in European Patent No. 27242, JP-B-1-53455 and JP-A-61-189530 and ultraviolet absorbers having a chemical structure represented by the Formula (7) as a structural unit are disclosed in JP-A-63-53543. Moreover, for example, JP-A-47-192, JP-A-61-169831, JP-A-63-53543, JP-A-63-53544 and JP-A-63-56651 and European Patent No. 343246 are known to disclose examples of the ultraviolet absorbers.

As the ultraviolet absorber made of inorganic compounds, titanium oxide microparticle dispersions and dispersions of microparticles of metal oxide such as cerium oxide and zinc oxide as disclosed in German Patent No. 19511316 may be used.

In the present invention, preferably in the first or fourth embodiment of the present invention, ultraviolet absorbers made of organic compounds are preferable.

The polymer containing a unit having ultraviolet absorbing ability used in the present invention, preferably in the first or fourth embodiment of the present invention, may be added to a medium by dissolving or dispersing it. When the polymer has solubility in the medium, the compound used in the present invention, preferably in the first or fourth embodiment of the present invention, may be added directly. In the case where the polymer has no solubility, on the other hand, a method described in U.S. Pat. No. 2,322,027 may be used when a water-soluble medium is used and an oil-soluble ultraviolet absorber is used in a manner similar to the present invention. For instance, the compounds are first dissolved in a solvent, such as alkyl phthalates (e.g., dibutyl phthalate or dioctyl phthalate), phosphoric acid esters (e.g., diphenyl phosphate, triphenyl phosphate, tricresyl phosphate, or dioctyl butyl phosphate), citric acid esters (e.g., tributyl acetylcitrate), benzoic acid esters (e.g., octyl benzoate), alkylamides (e.g., diethyllaurylamide), fatty acid esters (e.g., dibutoxyethyl succinate, diethyl azelate), a trimesic acid ester (e.g., tributyl trimesate); or an organic solvent having a boiling point ranging from about 30° C. to 150° C., such as a lower alkyl acetate (e.g., ethyl acetate, butyl acetate), ethyl propionate, secondary butyl alcohol, methyl isobutyl ketone, β-ethoxyethylacetate, or methyl cellosolve acetate, and then the compounds are dispersed into a hydrophilic colloid. These high boiling organic solvents and low boiling organic solvents may also be used as a mixture of two or more.

Alternatively, there can be employed the dispersion methods utilizing polymers, as disclosed in JP-B-51-39853 and JP-A-51-59943.

As a specific method used to add these hydrophobic compounds in the form of an oil composition or polymer composition to a light-sensitive material, a method described in JP-A-7-92613 may be applied.

### <Latex Polymer>

The latex polymer for use in the present invention will be explained. The term “latex polymer” used herein means a dispersion comprising hydrophobic water-insoluble polymer dispersed in a water-soluble dispersion medium as fine particles. The dispersed state may be one in which polymer is emulsified in a dispersion medium, one in which polymer underwent emulsion polymerization, one in which polymer underwent micelle dispersion, one in which polymer molecules having a hydrophilic portion are dispersed in a molecular state or the like. Latex polymer used in the present invention is mentioned in “Gosei Jushi Emulsion (Synthetic Resin Emulsion)”, compiled by Taira Okuda and Hiroshi Inagaki, issued by Kobunshi Kanko Kai (1978); “Gosei Latex no Oyo (Application of Synthetic Latex)”, compiled by Takaaki Sugimura, Yasuo Kataoka, Souichi Suzuki and Keishi Kasahara, issued by Kobunshi Kanko Kai (1993); Soichi Muroi, “Gosei Latex no Kagaku (Chemistry of Synthetic Latex)”, issued by Kobunshi Kanko Kai (1970); Yoshiaki Miyosawa (supervisor) “Development and Application of Aqueous Coating Material”, issued by CMC Publishing Co., Ltd. (2004) and JP-A-64-538, and so forth. The dispersed particles preferably have a mean particle size of about 1 to 50,000 nm, more preferably about 5 to 1,000 nm. The particle size distribution of the dispersed particles is not particularly limited, and the particles may have either wide particle size distribution or monodispersed particle size distribution.

The latex polymer for use in the present invention may be latex of the so-called core/shell type, other than ordinary latex polymer of a uniform structure. In this case, it is preferred in some cases that the core and the shell have different glass transition temperatures. The glass transition temperature (Tg) of the latex polymer for use in the present invention, preferably in the first or second embodiment of the present invention, is preferably −30° C. to 130° C., more preferably 0° C. to 100° C., and further more preferably 10° C. to 80° C. The glass transition temperature (Tg) of the latex polymer for use in the present invention, preferably in the third embodiment of the present invention, is preferably −30° C. to 100° C., more preferably 0° C. to 80° C., further more preferably 10° C. to 70° C., and especially preferably 15° C. to 60° C.

In the present invention, as preferable types of latex polymer, hydrophobic polymers such as acrylic-series polymers, polyesters, rubbers (e.g., SBR resins), polyurethanes, polyvinyl chlorides, polyvinyl acetates, polyvinylidene chlorides, and polyolefins, are preferably used. These polymers may be straight-chain, branched or cross-linked polymers, the so-called homopolymers obtained by polymerizing a single monomers, or copolymers obtained by polymerizing two or more types of monomer. In the case of the copolymers, these copolymers may be either random copolymers or block copolymers. The molecular weight of each of these polymers is preferably 5,000 to 1,000,000, and further preferably 10,000 to 500,000 in terms of number average molecular weight. Polymers having excessively small molecular weight impart insufficient dynamic strength to a layer containing a latex and polymers having excessively large molecular weight bring about poor filming ability, and therefore both cases are undesirable. Crosslinkable latex polymers are also preferably used.

No particular limitation is imposed on the monomer used to synthesize the latex polymer used in the present invention, and the following monomer groups (a) to (j) may be preferably used as those polymerizable in a usual radical polymerization or ion polymerization method. These monomers may be selected singly or combined freely to synthesize a latex polymer.

—Monomer Groups (a) to (j)—
(a) Conjugated dienes: 1,3-pentadiene, isoprene, 1-phenyl-1,3-butadiene, 1-α-naphthyl-1,3-butadiene, 1-β-naphthyl-1,3-butadiene, cyclopentadiene, etc.
(b) Olefins: ethylene, propylene, vinyl chloride, vinylidene chloride, 6-hydroxy-1-hexene, 4-pentenoic acid, methyl 8-nonenate, vinylsulfonic acid, trimethylvinylsilane, trimethoxyvinylsilane, 1,4-divinylcyclohexane, 1,2,5-trivinylcyclohexane, etc.
(c) α,β-unsaturated carboxylates: alkyl acrylates such as methyl acrylate, ethyl acrylate, butyl acrylate, cyclohexyl acrylate, 2-ethylhexyl acrylate, and dodecyl acrylate; substituted alkyl acrylates such as 2-chloroethyl acrylate, benzyl acrylate, and 2-cyanoethyl acrylate; alkyl methacrylates such as methyl methacrylate, butyl methacrylate, 2-ethylhexyl methacrylate, and dodecyl methacrylate; substituted alkyl methacrylates such as 2-hydroxyethyl methacrylate, glycidyl methacrylate, glycerin monomethacrylate, 2-acetoxyethyl methacrylate, tetrahydrofurfuryl methacrylate, 2-methoxyethyl methacrylate, polypropylene glycol monomethacrylates (mole number of added polyoxypropylene=2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, and 2-isocyanatoethyl methacrylate; derivatives of unsaturated dicarboxylic acids such as monobutyl maleate, dimethyl maleate, monomethyl itaconate, and dibutyl itaconate; multifunctional esters such as ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, and 1,2,4-cyclohexane tetramethacrylate; etc.
(d) α,β-unsaturated carboxylic amides: acrylamide, methacrylamide, N-methylacrylamide, N,N-dimethylacrylamide, N-methyl-N-hydroxyethylmethacrylamide, N-tert-butylacrylamide, N-tert-octylmethacrylamide, N-cyclohexylacrylamide, N-phenylacrylamide, N-(2-acetoacetoxyethyl)acrylamide, N-acryloylmorpholine, diacetone acrylamide, itaconic diamide, N-methylmaleimide, 2-acrylamide-methylpropane sulfonic acid, methylenebisacrylamide, dimethacryloylpiperazine, etc.
(e) Unsaturated nitriles: acrylonitrile, methacrylonitrile, etc.
(f) Styrene and derivatives thereof: styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, p-aminomethylstyrene, 1,4-divinylbenzene, etc.
(g) Vinyl ethers: methyl vinyl ether, butyl vinyl ether, methoxyethyl vinyl ether, etc.
(h) Vinyl esters: vinyl acetate, vinyl propionate, vinyl benzoate, vinyl salicylate, vinyl chloroacetate, etc.
(i) α,β-unsaturated carboxylic acids and salts thereof: acrylic acid, methacrylic acid, itaconic acid, maleic acid, sodium acrylate, ammonium methacrylate, potassium itaconate, etc.
(j) Other polymerizable monomers: N-vinylimidazole, 4-vinylpyridine, N-vinylpyrrolidone, 2-vinyloxazoline, 2-isopropenyloxazoline, divinylsulfone, etc.

These latex polymers described above are commercially available, and polymers described below may be utilized.

Examples of the acrylic-series polymers include Cevian A-4635, 4718, and 4601 (trade names, manufactured by Daicel Chemical Industries); Nipol Lx811, 814, 821, 820, 855 (P-17: Tg 36° C.), and 857×2 (P-18: Tg 43° C.) (trade names, manufactured by Nippon Zeon Co., Ltd.); Voncoat R3370 (P-19: Tg 25° C.), and 4280 (P-20: Tg 15° C.) (trade names, manufactured by Dai-Nippon Ink & Chemicals, Inc.); Julimer ET-410 (P-21: Tg 44° C.) (trade name, manufactured by Nihon Junyaku K. K.); AE116 (P-22: Tg 50° C.), AE119 (P-23: Tg 55° C.), AE121 (P-24: Tg 58° C.), AE125 (P-25: Tg 60° C.), AE134 (P-26: Tg 48° C.), AE137 (P-27: Tg 48° C.), AE140 (P-28: Tg 53° C.), and AE173 (P-29: Tg 60° C.) (trade names, manufactured by JSR Corporation); Aron A-104 (P-30: Tg 45° C.) (trade name, manufactured by Toagosei Co., Ltd.); NS-600X, and NS-620X (trade names, manufactured by Takamatsu Yushi K. K.); VINYBRON 2580, 2583, 2641, 2770, 2770H, 2635, 2886, 5202C, and 2706 (trade names, manufactured by Nisshin Chemicals Co., Ltd.).

Examples of the polyesters include FINETEX ES650, 611, 675, and 850 (trade names, manufactured by Dainippon Ink and Chemicals, Incorporated); WD-size, and WMS (trade names, manufactured by Eastman Chemical Ltd.); A-110, A-115GE, A-120, A-121, A-124GP, A-124S, A-160P, A-210, A-215GE, A-510, A-513E, A-515GE, A-520, A-610, A-613, A-615GE, A-620, WAC-10, WAC-15, WAC-17XC, WAC-20, S-110, S-110EA, S-111SL, S-120, S-140, S-140A, S-250, S-252Q S-250S, S-320, S-680, DNS-63P, NS-122L, NS-122LX, NS-244LX, NS-140L, NS-141LX, and NS-282LX (trade names, manufactured by Takamatsu Yushi K. K.); Aronmelt PES-1000 series, and PES-2000 series (trade names, manufactured by Toagosei Co., Ltd.); Bironal MD-1100, MD-1200, MD-1220, MD-1245, MD-1250, MD-1335, MD-140Q, MD-1480, MD-1500, MD-1930, and MD-1985 (trade names, manufactured by Toyobo Co., Ltd.); and Ceporjon ES (trade name, manufactured by Sumitomo Seika Chemicals Co., Ltd.).

Examples of the polyurethanes include HYDRAN AP 10, AP20, AP30, AP40, and 101H, Vondic 1320NS, and 1610NS (trade names, manufactured by Dainippon Ink and Chemicals, Incorporated); D-1000, D-2000, D-6000, D-4000, and D-9000 (trade names, manufactured by Dainichi seika Color & Chemicals Mfg. Co., Ltd.); NS-155X, NS-310A, NS-310X, and NS-311X (trade names, manufactured by Takamatsu Yushi K. K.); Elastron (trade name, manufactured by Dai-ichi Kogyo Seiyaku Co., Ltd.).

Examples of the rubbers include LACSTAR 7310K, 3307B, 4700H, and 7132C (trade names, manufactured by Dainippon Ink & Chemicals Incorporated); Nipol Lx416, LX410, LX430, LX435, LX110, LX415A, LX438C, 2507H, LX303A, LX407BP series, V1004, and MH5055 (trade names, manufactured by Nippon Zeon Co., Ltd.).

Examples of the polyvinyl chlorides include G351, and G576 (trade names, manufactured by Nippon Zeon Co., Ltd.); VINYBRON 240, 270, 277, 375, 386, 609, 550, 601, 602, 630, 660, 671, 683, 680, 680S, 681N, 685R, 277, 380, 381, 410, 430, 432, 860, 863, 865, 867, 900, 900GT, 938, and 950 (trade names, manufactured by Nisshin Chemicals Co., Ltd.).

Examples of polyvinylidene chlorides include L502 and L513 (trade names, manufactured by Asahi Kasei Corporation); D-5071 (trade name, manufactured by Dai-Nippon Ink & Chemicals, Inc.).

Examples of polyolefins include Chemipearl S120, SA100, and V300 (P-40: Tg 80° C.) (trade names, manufactured by Mitsui Petrochemical); Voncoat 2830, 2210, and 2960 (trade names, manufactured by Dainippon Ink and Chemicals, Incorporated); Zaikusen and Ceporjon G (trade names, manufactured by Sumitomo Seika Chemicals Co., Ltd.).

Examples of copolymer nylons include Ceporjon PA (trade name, manufactured by Sumitomo Seika Chemicals Co., Ltd.).

Examples of the polyvinyl acetates include VINYBRON 1080, 1082, 1085W, 1108W, 1108S, 1563M, 1566, 1570, 1588C, A22J7-F2, 1128C, 1137, 1138, A20J2, A23J1, A23J1, A23K1, A23P2E, A68J1N, 1086A, 1086, 1086D, 1108S, 1187, 1241LT, 1580N, 1083, 1571, 1572, 1581, 4465, 4466, 4468W, 4468S, 4470, 4485LL, 4495LL, 1023, 1042, 1060, 1060S, 1080M, 1084W, 1084S, 1096, 1570K, 1050, 1050S, 3290, 1017AD, 1002, 1006, 1008, 1107L, 1225, 1245L, GV-6170, GV-6181, 4468W, and 4468S (trade names, manufactured by Nisshin Chemicals Co., Ltd.).

These latex polymers may be used singly or two or more of these polymers may be blended.

In the present invention, it is preferable to prepare the receptor layer by applying an aqueous type coating solution and then drying. The “aqueous type” so-called here means that 60% by mass or more of the solvent (dispersion medium) of the coating solution is water. As components other than water in the coating solution, water miscible organic solvents may be used, such as methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethylene glycol monoethyl ether, and oxyethyl phenyl ether.

ThOugh no particular limitation is imposed on the drying time, the drying time is preferably shorter in view of production. Specifically, the drying time is preferably 10 seconds to 20 minutes and more preferably 30 seconds to 10 minutes.

A Minimum Filmforming Temperature (MFT) of the latex polymer is the lowest temperature required for an emulsion to form a smooth and transparent continuous coating film. The latex polymer for use in the present invention preferably has a minimum film-forming temperature (MFT) of from −30 to 90° C., more preferably from 0 to 70° C. In order to control the minimum film-forming temperature, a film-forming aid may be added. The film-forming aid is also called a temporary plasticizer, and it is an organic compound (usually an organic solvent) capable of reducing the minimum film-forming temperature of the latex polymer. It is described in Souichi Muroi, “Gosei Latex no Kagaku (Chemistry of Synthetic Latex)”, issued by Kobunshi Kanko Kai (1970). Typical examples of the filming aid are listed below, but the compounds for use in the invention are not limited to the following specific examples.

Z-1: Benzyl alcohol
Z-2: 2,2,4-Trimethylpentanediol-1,3-monoisobutyrate

### Z-3: 2-Dimethylaminoethanol

Z-4: Diethylene glycol

Preferable examples of the latex polymer to be used in the present invention may include polylactates, polyurethanes, polycarbonates, polyesters, polyacetals, SBRs and polyvinyl chlorides. It is most preferable that among these compounds, polyesters, polycarbonates and polyvinyl chlorides be included.

In combination with the latex polymer for use in the present invention, any polymer can be used. The polymer is preferably transparent or translucent, and generally colorless. The polymer may be a natural resin, polymer or copolymer, a synthetic resin, polymer or copolymer, or another film-forming medium, and specific examples thereof include gelatins, polyvinyl alcohols, hydroxyethylcelluloses, cellulose acetates, cellulose acetate butyrates, polyvinylpyrrolidones, caseins, starches, polyacrylic polymethylmethacrylic acids, polyvinyl chlorides, polymethacrylic acids, styrene-maleic anhydride copolymers, styrene-acrylonitrile copolymers, styrene-butadiene copolymers, polyvinyl acetals (e.g. polyvinyl formals, polyvinyl butyrals, etc.), polyesters, polyurethanes, phenoxy resins, polyvinylidene chlorides, polyepoxides, polycarbonates, polyvinyl acetates, polyolefins, cellulose esters, and polyamides. In the coating liquid, the binder may be dissolved or dispersed in an aqueous solvent or in an organic solvent, or may be in the form of an emulsion.

The glass transition temperature (Tg) of the binder of the invention is preferably in the range of −30° C. to 70° C., more preferably −10° C. to 50° C., still more preferably 0° C. to 40° C. in view of film forming properties and image storability. A blend of two or more types of polymers can be used as the binder. When two or more polymers are used, the average Tg obtained by summing up the Tg of each polymer weighted by its proportion is preferably within the foregoing range. Also, when phase separation occurs or when a core-shell structure is adopted, the weighted average Tg is preferably within the foregoing range.

The glass transition temperature (Tg) is calculated according to the following equation:

1/Tg=Σ(Xi/Tgi)

wherein, assuming that the polymer is a copolymer composed of n monomers from i=1 to i=n, Xi is a weight fraction of the i-th monomer (ΣXi=1) and Tgi is glass transition temperature (measured in absolute temperature) of a homopolymer formed from the i-th monomer. The symbol Σ means the sum of i=1 to i=n. The value of the glass transition temperature of a homopolymer formed from each monomer (Tgi) is adopted from J. Brandrup and E. H. Immergut, “Polymer Handbook, 3rd. Edition”, Wiley-Interscience (1989).

The polymer used for the binder for use in the invention can be easily obtained by a solution polymerization method, a suspension polymerization method, an emulsion polymerization method, a dispersion polymerization method, an anionic polymerization method, a cationic polymerization method, or the like. Above all, an emulsion polymerization method in which the polymer is obtained as a latex is the most preferable. Also, a method is preferable in which the polymer is prepared in a solution, and the solution is neutralized or an emulsifier is added to the solution, to which water is then added to prepare a water dispersion by forced stirring. For example, an emulsion polymerization method comprises conducting polymerization under stirring at about 30° C. to about 100° C. (preferably 60° C. to 90° C.) for 3 to 24 hours by using water or a mixed solvent of water and a water-miscible organic solvent (such as methanol, ethanol, or acetone) as a dispersion medium, a monomer mixture in an amount of 5 mass % to 150 mass % based on the amount of the dispersion medium, an emulsifier and a polymerization initiator. Various conditions such as the dispersion medium, the monomer concentration, the amount of initiator, the amount of emulsifier, the amount of dispersant, the reaction temperature, and the method for adding monomer are suitably determined considering the type of the monomers to be used. Furthermore, it is preferable to use a dispersant as necessary.

Generally, the emulsion polymerization method can be conducted according to the disclosures of the following documents: “Gosei Jushi Emarujon (Synthetic Resin Emulsions)” (edited by Taira Okuda and Hiroshi Inagaki and published by Kobunshi Kankokai (1978)); “Gosei Ratekkusu no Oyo (Applications of Synthetic Latexes)” (edited by Takaalci Sugimura, Yasuo Kataoka, Soichi Suzuld and Keiji Kasahara and published by Kobunshi Kankokai (1993)); and “Gosei Ratekkusu no Kagaku (Chemistry of Synthetic Latexes)” (edited by Soichi Muroi and published by Kobunshi Kankokai (1970)). The emulsion polymerization method for synthesizing the latex polymer in the invention may be a batch polymerization method, a monomer (continuous or divided) addition method, an emulsion addition method, or a seed polymerization method. The emulsion polymerization method is preferably a batch polymerization method, a monomer (continuous or divided) addition method, or an emulsion addition method in view of the productivity of latex.

The polymerization initiator may be any polymerization initiator having radical generating ability. The polymerization initiator may be selected from inorganic peroxides such as persulfates and hydrogen peroxide, peroxides described in the organic peroxide catalogue of NOF Corporation, and azo compounds as described in the azo polymerization initiator catalogue of Wako Pure Chemical Industries, Ltd. Among them, water-soluble peroxides such as persulfates and water-soluble azo compounds as described in the azo polymerization initiator catalogue of Wako Pure Chemical Industries, Ltd. are preferable; ammonium persulfate, sodium persulfate, potassium persulfate, azobis(2-methylpropionamidine) hydrochloride, azobis(2-meth-yl-N-(2-hydroxyethyl)propionamide), and azobiscyanovaleric acid are more preferable; and peroxides such as ammonium persulfate, sodium persulfate, and potassium persulfate are especially preferable from the viewpoints of image storability, solubility and cost.

The amount of the polymerization initiator to be added is, based on the total amount of monomers, preferably 0.3 mass % to 2.0 mass %, more preferably 0.4 mass % to 1.75 mass %, and especially preferably 0.5 mass % to 1.5 mass %.

The polymerization emulsifier may be selected from anionic surfactants, nonionic surfactants, cationic surfactants, and ampholytic surfactants. Among them, anionic surfactants are preferable from the viewpoints of dispersibility and image storability. Sulfonic acid type anionic surfactants are more preferable because polymerization stability can be ensured even with a small addition amount and they have resistance to hydrolysis. Long chain allcyldiphenyl ether disulfonic acid salts (whose typical example is PELEX SS—H manufactured by Kao Corporation, trade name) are still more preferable, and low electrolyte types such as PIONIN A-43-S (manufactured by Takemoto Oil & Fat Co., Ltd., trade name) are especially preferable.

The amount of sulfonic acid type anionic surfactant as the polymerization emulsifier is preferably 0.1 mass % to 10.0 mass %, more preferably 0.2 mass % to 7.5 mass %, and especially preferably 0.3 mass % to 5.0 mass %, based on the total amount of monomers.

It is preferable to use a chelating agent in synthesizing the latex polymer to be used in the invention. The chelate agent is a compound capable of coordinating (chelating) a polyvalent ion such as metal ion (e.g., iron ion) or alkaline earth metal ion (e.g., calcium ion), and examples of the chelate compound which can be used include the compounds described in JP-B-6-8956, U.S. Pat. No. 5,053,322, JP-A-4-73645, JP-A-4-127145, JP-A-4-247073, JP-A-4-305572, JP-A-6-11805, JP-A-5-173312, JP-A-5-66527, JP-A-5-158195, JP-A-6-118580, JP-A-6-110168, JP-A-6-161054, JP-A-6-175299, JP-A-6-214352, JP-A-7-114161, JP-A-7-114154, JP-A-7-120894, JP-A-7-199433, JP-A-7-306504, JP-A-9-43792, JP-A-8-314090, JP-A-10-182571, JP-A-10-182570, and JP-A-11-190892.

Preferred examples of the chelate agent include inorganic chelate compounds (e.g., sodium nipolyphosphate, sodium hexametaphosphate, sodium tetrapolyphosphate), aminopolycarboxylic acid-based chelate compounds (e.g., nitrilotriacetate, ethylenediaminetetraacetate), organic phosphonic acid-based chelate compounds (e.g., compounds described in Research Disclosure, No. 18170, JP-A-52-102726, JP-A-53-42730, JP-A-56-97347, JP-A-54-121127, JP-A-55-4024, JP-A-55-4025, JP-A-55-29883, JP-A-55-126241, JP-A-55-65955, JP-A-55-65956, JP-A-57-179843, JP-A-54-61125, and West German Patent No. 1045373), polyphenol-based chelating agents, and polyamine-based chelate compounds, with aminopolycarboxylic acid derivatives being more preferred.

Preferred examples of the aminopolycarboxylic acid derivative for use in the present invention include the compounds shown in the Table attached to EDTA (—Complexane no Kagaku (Chemistry of Complexane)—), Nankodo (1977). In these compounds, a part of the carboxyl groups may be substituted by an alkali metal salt such as sodium or potassium or by an ammonium salt. More preferred examples of the aminopolycarboxylic acid derivative include iminodiacetic acid, N-methyliminodiacetic acid, N-(2-aminoethyl)iminodiacetic acid, N-(carbamoylmethyl)imino diacetic acid, nitrilotriacetic acid, ethylenediamine-N,N′-diacetic acid, ethylenediamine-N,N′-di-α-propionic acid, ethylenediamine-N,N′-di-β-propionic acid, N,N′-ethylene-bis(α-o-hydroxyphenyl)glycine, N,N′-di(2-hydroxybenzyl)ethylenediamine-N,N′-diacetic acid, ethylenediamine-N,N′-diacetic•acid-N,N′-diacetohydroxamic acid, N-hydroxyethylethylenediamine-N,N′,N′-triacetic acid, ethylenediamine-N,N,N′,N′-tetraacetic acid, 1,2-propylenediamine-N,N,N′,N′-tetraacetic acid, d,l-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, d,l-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraactic acid, trans-cyclohexane-1,2-diamine-N,N,N′,N′-tetraacetic acid, cis-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, o-phenylenediamine-N,N,N′,N′-tetraacetic acid, cis-1,4-diaminobutene-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N′,N″-tetraacetic acid, 2,2′-oxy-bis(ethyliminodiacetic acid), 2,2′-ethylenedioxy-bis(ethyliminodiacetic acid), ethylenediamine-N,N′-diacetic acid-N,N′-di-α-propionic acid, ethylenediamine-N,N′-diacetic acid-N,N′-di-β-propionic acid, ethylenediamine-N,N,N′,N′-tetrapropionic acid, diethylenetriamine-N,N,N′,N″,N″-pentaacetic acid, triethylenetetramine-N,N,N′,N″,N′″,N′″-hexaacetic acid, and 1,2,3-triaminopropane-N,N,N′,N″,N′″,N′″-hexaacetic acid. In these compounds, a part of the carboxyl groups may be substituted by an alkali metal salt such as sodium or potassium or by an ammonium salt.

The amount of the chelating agent to be added is preferably 0.01 mass % to 0.4 mass %, more preferably 0.02 mass % to 0.3 mass %, and especially preferably 0.03 mass % to 0.15 mass %, based on the total amount of monomers. When the addition amount of the chelating agent is less than 0.01 mass %, metal ions entering during the preparation of the latex polymer are not sufficiently trapped, and the stability of the latex against aggregation is lowered, whereby the coating properties become worse. When it exceeds 0.4 mass %, the viscosity of the latex increases, whereby the coating properties are lowered.

In the preparation of the latex polymer to be used in the invention, it is preferable to use a chain transfer agent. The chain transfer agent may be selected from ones described in Polymer Handbook (3rd Edition) (Wiley-Interscience, 1989). Sulfur compounds are more preferable because they have high chain transfer ability and because the required amount is small. Especially, hydrophobic mercaptane-based chain transfer agents such as tert-dodecylmercaptane and n-dodecylmercaptane are preferable.

The amount of the chain transfer agent to be added is preferably 0.2 mass % to 2.0 mass %, more preferably 0.3 mass % to 1.8 mass %, especially preferably 0.4 mass % to 1.6 mass %, based on the total amount of monomers.

Besides the foregoing compounds, in the emulsion polymerization, additives may be used such as electrolytes, stabilizers, thickeners, defoaming agents, antioxidants, vulcanizers, antifreezing agents, gelling agents, and vulcanization accelerators. The additives may be selected from the additives described in Synthetic Rubber Handbook.

In the coating solution of the latex polymer to be used in the invention, an aqueous solvent can be used as the solvent, and a water-miscible organic solvent can be used additionally. Examples of usable water-miscible organic solvents include alcohols (for example, methyl alcohol, ethyl alcohol, and propyl alcohol), cellosolves (for example, methyl cellosolve, ethyl cellosolve, and butyl cellosolve), ethyl acetate, and dimethylformamide. The amount of the organic solvent to be added is preferably 50 mass % or less of the entire solvent, more preferably 30 mass % or less of the entire solvent.

Furthermore, in the latex polymer to be used in the invention, the polymer concentration is, based on the amount of the latex liquid, preferably 10 mass % to 70 mass %, more preferably 20 mass % to 60 mass %, and especially preferably 30 mass % to 55 mass %.

The amount of the latex polymer to be added is preferably 50 to 95% by mass and more preferably 70 to 90% by mass as its solid content based on all polymers in the receptor layer.

The latex polymer in the image-receiving sheet of the present invention includes a state of a gel or dried film formed by removing a part of solvents by vaporization.

### <Water-Soluble Polymer>

The image-receiving sheet of the present invention, preferably the second embodiment of the present invention, is provided preferably with at least one receptor layer containing a latex polymer and a water-soluble polymer. The water-soluble polymer which can be scarcely dyed is made to exist between the latex polymers, whereby the dye stuck to the latex polymer can be prevented from diffusing. As a result, it is possible to decrease a variation in the sharpness of the receptor layer with time, whereby a recording image reduced in the variation of a transferred image with time can be formed:

The water-soluble polymer which can be used in the present invention, preferably in the second embodiment of the present invention, is natural polymers (polysaccharide type, microorganism type and animal type), semi-synthetic polymers (a cellulose-based, starch-based and alginic acid-based) and synthetic polymer type (vinyl type and others), and synthetic polymers including polyvinyl alcohols which will be explained later and natural or semi-synthetic polymers using celluloses as starting materials correspond to the water-soluble polymer usable in the present invention, preferably the second embodiment of the present invention.

Among the water-soluble polymers which can be used in the present invention, preferably the second embodiment of the present invention, the natural polymers and the semi-synthetic polymers will be explained in detail.

Specific examples include the following polymers: plant polysaccharides such as gum arabics, κ-canageenans, τ-carrageenans, λ-carrageenans, guar gums (e.g. SUPERCOL manufactured by Squalon), locust bean gums, pectins, tragacanths, corn starches (e.g. PURITY-21 manufactured by National Starch & Chemical Co.), and phosphorylated starches (e.g. NATIONAL 78-1898 manufactured by National Starch & Chemical Co.); microbial polysaccharides such as xanthan gums (e.g. KELTROL T manufactured by Kelco) and dextrins (e.g. NADEX 360 manufactured by National Starch & Chemical Co.); animal polysaccharides such as gelatins (e.g. Crodyne B419 manufactured by Croda), caseins, sodium chondroitin sulfates (e.g. CROMOIST CS manufactured by Croda); cellulose-based polymers such as ethylcelluloses (e.g. CELLOFAS WLD manufactured by I.C.I.), carboxymethylcelluloses (e.g. CMC manufactured by Daicel), hydroxyethylcelluloses (e.g. NEC manufactured by Daicel), hydroxypropylcelluloses (e.g. KLUCEL manufactured by Aqualon), methylcelluloses (e.g. VISCONTRAN manufactured by Henkel), nitrocelluloses (e.g. Isopropyl Wet manufactured by Hercules), and cationated celluloses (e.g. CRODACEL QM manufactured by Croda); starches such as phosphorylated starches (e.g. NATIONAL 78-1898 manufactured by National Starch & Chemical Co.); alginic acid-based compounds such as sodium alginates (e.g. KELTONE manufactured by Kelco) and propylene glycol alginates; and other polymers such as cationated guar gums (e.g. HI-CARE 1000 manufactured by Alcolac) and sodium hyaluronates (e.g. HYALURE manufactured by Lifecare Biomedial) (all of the names are trade names).

Among the water-soluble polymers which can be used in the present invention, preferably in the second embodiment of the present invention, the synthetic polymers will be explained in detail. Examples of the acryl type include sodium polyacrylates, polyacrylic acid copolymers, polyacrylamides, polyacrylamide copolymers and polydiethylaminoethyl(meth)acrylate quaternary salts or their copolymers. Examples of the vinyl type include polyvinylpyrrolidones, polyvinylpyrrolidone copolymers and polyvinyl alcohols. Examples of the others include polyethylene glycols, polypropylene glycols, polyisopropylacrylamides, polymethyl vinyl ethers, polyethyleneimines, polystyrenesulfonic acids or their copolymers, naphthalenesulfonic acid condensate salts, polyvinylsulfonic acids or their copolymers, polyacrylic acids or their copolymers, acrylic acid or its copolymers, maleic acid copolymers, maleic acid monoester copolymers, acryloylmethylpropanesulfonic acid or its copolymers, polydimethyldiallylammonium chlorides or their copolymers, polyamidines or their copolymers, polyimidazolines, dicyanamide type condensates, epichlorohydrin/dimethylamine condensates, Hofmann decomposed products of polyacrylamides and water-soluble polyesters (Plascoat Z-221, Z-446, Z-561, Z-450, Z-565, Z-850, Z-3308, RZ-105, RZ-570, Z-730 and RZ-142 (all of these names are trade names) manufactured by Goo Chemical Co., Ltd.).

In addition, highly water absorptive polymers, namely, homopolymers of vinyl monomers having —COOM or —SO₃M (M is a hydrogen atom or an alkali metal) or copolymers of these vinyl monomers among them or with other vinyl monomers (for example, sodium methacrylate, ammonium methacrylate, Sumikagel L-5H (trade name) manufactured by Sumitomo Chemical Co., Ltd. may also be used.

Among the water-soluble synthetic polymers usable in the present invention, preferably in the second embodiment of the present invention, polyvinyl alcohols will be explained in more detail. Examples of completely saponificated polyvinyl alcohol include PVA-105 [polyvinyl alcohol (PVA) content: 94.0 mass % or more; degree of saponification: 98.5±0.5 mol %; content of sodium acetate: 1.5 mass % or less; volatile constituent: 5.0 mass % or less; viscosity (4 mass %; 20° C.): 5.6±0.4 CPS]; PVA-110 [PVA content: 94.0 mass %; degree of saponification: 98.5±0.5 mol %; content of sodium acetate: 1.5 mass %; volatile constituent: 5.0 mass %; viscosity (4 mass %; 20° C.): 11.0-10.8 CPS]; PVA-117 [PVA content: 94.0 mass %; degree of saponification: 98.5±0.5 mol %; content of sodium acetate: 1.0 mass %; volatile constituent: 5.0 mass %; viscosity (4 mass %; 20° C.): 28.0±3.0 CPS];

PVA-117H [PVA content: 93.5 mass %; degree of saponification: 99.6±0.3 mol %; content of sodium acetate: 1.85 mass %; volatile constituent: 5.0 mass %; viscosity (4 mass %; 20° C.): 29.0±3.0 CPS]; PVA-120 [PVA content: 94.0 mass %; degree of saponification: 98.5±0.5 mol %; content of sodium acetate: 1.0 mass %; volatile constituent: 5.0 mass %; viscosity (4 mass %; 20° C.): 39.5±4.5 CPS]; PVA-124 [PVA content: 94.0 mass %; degree of saponification: 98.5±0.5 mol %; content of sodium acetate: 1.0 mass %; volatile constituent: 5.0 mass %; viscosity (4 massW 20° C.): 60.0±6.0 CPS];
PVA-124H [PVA content: 93.5 mass %; degree of saponification: 99.6±0.3 mol %; content of sodium acetate: 1.85 mass %; volatile constituent: 5.0 mass %; viscosity (4 mass %; 20° C.): 61.0±6.0 CPS]; PVA-CS [PVA content: 94.0 mass %; degree of saponification: 97.5±0.5 mol %; content of sodium acetate: 1.0 mass %; volatile constituent: 5.0 mass %; viscosity (4 mass %; 20° C.): 27.5±3.0 CPS]; PVA-CST [PVA content: 94.0 mass %; degree of saponification: 96.0±0.5 mol %; content of sodium acetate: 1.0 mass %; volatile constituent: 5.0 mass %; viscosity (4 mass %; 20° C.): 27.0±3.0 CPS]; PVA-HC [PVA content: 90.0 mass %; degree of saponification: 99.85 mol % or more; content of sodium acetate: 2.5 mass %; volatile constituent: 8.5 mass %; viscosity (4 mass %; 20° C.): 25.0±3.5 CPS] (all trade names, manufactured by Kuraray Co., Ltd.), and the like.

Examples of partially saponificated polyvinyl alcohol include PVA-203 [PVA content: 94.0 mass %; degree of saponification: 88.0±1.5 mol %; content of sodium acetate: 1.0 mass %; volatile constituent: 5.0 mass %; viscosity (4 mass %; 20° C.): 3.4±0.2 CPS]; PVA-204 [PVA content: 94.0 mass %; degree of saponification: 88.0±1.5 mol %; content of sodium acetate: 1.0 mass %; volatile constituent: 5.0 mass %; viscosity (4 mass %; 20° C.): 3.9±0.3 CPS]; PVA-205 [PVA content: 94.0 mass %; degree of saponification: 88.0±1.5 mol %; content of sodium acetate: 1.0 mass %; volatile constituent: 5.0 mass %; viscosity (4 mass %; 20° C.): 5.0±0.4 CPS];

PVA-210 [PVA content: 94.0 mass %; degree of saponification: 88.0±1.0 mol %; content of sodium acetate: 1.0 mass %; volatile constituent: 5.0 mass %; viscosity (4 mass %; 20° C.): 9.0±1.0 CPS]; PVA-217 [PVA content 94.0 mass %; degree of saponification: 88.0±1.0 mol %; content of sodium acetate: 1.0 mass %; volatile constituent: 5.0 mass %; viscosity (4 mass %; 20° C.): 22.5±2.0 CPS]; PVA-220 [PVA content 94.0 mass %; degree of saponification: 88.0±1.0 mol %; content of sodium acetate: 1.0 mass %; volatile constituent: 5.0 mass %; viscosity (4 mass %; 20° C.): 30.0±3.0 CPS];
PVA-224 [PVA content: 94.0 mass %; degree of saponification: 88.0±1.5 mol %; content of sodium acetate: 1.0 mass %; volatile constituent: 5.0 mass %; viscosity (4 mass %; 20° C.): 44.0±4.0 CPS]; PVA-228 [PVA content 94.0 mass %; degree of saponification: 88.0±1.5 mol %; content of sodium acetate: 1.0 mass %; volatile constituent: 5.0 mass %; viscosity (4 mass %; 20° C.): 65.0±5.0 CPS]; PVA-235 [PVA content: 94.0 mass %; degree of saponification: 88.0±1.5 mol %; content of sodium acetate: 1.0 mass %; volatile constituent: 5.0 mass %; viscosity (4 mass %; 20° C.): 95.0±15.0 CPS];
PVA-217EE [PVA content: 94.0 mass %; degree of saponification: 88.0±1.0 mol %; content of sodium acetate: 1.0 mass %; volatile constituent: 5.0 mass %; viscosity (4 mass %; 20° C.): 23.0±3.0 CPS]; PVA-217E [PVA content: 94.0 mass %; degree of saponification: 88.0±1.0 mol %; content of sodium acetate: 1.0 mass %; volatile constituent: 5.0 mass %; viscosity (4 mass %; 20° C.): 23.0±3.0 CPS]; PVA-220E [PVA content: 94.0 mass %; degree of saponification: 88.0±1.0 mol %; content of sodium acetate: 1.0 mass %; volatile constituent: 5.0 mass %; viscosity (4 mass %; 20° C.): 31.0±4.0 CPS];
PVA-224E [PVA content: 94.0 mass %; degree of saponification: 88.0±1.0 mol %; content of sodium acetate: 1.0 mass %; volatile constituent: 5.0 mass %; viscosity (4 mass %; 20° C.): 45.0±5.0 CPS]; PVA-403 [PVA content: 94.0 mass %; degree of saponification: 80.0±1.5 mol %; content of sodium acetate: 1.0 mass %; volatile constituent: 5.0 mass %; viscosity (4 mass %; 20° C.): 3.1±0.3 CPS]; PVA-405 [PVA content: 94.0 mass %; degree of saponification: 81.5±1.5 mol %; content of sodium acetate: 1.0 mass %; volatile constituent: 5.0 mass %; viscosity (4 mass %; 20° C.): 4.8±0.4 CPS];
PVA-420 [PVA content: 94.0 mass %; degree of saponification: 79.5±1.5 mol %; content of sodium acetate: 1.0 mass %; volatile constituent: 5.0 mass %]; PVA-613 [PVA content: 94.0 mass %; degree of saponification: 93.5±1.0 mol %; content of sodium acetate: 1.0 mass %; volatile constituent: 5.0 mass %; viscosity (4 mass %; 20° C.): 16.5±2.0 CPS]; L-8 [PVA content: 96.0 mass %; degree of saponification: 71.0±1.5 mol %; content of sodium acetate: 1.0 mass % (ash); volatile constituent: 3.0 mass %; viscosity (4 mass %; 20° C.): 5.4±0.4 CPS] (all trade names, manufactured by Kuraray Co., Ltd.), and the like.

The above values were measured in the manner described in JIS K-6726-1977.

With respect to modified polyvinyl alcohols, those described in Koichi Nagano, et al., “Poval”, Kobunshi Kankokai, Inc. are useful. The modified polyvinyl alcohols include polyvinyl alcohols modified by cations, anions, —SH compounds, alkylthio compounds, or silanols.

Examples of such modified polyvinyl alcohols (modified PVA) include C polymers such as C-118, C-318, C-318-2A, and C-506 (all being trade names of Kuraray Co., Ltd.); HL polymers such as HL-12E and HL-1203 (all being trade names of Kuraray Co., Ltd.); UM polymers such as HM-03 and HM-N-03 (all being trade names of Kuraray Co., Ltd.); K polymers such as KL-118, KL-318, KL-506, KM-118T, and KM-618 (all being trade names of Kuraray Co., Ltd.); M polymers such as M-115 (a trade name of Kuraray Co., Ltd.); MP polymers such as MP-102, MP-202, and MP-203 (all being trade names of Kuraray Co., Ltd.); MPK polymers such as MPK-1, MPK-2, MPK-3, MPK-4, MPK-5, MPK-6 (all being trade names of Kuraray Co., Ltd.); R polymers such as R-1130, R-2105, and R-2130 (all being trade names of Kuraray Co., Ltd.); and V polymers such as V-2250 (a trade name of Kuraray Co., Ltd.).

The viscosity of polyvinyl alcohol can be adjusted or stabilized by adding a trace amount of a solvent or an inorganic salt to an aqueous solution of polyvinyl alcohol, and there can be employed compounds described in the aforementioned reference “Poval”, Koichi Nagano et al., published by Kobunshi Kankokai, pp. 144-154. For example, a coated surface property can be improved by an addition of boric acid. The amount of boric acid added is preferably 0.01 to 40 mass % with respect to polyvinyl alcohol.

Preferred binders are transparent or semitransparent, generally colorless, and water-soluble. Examples include natural resins, polymers and copolymers; synthetic resins, polymers, and copolymers; and other media forming films: for example, rubbers, polyvinyl alcohols, hydroxyethyl celluloses, cellulose acetates, cellulose acetate butylates, polyvinylpyrrolidones, starches, polyacrylic acids, polymethyl methacrylates, polyvinyl chlorides, polymethacrylic acids, styrene/maleic acid anhydride copolymers, styrene/acrylonitrile copolymers, styrene/butadiene copolymers, polyvinylacetals (e.g., polyvinylformals and polyvinylbutyrals), polyesters, polyurethanes, phenoxy resins, polyvinylidene chlorides, polyepoxides, polycarbonates, polyvinyl acetates, polyolefins, cellulose esters, and polyamides.

The amount of the water-soluble polymer is preferably 50 mass % or less, more preferably 30 mass % or less, still more preferably 0.005 to 10 mass % and particularly preferably 0.5 to 5 mass % in total polymers contained in the receptor layer.

### <Releasing Agent>

Also, a releasing agent may be compounded in the receptor layer to prevent thermal fusion with a thermal transfer sheet (ink sheet) when an image is formed. As the releasing agent, silicone oil or a phosphate-based plasticizer fluorine-series compound may be used and particularly, silicone oil is preferably used: As the silicone oil, modified silicone oil such as epoxy-modified, alkyl-modified, amino-modified, carboxyl-modified, alcohol-modified, fluorine-modified, alkyl aralkyl polyether-modified, epoxy/polyether-modified or polyether-modified silicone oil is preferably used. Among these compounds, a reaction product between vinyl-modified silicone oil and hydrogen-modified silicone oil is preferable. The amount of the releasing agent is preferably 0.2 to 30 parts by mass.

### <Emulsion>

Hydrophobic additives, such as a lubricant, an antioxidant, and the like, can be introduced into a layer of the image-receiving sheet (e.g. a receptor layer, a heat insulation layer, an undercoat layer), by using a known method described in U.S. Pat. No. 2,322,027, and the like. In this case, a high-boiling organic solvent, as described in U.S. Pat. No. 4,555,470, U.S. Pat. No. 4,536,466, U.S. Pat. No. 4,536,467, U.S. Pat. No. 4,587,206, U.S. Pat. No. 4,555,476 and U.S. Pat. No. 4,599,296, JP-B-3-62256, and the like, may be used in combination with a low-boiling organic solvent having a boiling point of 50 to 160° C., according to the need. Also, these lubricants, antioxidants, and high-boiling organic solvents may be respectively used in combination of two or more.

As the antioxidant (hereinafter, also referred to as a radical trapper in this specification), a compound represented by any one of the following Formulae (E-1) to (E-3) is preferably used.

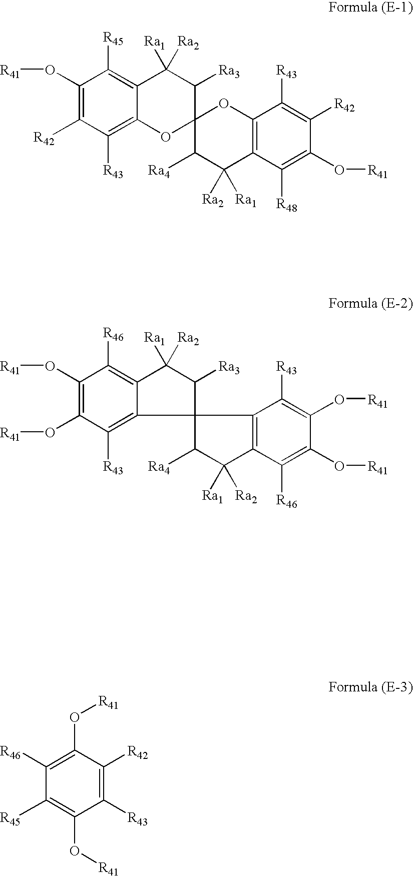

R₄₁ represents an aliphatic group, an aryl group, a heterocyclic group, an acyl group, an aliphatic oxycarbonyl group, an aryloxycarbonyl group, an aliphatic sulfonyl group, an arylsulfonyl group, a phosphoryl group, or a group —Si(R₄₇)(R₄₈)(R₄₉) in which R₄₇, R₄₈ and R₄₉ each independently represent an aliphatic group, an aryl group, an aliphatic oxy group, or an aryloxy group. R₄₂, R₄₃, R₄₅, and R₄₆ each independently represent a hydrogen atom, or a substituent. Rₐ₁, Rₐ₂, Rₐ₃; and Rₐ₄ each independently represent a hydrogen atom, or an aliphatic group (for example, methyl, ethyl).

With respect to the compounds represented by any one of the Formulae (E-1) to (E-3), the groups that are preferred from the viewpoint of the effect to be obtained by the present invention, are explained below.

In the Formulae (E-1) to (E-3), it is preferred that R₄₁ represent an aliphatic group, an acyl group, an aliphatic oxycarbonyl group, an aryloxycarbonyl group, or a phosphoryl group, and R₄₂, R₄₃, R₄₅, and R₄₆ each independently represent a hydrogen atom, an aliphatic group, an aliphatic oxy group, or an acylamino group. It is more preferred that R₄₁ represent an aliphatic group, and R₄₂, R₄₃, R₄₅ and R₄₆ each independently represent a hydrogen atom, or an aliphatic group.

Preferable specific examples of the compounds represented by any one of the Formulae (E-1) to (E-3) are shown below, but the present invention is not limited to these compounds.

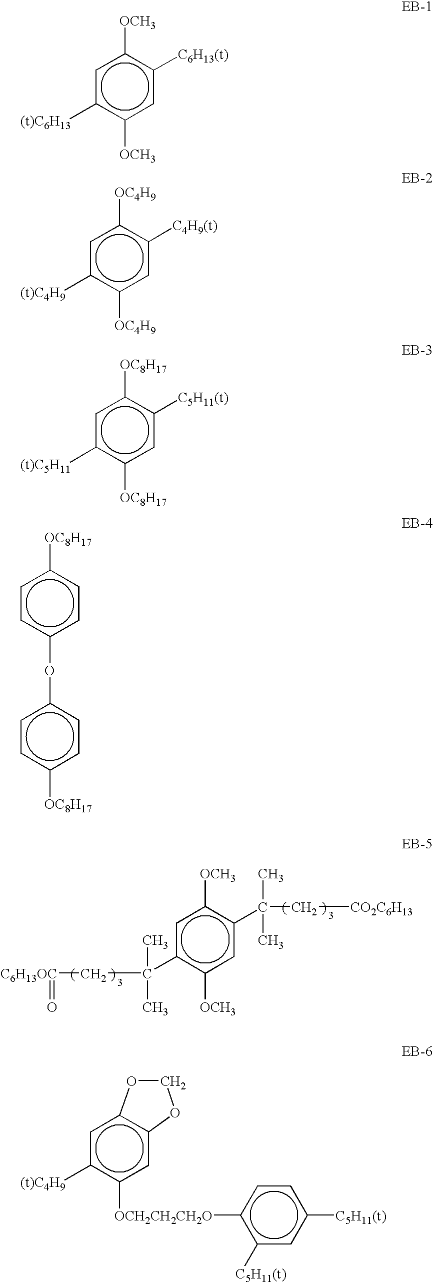

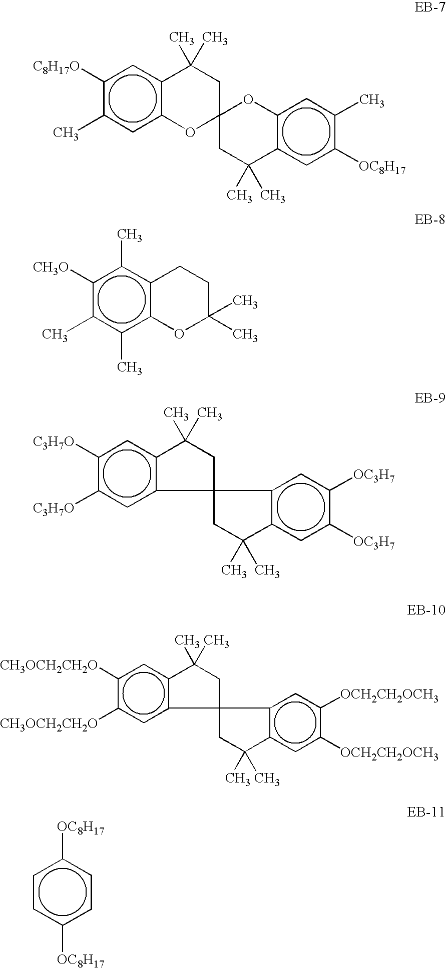

As the lubricant, solid waxes such as polyethylene wax, amide wax and Teflon powder; silicone oil, phosphate-series compounds, fluorine-based surfactants, silicone-based surfactants and others including releasing agents known in the technical fields concerned may be used. Fluorine-series compounds typified by fluorine-based surfactants, silicone-based surfactants and silicone-series compounds such as silicone oil and/or its hardened products are preferably used.

As the silicone oil, straight silicone oil and modified silicone oil or their hardened products may be used. Examples of the straight silicone oil include dimethylsilicone oil, methylphenylsilicone oil and methyl.hydrogen silicone oil. Examples of the dimethylsilicone oil include KF96-10, KF96-100, KF96-1000, KF96H-10000, KF96H-12500 and KF96H-100000 (all of these names are trade names, manufactured by Shin-Etsu Chemical Co., Ltd.). Examples of the dimethylsilicone oil include KF50-100, KF54 and KF56 (all of these names are trade names, manufactured by Shin-Etsu Chemical Co., Ltd.).

The modified silicone oil may be classified into reactive silicone oils and non-reactive silicone oils. Examples of the reactive silicone oils include amino-modified, epoxy-modified, carboxyl-modified, hydroxy-modified, methacryl-modified, mercapto-modified, phenol-modified or one-terminal reactive/hetero-functional group-modified silicone oils. Examples of the amino-modified silicone oil include KF-393, KF-857, KF-858, X-22-3680, X-22-3801C, KF-8010, X-22-161A and KF-8012 (all of these names are trade names, manufactured by Shin-Etsu Chemical Co., Ltd.). Examples of the epoxy-modified silicone oil include KF-100T, KF-101, KF-60-164, KF-103, X-22-343 and X-22-3000T (all of these names are trade names, manufactured by Shin-Etsu Chemical Co., Ltd.). Examples of the carboxyl-modified silicone oil include X-22-162C (trade name, manufactured by Shin-Etsu Chemical Co., Ltd.). Examples of the hydroxy-modified silicone oil include X-22-160AS, KF-6001, KF-6002, KF-6003, X-22-170DX, X-22-176DX, X-22-176D and X-22-176DF (all of these names are trade names, manufactured by Shin-Etsu Chemical Co., Ltd.). Examples of the methacryl-modified silicone oil include X-22-164A, X-22-164C, X-24-8201, X-22-174D and X-22-2426 (all of these names are trade names, manufactured by Shin-Etsu Chemical Co., Ltd.).

Reactive silicone oils may be hardened upon use, and may be classified into a reaction-curable type, photocurable type and catalyst-curable type. Among these types, silicone oil that is the reaction-curable type is particularly preferable. As the reaction-curable type silicone oil, products obtained by reacting an amino-modified silicone oil with an epoxy-modified silicone oil and then by curing are desirable. Also, examples of the catalyst-curable type or photocurable type silicone oil include KS-705F-PS, KS-705F—PS-1 and KS-770-PL-3 (all of these names are trade names, catalyst-curable silicone oils, manufactured by Shin-Etsu Chemical Co., Ltd.) and KS-720 and KS-774-PL-3 (all of these names are trade names, photocurable silicone oils, manufactured by Shin-Etsu Chemical Co., Ltd.). The amount of the curable type silicone oil is preferably 0.5 to 30% by mass based on the resin constituting the receptor layer. The releasing agent is used preferably in an amount of 2 to 4% by mass and further preferably 2 to 3% by mass based on 100 parts by mass of the polyester resin. If the amount is too small, the releasability cannot be secured without fail, whereas if the amount is excessive, a protective layer of the ink sheet is not transferred to the image-receiving sheet resultantly.

Examples of the non-reactive silicone oil include polyether-modified, methylstyryl-modified, alkyl-modified, higher fatty acid ester-modified, hydrophilic special-modified, higher alkoxy-modified or fluorine-modified silicone oils. Examples of the polyether-modified silicone oil include KF-6012 (trade name, manufactured by Shin-Etsu Chemical Co., Ltd.) and examples of the methylstyryl-modified silicone oil include 24-510 and KF41-410 (all of these names are trade names, manufactured by Shin-Etsu Chemical Co., Ltd.). Modified silicones represented by any one of the following Formulae 1 to 3 may also be used.

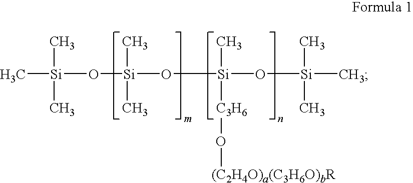

In the Formula 1, R represents a hydrogen atom, an aryl group or a straight-chain or branched alkyl group which may be substituted with a cycloalkyl group. m and n respectively denote an integer of 2,000 or less, and a and b respectively denote an integer of 30 or less.

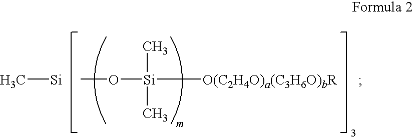

In the Formula 2, R represents a hydrogen atom, an aryl group or a straight-chain or branched alkyl group which may be substituted with a cycloalkyl group. m denotes an integer of 2,000 or less, and a and b respectively denote an integer of 30 or less.

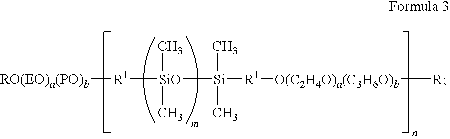

In the Formula 3, R represents a hydrogen atom, an aryl group or a straight-chain or branched alkyl group which may be substituted with a cycloalkyl group. m and n respectively denote an integer of 2,000 or less, and a and b respectively denote an integer of 30 or less. R¹ represents a single bond or a divalent linking group, E represents an ethylene group which may have a substituent or substituents, P represents a propylene group which may have a substituent or substituents.

Silicone oils such as those mentioned above are described in “SILICONE HANDBOOK” (The Nikkan Kogyo Shimbun, Ltd.) and the technologies described in each publication of JP-A-8-108636 and JP-A-2002-264543 may be preferably used as the technologies to cure the curable silicone oils.

Examples of the high-boiling organic solvent include phthalates (e.g., dibutyl phthalate, dioctyl phthalate, di-2-ethylhexyl phthalate), phosphates or phosphates (e.g., triphenyl phosphate, tricresyl phosphate, tri-2-ethylhexyl phosphate), fatty acid esters (e.g., di-2-ethylhexyl succinate, tributyl citrate), benzoates (e.g., 2-ethylhexyl benzoate, dodecyl benzoate), amides (e.g., N,N-diethyldodecane amide, N,N-dimethylolein amide), alcohols or phenols (e.g., iso-stearyl alcohol, 2,4-di-tert-amyl phenol), anilines (e.g., N,N-dibutyl-2-butoxy-5-tert-octylaniline), chlorinated paraffins, hydrocarbons (e.g., dodecyl benzene, diisopropyl naphthalene), and carboxylic acids (e.g., 2-(2,4-di-tert-amyl phenoxy)butyrate).

Preferably the compounds shown below are used.

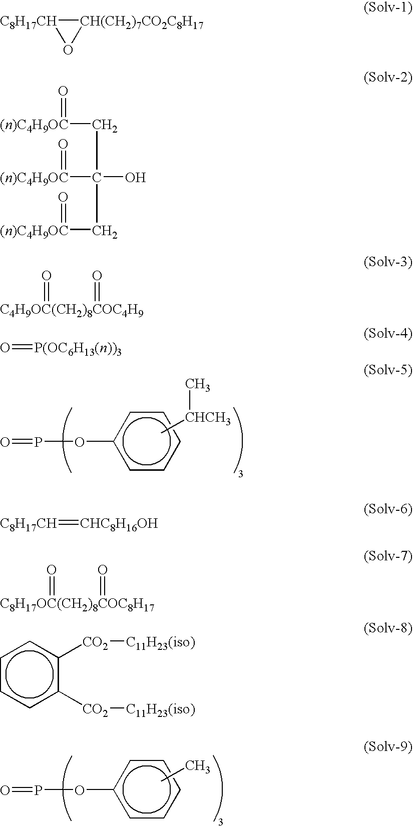

Further, the high-boiling organic solvent may be used in combination with, as an auxiliary solvent, an organic solvent having a boiling point of 30° C. or more and 160° C. or less, such as ethyl acetate, butyl acetate, methyl ethyl ketone, cyclohexanone, methylcellosolve acetate, or the like. The high-boiling organic solvent is used in an amount of generally 10 g or less, preferably 5 g or less, and more preferably 1 to 0.1 g, per 1 g of the hydrophobic additives to be used. The amount is also preferably 1 ml or less, more preferably 0.5 ml or less, and particularly preferably 0.3 ml or less, per 1 g of the binder.

A dispersion method that uses a polymer, as described in JP-B-51-39853 and JP-A-51-59943, and a method wherein the addition is made with them in the form of a dispersion of fine particles, as described, for example, in JP-A-62-30242, can also be used. In the case of a compound that is substantially insoluble in water, other than the above methods, a method can be used wherein the compound is dispersed and contained in the form of a fine particle in a binder.

When the hydrophobic compound is dispersed in a hydrophilic colloid, various surfactants may be used. For example, those listed as examples of the surfactant in JP-A-59-157636, page (37) to page (38) may be used. It is also possible to use phosphoates-based surfactants described in JP-A-7-56267, JP-A-7-228589, and West German Patent Application Laid-Open (OLS) No. 1,932,299A.

### <Film Hardener>

An inorganic or organic film hardener is preferably added to harden the receptor layer of the heat-sensitive image-receiving sheet of the present invention, preferably the second embodiment of the present invention. The film hardener may be added in the coating layers (for example, the receptor layer and heat insulation layer and undercoat layer) of the image-receiving sheet. Examples of hardener that can be used in the present invention include H-1,4,6,8, and 14 in JP-A-1-214845 in page 17; compounds (H-1 to H-54) represented by one of the formulae (VII) to (XII) in U.S. Pat. No. 4,618,573, columns 13 to 23; compounds (H-1 to H-76) represented by the formula (6) in JP-A-2-214852, page 8, the lower right (particularly, H-14); and compounds described in claim 1 in U.S. Pat. No. 3,325,287. Examples of the hardening agent include hardening agents described, for example, in U.S. Pat. No. 4,678,739, column 41, U.S. Pat. No. 4,791,042, JP-A-59-116655, JP-A-62-245261, JP-A-61-18942, and JP-A-4-218044. More specifically, an aldehyde-series hardening agent (formaldehyde, etc.), an aziridine-series hardening agent, an epoxy-series hardening agent, a vinyl sulfone-series hardening agent (N,N′-ethylene-bis(vinylsulfonylacetamido)ethane, etc.), an N-methylol-series hardening agent (dimethylol urea, etc.), a boric acid, a metaboric acid, or a polymer hardening agent (compounds described, for example, in JP-A-62-234157), can be mentioned. Preferable examples of the hardener include a vinylsulfone-series hardener and chlorotriazines.

More preferable hardeners in the present invention, preferably in the second embodiment of the present invention, are compounds represented by the following Formula (B) or (C).

(CH₂═CH—SO₂)ₙ-L Formula (B)

(X—CH₂—CH₂—SO₂)ₙ—L Formula (C)

In the Formulae (B) and (C), X represents a halogen atom, L represents an organic linkage group having n-valency. When the compound represented by the Formula (B) or (C) is a low-molecular compound, n denotes an integer from 1 to 4. When the compound represented by the Formula (B) or (C) is a high-molecular compound, n denotes an integer ranging from 10 to 1,000.

In the Formulae (B) and (C), X is preferably a chlorine atom or a bromine atom, and further preferably a bromine atom. n that is an integer from 1 to 4, is preferably an integer from 2 to 4, more preferably 2 or 3 and most preferably 2.

L represents an organic group having n-valency, and is preferably an aliphatic hydrocarbon group, an aromatic hydrocarbon group or a heterocyclic group, provided that these groups may be combined through an ether bond, ester bond, amide bond, sulfonamide bond, urea bond, urethane bond or the like. Also, each of these groups may have a substituent. Examples of the substituent include a halogen atom, alkyl group, aryl group, heterocyclic group, hydroxyl group, alkoxy group, aryloxy group, alkylthio group, arylthio group, acyloxy group, alkoxycarbonyl group, carbamoyloxy group, acyl group, acyloxy group, acylamino group, sulfonamide group, carbamoyl group, sulfamoyl group, sulfonyl group, phosphoryl group, carboxyl group and sulfo group. Among these groups, a halogen atom, alkyl group, hydroxy group, alkoxy group, aryloxy group and acyloxy group are preferable.

Specific examples of the vinylsulfone-series hardener include, though not limited to, the following compounds (VS-1) to (VS-27).

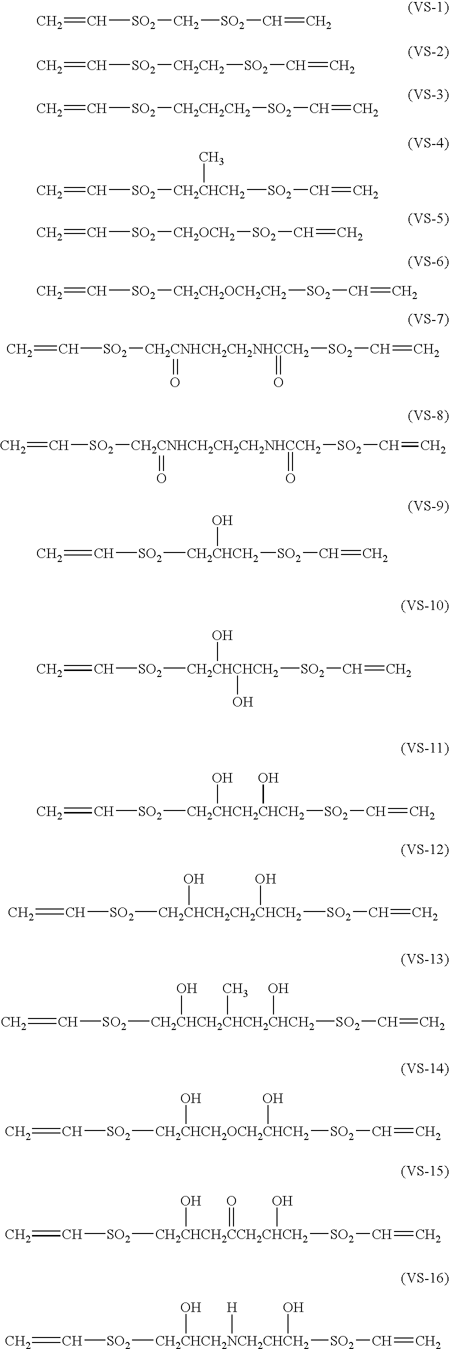

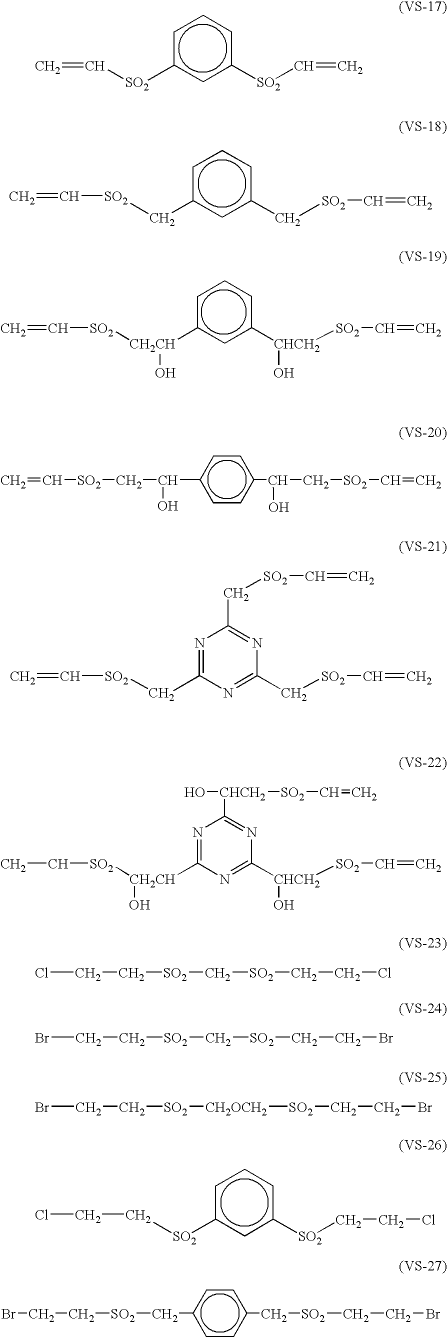

These hardeners may be obtained with reference to the method described in, for example, the specification of U.S. Pat. No. 4,173,481.

Also, as the chlorotriazine-series hardener, 1,3,5-triazine compounds in which the 2nd position, 4th position or 6th position of the compound is substituted with at least one chlorine atom are preferable. 1,3,5-triazine compounds in which the 2nd position, 4th position or 6th position of the compound is substituted with two or three chlorine atoms are more preferable.

The 2nd position, 4th position or 6th position of the compound may be substituted with at least one chlorine atom and the remainder positions may be substituted with groups other than a chlorine atom. Examples of these other groups include a hydrogen atom, bromine atom, fluorine atom, iodine atom, alkyl group, alkenyl group, alkinyl group, cycloalkyl group, cycloalkenyl group, aryl group, heterocyclic group, hydroxy group, nitro group, cyano group, amino group, hydroxylamino group, alkylamino group, arylamino group, heterocyclic amino group, acylamino group, sulfonamide group, carbamoyl group, sulfamoyl group, sulfo group, carboxyl group, alkoxy group, alkenoxy group, aryloxy group, heterocyclic oxy group, acyl group, acyloxy group, alkyl- or aryl-sulfonyl group, alkyl- or aryl-sulfinyl group, alkyl- or aryl-sulfonyloxy group, mercapto group, alkylthio group, alkenylthio group, arylthio group, heterocyclic thio group and alkyloxy- or aryloxy-carbonyl group.

Specific examples of the chlorotriazine-series hardener include, though not limited to, 4,6-dichloro-2-hydroxy-1,3,5-triazine or its Na salt, 2-chloro-4,6-diphenoxytriazine, 2-chloro-4,6-bis[2,4,6-trimethylphenoxy]triazine, 2-chloro-4,6-diglycidoxy-1,3,5-triazine, 2-chloro-4-(n-butoxy)-6-glycidoxy-1,3,5-triazine, 2-chloro-4-(2,4,6-trimethylphenoxy)-6-glycidoxy-1,3,5-triazine, 2-chloro-4-(2-chloroethoxy)-6-(2,4,6-trimethylphenoxy)-1,3,5-triazine, 2-chloro-4-(2-bromoethoxy)-6-(2,4,6-trimethylphenoxy)-1,3,5-triazine, 2-chloro-4-(2-di-n-butylphosphateethoxy)-6-(2,4,6-trimethylphenoxy)-1,3,5-triazine and 2-chloro-4-(2-di-n-butylphosphateethoxy)-6-(2,6-xylenoxy)-1,3,5-triazine.

Such a compound is easily produced by reacting cyanur chloride (namely, 2,4,6-trichlorotriazine) with, for example, a hydroxy compound, thio compound or amino compound corresponding to the substituent on the heterocycle.

These hardeners are preferably used in an amount of 0.001 to 1 g, and further preferably 0.005 to 0.5 g, per 1 g of the hydrophilic binder.

The receptor layer is preferably formed by dissolving the above receptor polymer, polymer including a unit having an ultraviolet absorbing ability, a releasing agent, and other materials in a solvent to mix these ingredients, and by applying the resulting solution. As the solvent, methyl ethyl ketone, toluene or the like may be used, though the solvent used in the present invention is not limited to these solvents.

The amount of the receptor layer to be applied is preferably 0.5 to 10 g/m² (solid basis, hereinafter, the amount to be applied in the present invention is a value on solid basis unless other wise noted).

The film thickness of the receptor layer is preferably 1 to 20 μm.

### (Undercoat Layer)

An undercoat layer is preferably formed between the receptor layer and the support. As the undercoat layer, for example, a white background regulation layer, a charge regulation layer, an adhesive layer or a primer layer is formed. These layers may be formed in the same manner as those described in, for example, each specification of Japanese Patent Nos. 3,585,599 and 2,925,244.

### (Heat Insulation Layer)

In the present invention, preferably in the first, second or fourth embodiment of the present invention, the heat insulation layer (foam layer) serves to protect a support from heat when a thermal head is used to carry out a transfer operation under heating. Also, because the heat insulation layer has high cushion characteristics, a thermal transfer image-receiving sheet having high printing sensitivity can be obtained even in the case of using paper as the substrate.

In the present invention, preferably in the first, second or fourth embodiment of the present invention, the heat insulation layer is made of a resin and a foaming agent. As the resin for the heat insulation layer, known resins such as a urethane resin, acryl resin, methacryl resin and modified olefin resin or those obtained by blending these resins may be used. Each of these resins is dissolved and/or dispersed in an organic solvent or water and the resulting solution is applied to form a heat insulation layer. The heat insulation layer coating solution is preferably an aqueous type coating solution having no influence on the foaming agent. As the coating solution, for example, a water-soluble, water-dispersible or SBR latex, emulsions including a urethane-series emulsion, polyester emulsion, emulsion of vinyl acetate and its copolymer, emulsion of a copolymer of acryl types such as acryl or acrylstyrene, vinyl chloride emulsion, or dispersions of these emulsions may be used. When a microsphere which will be explained later is used as the foaming agent, it is preferable to use an emulsion of vinyl acetate or its copolymer or an emulsion of a copolymer of acryl such as acryl or acrylstyrene.

The glass transition point, softness and filmforming characteristics of these resins can be easily controlled by changing the kind and ratio of the monomer to be copolymerized, and are therefore suitable in the point that desired characteristics are obtained even if a plasticizer and filming adjuvant are not added, that a film is reduced in a change in color when it is stored in various environments after formed, and that it is reduced in material properties with time. Also, among the above resins, a SBR latex is undesirable because it usually has a low glass transition point, tends to cause clogging and tends to be yellowed after a film is formed or while it is stored. A urethane-series emulsion is undesirable because many urethane emulsions contain solvents such as NMP and DMF and therefore tends to have an adverse influence on a foaming agent. A polyester emulsion or dispersion and a vinyl chloride emulsion are undesirable because they generally have high glass transition points, and cause a deterioration in the foaming characteristics of a microsphere. Though there are those which are soft, they are not used preferably because the softness is imparted by adding a plasticizer.

The foaming characteristics of the foaming agent are largely affected by the hardness of a resin. In order for the foaming agent to foam the resin at a desired expansion ratio, the resin is preferably those having a glass transition point of −30 to 20° C. or a minimum filmforming temperature (MFT) of 20° C. or less. Resins having a glass transition point of more than 20° C. lack in softness and cause a deterioration in the foaming characteristics of the foaming agent. Also, resins having a glass transition point of less than −30° C. give rise to blocking caused by adhesiveness (generated on the foaming layer and on the backside of the substrate when the substrate on which the foaming layer has been formed is rolled) and cause defects (for instance, when the image-receiving sheet is cut, the resin of the foaming layer adheres to a cutter blade, which deteriorates outward appearance or allows cutting dimension to be out of order). Also, resins of which the minimum filmforming temperature is more than 20° C. causes filmforming inferiors during coating and drying, giving rise to disorders such as surface cracks.

Examples of the foaming agent include known foaming agents, for example, decomposition type foaming agents such as dinitropentamethylenetetramine, diazoaminobenzene, azobisisobutyronitrile and azodicarboamide, which are decomposed by heating to generate gases such as oxygen, hydrocarbon gas or nitrogen; and microspheres obtained by encapsulating a low-boiling point liquid such as butane and pentane with a resin such as polyvinylidene chloride or polyacrylonitrile to form a microcapsule. Among these materials, microspheres obtained by encapsulating a low-boiling point liquid such as butane and pentane with a resin such as polyvinylidene chloride or polyacrylonitrile to form a microcapsule are preferably used. These foaming agents are respectively foamed by heating after the foam layer is formed, and the resulting foamed layer has high cushion characteristics and heat insulation characteristics. The amount of the foaming agent is preferably in a range preferably from 0.5 to 100 parts by mass based on 100 parts by mass of the resin used to form the foaming layer. When the amount is less than 0.5 parts by mass, the cushion characteristics of the foam layer is reduced and therefore, the effect of the foam layer is not obtained. When the amount exceeds 100 parts by mass, the hollow ratio of the foamed layer becomes so large that the mechanical strength of the foam layer is reduced and the foam layer cannot stand to usual handling. Also, the surface of the foam layer loses smoothness, producing an adverse effect on the outward appearance and image quality. Also, the thickness of the whole foam layer is preferably 30 to 100 μm. When the thickness is less than 30 μm, the foam layer has insufficient cushion characteristics and insulation, whereas when the thickness is more than 100 μm, the effect of the foam layer is not improved, bringing about reduced strength. Also, as to the particle diameter of the foaming agent, the volume average particle diameter of the foaming agent before the foam layer is foamed is about 5 to 15 μm and the volume average particle diameter of the foaming agent after the foam layer is foamed is 20 to 50 μm. Foaming agents having a volume average particle diameter of less than 5 μm before foamed or foaming agents having a volume average particle diameter of less than 20 μm after foamed have a low cushion effect. Foaming agents having a volume average particle diameter exceeding 15 μm before foamed or foaming agents having a volume average particle diameter exceeding 50 μm after foamed each make the surface of the foam layer irregular, and eventually have an adverse influence on the quality of the formed image. Therefore, an amount out of the above range is undesirable,

It is particularly preferable to use, among the above foaming agents, a low-temperature foaming type micropsphere in which the softening point of the capsule wall and foaming start temperature are respectively 100° C. or less, and which has an optimum foaming temperature (temperature at which the expansion ratio is highest when a heating time is one minute) of 140° C. or less, and to make the heating temperature as low as possible when the foaming agent is foamed. The use of a microsphere having a lower foaming temperature makes it possible to prevent thermal wrinkles and curling of the substrate. This microsphere having a low foaming temperature can be obtained by controlling the amount of a thermoplastic resin such as polyvinylidene chloride and polyacrilonitrile which forms the capsule wall. The volume average particle diameter is preferably 5 to 15 μm. The foam layer formed using this microsphere has the advantages that air cells obtained by forming are closed cells, the foam layer is foamed using a simple process using only heating and the thickness of the foam layer can be easily controlled by the amount of the microsphere to be compounded.

However, this microsphere is not resistant to an organic solvent. When a coating solution using an organic solvent is used for the foam layer, the capsule wall of the microsphere is eroded, resulting in low foaming characteristics. Therefore, when a microsphere like the above is used, it is desirable to use an aqueous type coating solution that does not contain organic solvents, for example, ketones such as acetone and methyl ethyl ketone, esters such as ethyl acetate and lower alcohols such as methanol and ethanol which erode the capsule wall. Accordingly, it is desirable to use an aqueous type coating solution, specifically, a solution using a water-soluble or water-dispersible resin or a resin emulsion and preferably an acrylstyrene emulsion or modified vinyl acetate emulsion. Also, even if an aqueous type coating solution is used to form a foam layer, a coating solution formulated with a high-boiling point and highly polar solvent such as NMP, DMF or cellosolve as a cosolvent, a filmforming auxiliary, or a plasticizer has an adverse influence on the microsphere. It is therefore necessary to take it into account, for example, to seize the composition of the aqueous resin to be used and the amount of the high-boiling point solvent to be added, to thereby confirm whether the microcapsule is adversely affected or not.

The heat insulation layer may be formed of the resin and the forming agent. In the present invention, preferably the third embodiment of the present invention, the heat insulation layer is preferably formed of a hollow polymer.

The hollow polymer in the present invention, preferably the third embodiment of the present invention, is polymer particles having independent pores inside of the particles. Examples of the hollow polymer include 1) non-foaming type hollow particles obtained in the following manner: water is contained inside of a capsule wall formed of a polystyrene, acryl resin or styrene/acryl resin and, after a coating solution is applied and dried, the water in the particles is vaporized out of the particles, with the result that the inside of the particle forms a hollow; 2) foaming type microballoons obtained in the following manner: a low-boiling point liquid such as butane and pentane is encapsulated in a resin constituted of any one, a mixture or a polymer of polyvinylidene chloride, polyacrylonitrile, polyacrylic acid and polyacrylate, and after the resin coated material is applied, it is heated to expand the low-boiling point liquid inside of the particle whereby the inside of the particle is made to be hollow; and 3) foaming type microballoons obtained by foaming the above 2) under heating in advance to make a hollow polymer.

These hollow polymers preferably have a hollow ratio of about 20 to 70% and may be used in combinations of two or more. In the present invention, preferably the third embodiment of the present invention, the hollow polymers are preferably used in a form of latex. Specific examples of the above 1) include Rohpake 1055 manufactured by Rohm and Haas Co.; Boncoat PP-1000 manufactured by Dainippon Ink and Chemicals, Incorporated; SX866(B) manufactured by JSR Corporation; and Nippol MH5055 manufactured by Nippon Zeon (all of these product names are trade names). Specific examples of the above 2) include F-30 and F-50 manufactured by Matsumoto Yushi-Seiyaku Co., Ltd. (all of these product names are trade names). Specific examples of the above 3) include F-30E manufactured by Matsumoto Yushi-Seiyaku Co., Ltd, and Expancel 461DE, 55 IDE and 551DE20 manufactured by Nippon Ferrite (all of these product names are trade names).

A water-dispersible resin or water-soluble type resin is preferably contained in the intermediate layer containing the hollow polymer. As the binder resin in the present invention, preferably the third embodiment of the present invention, known resins such as an acryl resin, styrene/acryl copolymer, polystyrene resin, polyvinyl alcohol resin, vinyl acetate resin, ethylene/vinyl acetate copolymer, vinyl chloride/vinyl acetate copolymer, styrene/butadiene copolymer, polyvinylidene chloride, cellulose derivative, casein, starch and gelatin may be used. Also, these resins may be used either singly or as mixtures.

The solid content of the hollow polymer in the intermediate layer preferably falls in a range from 5 to 2,000 parts by mass when the solid content of the binder resin is 100 parts by mass. Also, the ratio by mass of the solid content of the hollow polymer in the coating solution is preferably 1 to 70% by mass and more preferably 10 to 40% by mass. If the ratio of the hollow polymer is excessively low, sufficient heat insulation cannot be obtained, whereas if the ratio of the hollow polymer is excessively large, the adhesion between the hollow polymers is reduced, posing problems, for example, powder fall or film separation.

The particle size of the hollow polymer is preferably 0.1 to 20 μm, more preferably 0.1 to 2 μm and particularly preferably 0.1 to 1 μm. Also, the glass transition temperature (Tg) of the hollow polymer is preferably 70° C. or more and more preferably 100° C. or more.

The intermediate layer (including an undercoat layer and a heat insulation layer) preferably contains a gelatin. The amount of the gelatin in the coating solution for the intermediate layer is preferably 0.5 to 14% by mass, and particularly preferably 1 to 6% by mass. Also, the coating amount of the above hollow polymer in the intermediate layer is preferably 1 to 100 g/m², and more preferably 5 to 20 g/m².

The thickness of the intermediate layer containing the hollow polymer is preferably 5 to 50 μm, and more preferably 5 to 40 μm.

### (Support)

As the support, coated paper, WP paper (double side laminated paper) or the like may be used.

In the present invention, preferably in the second embodiment of the present invention, a waterproof support is preferably used as the support. The use of the waterproof support makes it possible to prevent the support from absorbing moisture, whereby a variation in the performance of the receptor layer with time can be prevented. As the waterproof support, for example, coated paper or laminate paper may be used.

### —Coated Paper—

The coated paper is paper obtained by coating a sheet such as base paper with various resins, rubber latexes or high-molecular materials on one side or both sides of the sheet, wherein the coating amount differs depending on its use. Example of such coated paper include art paper, cast coated paper and Yankee paper.

It is proper to use a thermoplastic resin as the resin to be applied to the surface of the base paper. As such a thermoplastic resin, the following thermoplastic resins (A) to (H) may be exemplified.

(A) Polyolefin resins such as polyethylene resin and polypropylene resin; copolymer resins composed of an olefin such as ethylene or propylene and another vinyl monomer; and acrylic resin.
(B) Thermoplastic resins having an ester linkage: for example, polyester resins obtained by condensation of a dicarboxylic acid component (such a dicarboxylic acid component may be substituted with a sulfonic acid group, carboxyl group or the like) and an alcohol component (such an alcohol component may be substituted with a hydroxyl group or the like); polyacrylate resins or polymethacrylate resins such as polymethylmethacrylate, polybutylmethacrylate, polymethylacrylate, polybutylacrylate, or the like; polycarbonate resins, polyvinyl acetate resins, styrene acrylate resins, styrene-methadylate copolymer resins, vinyltoluene acrylate resins, or the like.

Concrete examples of them are those described in JP-A-59-101395, JP-A-63-7971, JP-A-63-7972, JP-A-63-7973, and JP-A-60-294862.

Commercially available thermoplastic resins usable herein are, for example, Vylon 290, Vylon 200, Vylon 280, Vylon 300, Vylon 103, Vylon GK-140, and Vylon GK-130 (products of Toyobo Co., Ltd.); Tafton NE-382, Tafton U-5, ATR-2009, and ATR-2010 (products of Kao Corporation); Elitel UE 3500, UE 3210, XA-8153, KZA-7049, and KZA-1449 (products of Unitika Ltd.); and Polyester TP-220 and R-188 (products of The Nippon Synthetic Chemical Industry Co., Ltd.); and thermoplastic resins in the Hyros series from Seiko Chemical Industries Co., Ltd., and the like (all of these names are trade names).

(C) Polyurethane resins, etc.
(D) Polyamide resins, urea resins, etc.
(E) Polysulfone resins, etc.
(F) Polyvinyl chloride resins, polyvinylidene chloride resins, vinyl chloride/vinyl acetate copolymer resins, vinyl chloride/vinyl propionate copolymer resins, etc.
(G) Polyol resins such as polyvinyl butyral; and cellulose resins such as ethyl cellulose resin and cellulose acetate resin, and
(H) Polycaprolactone resins, styrene/maleic anhydride resins, polyacrylonitrile resins, polyether resins, epoxy resins and phenolic resins.

The thermoplastic resins may be used either alone or in combination of two or more.

The thermoplastic resin may contain a whitener, a conductive agent, a filler, a pigment or dye including, for example, titanium oxide, ultramarine blue, and carbon black; or the like, if necessary.

### —Laminated Paper—

The laminated paper is a paper which is formed by laminating various kinds of resin, rubber, polymer sheets or films on base paper or the like. Specific examples of the materials useable for the lamination include polyolefins, polyvinyl chlorides, polyethylene terephthalates, polystyrenes, polymethacrylates, polycarbonates, polyimides, and triacetylcelluloses. These resins may be used alone, or in combination of two or more.

Generally, a low-density polyethylene is used as the polyolefin. However, for improving the thermal resistance of the support, it is preferred to use polypropylene, a blend of polypropylene and polyethylene, a high-density polyethylene, or a blend of the high-density polyethylene and a low-density polyethylene. From the viewpoint of cost and its suitableness for the laminate, it is preferred to use the blend of the high-density polyethylene and the low-density polyethylene.

The blend of the high-density polyethylene and the low-density polyethylene is preferably used in a blend ratio (a mass ratio) of 1/9 to 9/1, more preferably 2/8 to 8/2, and most preferably 3/7 to 7/3. When the thermoplastic resin layer is formed on the both surfaces of the support, the back side of the support is preferably formed using, for example, the high-density polyethylene or a blend of the high-density polyethylene and the low-density polyethylene. The molecular weight of the polyethylenes is not particularly limited. Preferably, both of the high-density polyethylene and the low-density polyethylene have a melt index of 1.0 to 40 g/10 minute and a high extrudability.

The sheet or film may be subjected to a treatment to impart white reflection thereto. For example, a pigment such as titanium dioxide may be incorporated into the sheet or film.

The thickness of the support is preferably from 25 μm to 300 μm, more preferably from 50 μm to 260 μm, and further preferably from 75 μm to 220 μm. The support can have any rigidity according to the purpose. When it is used as a support for electrophotographic image-receiving sheet of photographic image quality, the rigidity thereof is preferably near to that in a support for use in color silver halide photography.

### (Curling Control Layer)

When the substrate is exposed as it is, there is the case where the heat-sensitive transfer image-receiving sheet is made to curl by moisture and temperature in the environment. It is therefore preferable to form a curling control layer on the backside of the support. The curling control layer not only prevents the image-receiving sheet from curling but also has a water-proof function. For the curling control layer, a polyethylene laminate, polypropylene laminate or the like is used. Specifically, the curling control layer may be formed in a manner similar to those described in, for example, each publication of JP-A-61-110135 and JP-A-6-202295.

### (Writing Layer and Charge Controlling Layer)

For the writing layer and the charge control layer, an inorganic oxide colloid, an ionic polymer or the like may be used. As the antistatic agent, optional antistatic agents including cationic antistatic agents such as a quaternary ammonium salt and polyamine derivative, anionic antistatic agents such as alkyl phosphate, and nonionic antistatic agents such as fatty acid ester may be used. Specifically, the writing layer and the charge control layer may be formed in a manner similar to those described in the specification of Japanese Patent No. 3585585.

A method of producing the heat-sensitive transfer image-receiving sheet of the present invention, preferably the third embodiment of the present invention, will be hereinafter explained.

The heat-sensitive transfer image-receiving sheet of the present invention, preferably the third embodiment of the present invention, may be formed by applying at least one intermediate layer and a receptor layer as a multilayer to the surface of a support simultaneously. It is known that in the case of producing plural layers having different functions from each other (for example, an air cell layer, heat insulation layer, intermediate layer and receptor layer) on a support, it may be produced by applying and overlapping each layer one by one or by applying materials prepared in advance by coating a support with each layer as shown in, for example, each publication of JP-A-2004-106283, JP-A-2004-181888 and JP-A-2004-345267.

It has been known in photographic industries, on the other hand, that productivity can be greatly improved by applying plural layers simultaneously as a multilayer. There are known methods such as the so-called slide coating (slide coating method) and curtain coating (curtain coating method) as described in, for example, each publication or specification of U.S. Pat. Nos. 2,761,791, 2,681,234, 3,508,947, 4,457,256 and 3,993,019; JP-A-63-54975, JP-A-61-278848, JP-A₇55-86557, JP-A-52-31727, JP-A-55-142565, JP-A-5043140, JP-A-63-80872, JP-A-54-54020, JP-A-5-104061 and JP-A-5-127305 and JP-B-49-7050; and Edgar B. Gutoff, et al., “Coating and Drying Defects: Troubleshooting Operating Problems”, John Wiley & Sons Company, 1995, pp 101-103.

In the present invention, preferably in the third embodiment of the present invention, it has been found that the productivity is greatly improved and image defects can be remarkably reduced at the same time by using the above simultaneous multilayer coating for the production of an image-receiving sheet having a multilayer structure.

The plural layers in the present invention, preferably in the third embodiment of the present invention, are structured using resins as its major components. Coating solutions forming each layer are preferably water-dispersible latexes. The solid content by weight of the resin put in a latex state in each layer coating solution is preferably in a range from 5 to 80% and particularly preferably 20 to 60%. The average particle size of the resin contained in the above water-dispersed latex is preferably 5 μm or less and particularly preferably 1 μm or less. The above water dispersed latex may contain known additives such as surfactants, dispersant and binder resin, according to the need.

In the present invention, in the third embodiment of the present invention, a laminate composed of plural layers is preferably formed on a support and rapidly dried according to the method described in U.S. Pat. No. 2,761,791. In the case of a multilayer structure by solidifying using a resin as one example, it is preferable to raise the solidifying temperature immediately after the plural layers are formed on the support. Also, in the case where a binder (e.g., a gelatin) that is gelled at lower temperatures is contained, there is the case where it is preferable to drop the solidifying temperature immediately after the plural layers are formed on the support.

The coating amount of a coating solution per one layer constituting the multilayer in the present invention, preferably the third embodiment of the present invention, is preferably in a range from 1 g/m² to 500 g/m². The number of the layers of the multilayer structure may be optionally selected from a number of 2 or more. The receptor layer is preferably disposed as a layer most apart from the support.

A heat-sensitive transfer sheet (ink sheet) to be used together with the aforementioned heat-sensitive transfer image-receiving sheet according to the present invention in the formation of a thermal-transferred image is produced by disposing a dye layer containing a diffusion transfer dye on a substrate. As the heat-sensitive transfer sheet, an optional ink sheet may be used. As a means for providing heat energy in the thermal transfer, any of the conventionally known providing means may be used. For example, a heat energy of about 5 to 100 mJ/mm² is applied by controlling recording time in a recording device such as a thermal printer (trade name: Video Printer VY-100, manufactured by Hitachi, Ltd.), whereby the expected object can be attained sufficiently.

Also, the heat-sensitive transfer image-receiving sheet of the present invention may be used in various applications enabling thermal transfer recording such as thin sheets or roll-like heat-sensitive transfer image-receiving sheets, cards and transmittable type manuscript-making sheets, by optionally selecting the type of support.

The present invention, preferably the second embodiment of the present invention, may be utilized for printers, copying machines and the like utilizing a heat-sensitive transfer recording system.

The heat-sensitive transfer image-receiving sheet of the present invention, preferably the first and fourth embodiment of the present invention, enables the formation of a high quality image, and is superior in light fastness.

The heat-sensitive transfer image-receiving sheet of the present invention, preferably the second embodiment of the present invention, is reduced in the variation of transferability with time, and can form a recording image reduced in the variation of the transferred image with time.

The heat-sensitive transfer image-receiving sheet of the present invention, preferably the third embodiment of the present invention, has high sensitivity, is free from image defects and can be formed at low costs.

The present invention will be explained in more detail by way of examples, which are, however, not intended to be limiting of the present invention.

### EXAMPLES

### Reference Example

### Production of an Ink Sheet

A polyester film 6.0 μm in thickness (trade name: Lumirror, manufactured by Toray Industries, Inc.) was used as the substrate film. A heat resistant slip layer (thickness: 1 μm) was formed on the backside of the film, and the following yellow, magenta and cyan compositions are respectively applied as a monochromatic layer (coating amount: 1 g/m² when the layer was dried) on the front side.

Yellow composition

| | |
|---|---|
| Dye (Trade name: Macrolex Yellow 6G, | 5.5 parts by mass |
| manufactured by Byer) | |
| Polyvinylbutyral resin | 4.5 parts by mass |
| (Trade name: ESLEC BX-1, manufactured by | |
| Sekisui Chemical Co., Ltd.) | |
| Methyl ethyl ketone/toluene (1/1, at mass ratio) | 90 parts by mass |

Magenta composition

| | |
|---|---|
| Magenta dye (Disperse Red 60) | 5.5 parts by mass |
| Polyvinylbutyral resin | 4.5 parts by mass |
| (Trade name: ESLEC BX-1, manufactured by | |
| Sekisui Chemical Co., Ltd.) | |
| Methyl ethyl ketone/toluene (1/1, at mass ratio) | 90 parts by mass |

Cyan composition

| | |
|---|---|
| Cyan dye (Solvent Blue 63) | 5.5 parts by mass |
| Polyvinylbutyral resin | 4.5 parts by mass |
| (Trade name: ESLEC BX-1, manufactured by | |
| Sekisui Chemical Co., Ltd.) | |
| Methyl ethyl ketone/toluene (1/1, at mass ratio) | 90 parts by mass |

### Example 1-1

### Production of an Image-Receiving Sheet

### (1-1) Production of Sample 1101

### Comparative Example

Synthetic paper (trade name: Yupo FPG 200, manufactured by Yupo Corporation, thickness: 200 μm) was used as the support to apply a white intermediate layer and a receptor layer having the following compositions in this order to one surface of this support by a bar coater. The application was carried out such that the amount of the white intermediate layer and the amount of the receptor layer after each layer was dried were 1.0 g/m² and 4.0 g/m², and these layers were respectively dried at 110° C. for 30 seconds.

White intermediate layer

| | | |
|---|---|---|
| Polyester resin | 10 | parts by mass |
| (Trade name: Vylon 200, manufactured by | | |
| Toyobo Co., Ltd.) | | |
| Fluuorescent whitening agent | 1 | part by mass |
| (Trade name: Uvitex OB, manufactured by | | |
| Ciba Specialty Chemicals) | | |
| Titanium oxide | 30 | parts by mass |
| Methyl ethyl ketone/toluene (1/1, at mass ratio) | 90 | parts by mass |

Receptor layer

| | | |
|---|---|---|
| Vinyl chloride/vinyl acetate resin | 100 | parts by mass |
| (Trade name: Solbin A, manufactured by | | |
| Nisshin Chemicals Co., Ltd) | | |
| Amino-modified silicone | 5 | parts by mass |
| (Trade name: X22-3050C, manufactured by | | |
| Shin-Etsu Chemical Co., Ltd) | | |
| Epoxy-modified silicone | 5 | parts by mass |
| (Trade name: X22-300E, manufactured by | | |
| Shin-Etsu Chemical Co., Ltd.) | | |
| Methyl ethyl ketone/toluene (=1/1, at mass ratio) | 400 | parts by mass |
| Benrotriazole type ultraviolet absorber | 5 | parts by mass |
| (Trade name: Tinuvin 900, manufactured by | | |
| Ciba Specialty Chemicals) | | |

### (1-2) Production of Sample 1102

### Comparative Example

Sample 1102 was produced in the same manner as in the production of the sample 101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 10 parts by mass |
| (Trade name: Tinuvin 900, manufactured by | |
| Ciba Specially Chemicals) | |

### (1-3) Production of Sample 1103

### Present Invention

Sample 1103 was produced in the same manner as in the production of the sample 101, except that the receptor layer was altered to one having the following composition and the drying operation was carried out at 100° C. for 2 minutes.

Receptor layer

| | |
|---|---|
| Vinyl chloride-series latex | 48 parts by mass |
| (Trade name: Vinybran 609, manufactured by | |
| Nisshin Chemicals Co., Ltd.) | |
| Benzotriazole type ultraviolet absorber latex | 15 parts by mass |
| polymer | |
| (Trade name: ULS 1700, manufactured by | |
| Ipposha Oil Industries Co., Ltd) | |
| Wax montanate | 10 parts by mass |
| (Trade name: J537, manufactured by Chukyo | |
| Yushi Co., Ltd.) | |

### (1-4) Production of Sample 1104

### Present Invention

Sample 1104 was produced in the same manner as in the production of the sample 1103, except that the receptor layer was made to have the following composition.

Receptor layer

| | |
|---|---|
| Vinyl chloride-series latex | 54 parts by mass |
| (Trade name: Vinybran 609, manufactured by | |
| Nisshin Chemicals Co., Ltd.) | |
| Benzotriazole type ultraviolet absorber latex | 7.5 parts by mass |
| polymer | |
| (Trade name: ULS 1700, manufactured by | |
| Ipposha Oil Industries Co., Ltd.) | |
| Wax montanate | 10 parts by mass |
| (Trade name: J537, manufactured by Chukyo | |
| Yushi Co., Ltd.) | |

### (Image Formation)

The ink sheet of Reference Example and each of the above samples 1101 to 1104 were superposed on each other such that the ink layer of the former one was brought into contact with the receptor layer of the latter one, to output an image by using a thermal transfer type printer. The output image was formed using gradation giving gray to each sample.

### (Test for Light Resistance)

Each of the above image samples was irradiated with xenon light (100,000 lx xenon light irradiator) through an ultraviolet cutting filter having a light transmittance of 50% for 370 nm light and a heat-ray cutting filter, for 7 days and 14 days. The residual ratio of cyan when the initial density of cyan was set to 1.0 was calculated to evaluate.

Residual ratio (%)=(Optical density after irradiation/Optical density before irradiation)×100(%)

⊚: Average residual ratio is 80% or more.

◯: Average residual ratio is 70% or more, and less than 80%.

Δ: Average residual ratio is 60% or more, and less than 70%.

x: Average residual ratio is less than 60%.

The obtained results are shown in Table 1.

TABLE 1

| | Light resistance test, | Light resistance test, |
|---|---|---|
| | after 7 days | after 14 days |
| Sample 1101 (Comparative | Δ | X |
| Example) | | |
| Sample 1102 (Comparative | Δ | Δ |
| Example) | | |
| Sample 1103 (This invention) | ◯ | ◯ |
| Sample 1104 (This invention) | ⊚ | ⊚ |

As is clear from the results of Table 1, it was found that the image sample of the present invention had good light resistance.

### Example 1-2

### Production of an Image-Receiving Sheet

### (2-1) Production of Sample 1201

### Comparative Example

Sample 1201 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin CL, manufactured by | |
| Nisshin Chemicals Co., Ltd.) | |
| Methylstyryl-modified silicone | 2 parts by mass |
| (Trade name: 24-510, manufactured by | |
| Shin-Etsu Chemical Co., Ltd.) | |
| Epoxy-modified silicone | 2 parts by mass |
| (Trade name: X22-3000T, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 5 parts by mass |
| (Trade name: Tinuvin 900, manufactured by | |
| Ciba Specialty Chemicals) | |

### (2-2) Production of Sample 1202

### Comparative Example

Sample 1202 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin CL, manufactured by | |
| Nisshin Chemicals Co., Ltd.) | |
| Methylstyryl-modified silicone | 2 parts by mass |
| (Trade name: 24-510, manufactured by | |
| Shin-Etsu Chemical Co., Ltd.) | |
| Epoxy-modified silicone | 2 parts by mass |
| (Trade name: X22-3000T, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 10 parts by mass |
| (Trade name: Tinuvin 900, manufactured by | |
| Ciba Specialty Chemicals) | |

### (2-3) Production of Sample 1203

### Present Invention

Sample 1203 was produced in the same manner as in the production of the sample 1103, except that the receptor layer was made to have the following composition.

Receptor layer

| | |
|---|---|
| Vinyl chloride-series latex | 48 parts by mass |
| (Trade name: Vinybran 900, Nisshin Chemicals | |
| Co., Ltd.) | |
| Benzotriazole type ultraviolet absorber latex | 15 parts by mass |
| polymer | |
| (Trade name: ULS 1700, manufactured by | |
| Ipposha Oil Industries Co., Ltd.) | |
| Wax montanate | 10 parts by mass |
| (Trade name: J537, manufactured by Chukyo | |
| Yushi Co., Ltd.) | |

### (2-4) Production of Sample 1204

### Present Invention

Sample 1204 was produced in the same manner as in the production of the sample 1103, except that the receptor layer was made to have the following composition.

Receptor layer

| | |
|---|---|
| Vinyl chloride-series latex | 54 parts by mass |
| (Trade name: Vinybran 900, Nisshin Chemicals | |
| Co., Ltd.) | |
| Benzotriazole type ultraviolet absorber latex | 7.5 parts by mass |
| polymer | |
| (Trade name: ULS 1700, manufactured by | |
| Ipposha Oil Industries Co., Ltd.) | |
| Wax montanate | 10 parts by mass |
| (Trade name: J537, manufactured by Chukyo | |
| Yushi Co., Ltd.) | |

### (Image Formation)

The ink sheet of Reference Example and each of the above samples 1201 to 1204 were superposed on each other such that the ink layer of the former one was brought into contact with the receptor layer of the latter one, to output an image by using a thermal transfer type printer. In the output image, a step pattern was used in which a yellow monochrome, a magenta monochrome, a cyan monochrome and a black image were changed sequentially in concentration from its minimum (namely, white background) to maximum.

### (Test for Light Resistance)

With regard to the above image sample, a test for light resistance was carried out in the same manner as in Example 1-1 to evaluate. The obtained results are shown in Table 2.

TABLE 2

| | Light resistance test, | Light resistance test, |
|---|---|---|
| | after 7 days | after 14 days |
| Sample 1201 (Comparative | Δ | X |
| Example) | | |
| Sample 1202 (Comparative | Δ | Δ |
| Example) | | |
| Sample 1203 (This invention) | ◯ | ◯ |
| Sample 1204 (This invention) | ⊚ | ⊚ |

As is clear from the results of Table 2, it was found that the image sample of the present invention had good light resistance.

### Example 1-3

A sample was produced in the same manner as in Example 1-1 except that Vinybran 683 (trade name, manufactured by Nisshin Chemicals Co., Ltd.) was used in place of Vinybran 609 as the vinyl chloride-series latex. Vinybran 683 was used in the same parts by mass as Vinybran 609 as the solid content of a latex polymer. The test for light resistance was made in the same manner as in Example 1-1, to find that an image sample having good light resistance was also obtained in this example.

### Example 1-4

A sample was produced in the same manner as in Example 1-1 except that Vinybran 601 (trade name, manufactured by Nisshin Chemicals Co., Ltd.) was used in place of Vinybran 609 as the vinyl chloride-series latex. Vinybran 601 was used in the same parts by mass as Vinybran 609 as the solid content of a latex polymer. The test for light resistance was made in the same manner as in Example 1-1, to find that an image sample having good light resistance was also obtained in this example.

### Example 1-5

A sample was produced in the same manner as in Example 1-1 except that Vinybran 270 (trade name, manufactured by Nisshin Chemicals Co., Ltd.) was used in place of Vinybran 609 as the vinyl chloride-series latex. Vinybran 270 was used in the same parts by mass as Vinybran 609 as the solid content of a latex polymer. The test for light resistance was made in the same manner as in Example 1-1, to find that an image sample having good light resistance was also obtained in this example.

### Example 1-6

A sample was produced in the same manner as in Example 1-1 except that Vinybran 380 (trade name, manufactured by Nisshin Chemicals Co., Ltd.) was used in place of Vinybran 609 as the vinyl chloride-series latex. Vinybran 380 was used in the same parts by mass as Vinybran 609 as the solid content of a latex polymer. The test for light resistance was made in the same manner as in Example 1-1, to find that an image sample having good light resistance was also obtained in this example.

### Example 1-7

A sample was produced in the same manner as in Example 1-1 except that Vinybran 900 (trade name, manufactured by Nisshin Chemicals Co., Ltd.) was used in place of Vinybran 609 as the vinyl chloride-series latex. Vinybran 900 was used in the same parts by mass as Vinybran 609 as the solid content of a latex polymer. The test for light resistance was made in the same manner as in Example 1-1, to find that an image sample having good light resistance was also obtained in this example.

### Example 1-8

A sample was produced in the same manner as in Example 1-1 except that Vinybran 900GT (trade name, manufactured by Nisshin Chemicals Co., Ltd.) was used in place of Vinybran 609 as the vinyl chloride-series latex. Vinybran 900GT was used in the same parts by mass as Vinybran 609 as the solid content of a latex polymer. The test for light resistance was made in the same manner as in Example 1-1, to find that an image sample having good light resistance was also obtained in this example.

### Example 1-9

A sample was produced in the same manner as in Example 1-1 except that a mixture of Vinybran 900 (trade name, manufactured by Nisshin Chemicals Co., Ltd.) and Vinybran 609 (trade name, manufactured by Nisshin Chemicals Co., Ltd.) was used in place of Vinybran 609 as the vinyl chloride-series latex. As to the mixing ratio of Vinybran 609 to Vinybran 900, the both were mixed in amounts, equivalent to each other as the solid content of a latex polymer. The mixture latex of Vinybran 609 and Vinybran 900 was used in the same parts by mass as in Example 1-1 as the solid content of a latex polymer. The test for light resistance was made in the same manner as in Example 1-1, to find that an image sample having good light resistance was also obtained in this example.

### Example 1-10

A sample was produced in the same manner as in Example 1-1 except that Bironal MD1480 (trade names, manufactured by Toyobo Co., Ltd.) was used in place of Vinybran 609 as the vinyl chloride-series latex. Bironal MD1480 was used in the same parts by mass as Vinybran 609 as the solid content of a latex polymer. The test for light resistance was made in the same manner as in Example 1-1, to find that an image sample having good light resistance was also obtained in this example.

### Example 1-11

A sample was produced in the same manner as in Example 1-1 except that Bironal MD1500 (trade names, manufactured by Toyobo Co., Ltd.) was used in place of Vinybran 609 as the vinyl chloride-series latex. Bironal MD1500 was used in the same parts by mass as Vinybran 609 as the solid content of a latex polymer. The test for light resistance was made in the same manner as in Example 1-1, to find that an image sample having good light resistance was also obtained in this example.

### Example 1-12

A sample was produced in the same manner as in Example 1-1 except that Elitel emulsion KZT8803 (trade names, manufactured by Unitika Ltd.) was used in place of Vinybran 609 as the vinyl chloride-series latex. Elitel emulsion KZT8803 was used in the same parts by mass as Vinybran 609 as the solid content of a latex polymer. The test for light resistance was made in the same manner as in Example 1-1, to find that an image sample having good light resistance was also obtained in this example.

### Example 1-13

A sample was produced in the same manner as in Example 1-1 except that TERRAMAC LAE100N (trade names, manufactured by Unitika Ltd.) was used in place of Vinybran 609 as the vinyl chloride-series latex. TERRAMAC LAE100N was used in the same parts by mass as Vinybran 609 as the solid content of a latex polymer. The test for light resistance was made in the same manner as in Example 1-1, to find that an image sample having good light resistance was also obtained in this example.

### Example 1-14

A sample was produced in the same manner as in Example 1-1 except that LX416 (trade names, manufactured by Nippon Zeon Co., Ltd.) was used in place of Vinybran 609 as the vinyl chloride-series latex. LX416 was used in the same parts by mass as Vinybran 609 as the solid content of a latex polymer. The test for light resistance was made in the same manner as in Example 1-1, to find that an image sample having good light resistance was also obtained in this example.

### Example 1-15

A sample was produced in the same manner as in Example 1-1 except that ULS1635 (trade names, manufactured by Ipposha Oil Industries Co., Ltd.) was used in place of ULS1700 as the ultraviolet absorber latex polymer. ULS1635 was used in the same parts by mass as ULS1700 as the solid content of a latex polymer. The test for light resistance was made in the same manner as in Example 1-1, to find that an image sample having good light resistance was also obtained in this example.

### Example 1-16

A sample was produced in the same manner as in Example 1-1 except that XL-7016 (trade names, manufactured by Ipposha Oil Industries Co., Ltd.) was used in place of ULS1700 as the ultraviolet absorber latex polymer. XL-7016 was used in the same parts by mass as ULS1700 as the solid content of a latex polymer. The test for light resistance was made in the same manner as in Example 1-1, to find that an image sample having good light resistance was also obtained in this example.

### Example 1-17

A sample was produced in the same manner as in Example 1-1 except that LVA-1025W (trade names, manufactured by Shin-Nakamura Chemical Co., Ltd.) was used in place of ULS1700 as the ultraviolet absorber latex polymer. UVA-1025W was used in the same parts by mass as ULS1700 as the solid content of a latex polymer. The test for light resistance was made in the same manner as in Example 1-1, to find that an image sample having good light resistance was also obtained in this example.

### Example 1-18

A sample was produced in the same manner as in Example 1-1 except that UVA-204W (trade names, manufactured by Shin-Nakamura Chemical Co., Ltd.) was used in place of ULS1700 as the ultraviolet absorber latex polymer. UVA-204W was used in the same parts by mass as ULS1700 as the solid content of a latex polymer. The test for light resistance was made in the same manner as in Example 1-1, to find that an image sample having good light resistance was also obtained in this example.

### Example 1-19

A sample was produced in the same manner as in Example 1-1 except that UVA-4512M (trade names, manufactured by Shin-Nakamura Chemical Co., Ltd.) was used in place of ULS1700 as the ultraviolet absorber latex polymer. UVA-4512M was used in the same parts by mass as ULS1700 as the solid content of a latex polymer. The test for light resistance was made in the same manner as in Example 1-1, to find that an image sample having good light resistance was also obtained in this example.

### Example 2-1

### Production of an Image-Receiving Sheet

### (1-1) Production of Sample 2101

### Comparative Example

A sample 2101 was produced in the same manner as in the production of sample 1101.

### (1-2) Production of Sample 2102

### Comparative Example

A sample 2102 was produced in the same manner as in the production of sample 1102.

### (1-3) Production of Sample 2103

### Present Invention

Sample 2103 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 5 parts by mass |
| polymer | |
| (Trade name: ULS-1935LH, manufactured by | |
| Ipposha Oil Industries Co., Ltd.) | |

### (1-4) Production of Sample 2104

### Present Invention

Sample 2104 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 10 parts by mass |
| polymer | |
| (Trade name: ULS-1935LH, manufactured by | |
| Ipposha Oil Industries Co., Ltd.) | |

### (1-5) Production of Sample 2105

### Present Invention

Sample 2105 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzophenpne type ultraviolet absorber | 5 parts by mass |
| polymer | |
| (Trade name: ULS-933LP, manufactured by | |
| Ipposha Oil Industries Co., Ltd.) | |

### (1-6) Production of Sample 2106

### Present Invention

Sample 2106 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzophenpne type ultraviolet absorber | 10 parts by mass |
| polymer | |
| (Trade name: ULS-933LP, manufactured by | |
| Ipposha Oil Industries Co., Ltd.) | |

### (1-7) Production of Sample 2107

### Present Invention

Sample 2107 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzophenpne type ultraviolet absorber | 5 parts by mass |
| polymer | |
| (Trade name: ULS-935LH, manufactured by | |
| Ipposha Oil Industries Co., Ltd.) | |

### (1-8) Production of Sample 2108

### Present Invention

Sample 2108 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzophenpne type ultraviolet absorber | 10 parts by mass |
| polymer | |
| (Trade name: ULS-935LH, manufactured by | |
| Ipposha Oil Industries Co., Ltd.) | |

### (1-9) Production of Sample 2109

### Present Invention

Sample 2109 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 5 parts by mass |
| polymer | |
| (Trade name: RSA-0002, manufactured by | |
| Yamanami Gosei Kagaku) | |

### (1-10) Production of Sample 2110

### Present Invention

Sample 2110 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 10 parts by mass |
| polymer | |
| (Trade name: RSA-0002, manufactured by | |
| Yamanami Gosei Kagaku) | |

### (1-11) Production of Sample 2111

### Present Invention

Sample 2111 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 5 parts by mass |
| polymer | |
| (Trade name: RSA-0124, manufactured by | |
| Yamanami Gosei Kagaku) | |

### (1-12) Production of Sample 2112

### Present Invention

Sample 2112 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 10 parts by mass |
| polymer | |
| (Trade name: RSA-0124, manufactured by | |
| Yamanami Gosei Kagaku) | |

### (1-13) Production of Sample 2113

### Present Invention

Sample 2113 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 5 parts by mass |
| polymer | |
| (Trade name: RSA-0151, manufactured by | |
| Yamanami Gosei Kagaku) | |

### (1-14) Production of Sample 2114

### Present Invention

Sample 2114 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Benzotriazole type ultraviolet absorber | 10 parts by mass |
| polymer | |
| (Trade name: RSA-0151, manufactured by | |
| Yamanami Gosei Kagaku) | |

### (1-15) Production of Sample 2115

### Present Invention

Sample 2115 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Ultraviolet absorber polymer | 5 parts by mass |
| (Trade name: Vanaresin UVA-1025S, manufactured | |
| by Shin-Nakamura Chemical Co., Ltd.) | |

### (1-16) Production of Sample 2116

### Present Invention

Sample 2116 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Ultraviolet absorber polymer | 10 parts by mass |
| (Trade name: Vanaresin UVA-1025S, manufactured | |
| by Shin-Nakamura Chemical Co., Ltd.) | |

### (1-17) Production of Sample 2117

### Present Invention

Sample 2117 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Ultraviolet absorber polymer | 5 parts by mass |
| (Trade name: Vanaresin UVA-1059G, manufactured | |
| by Shin-Nakamura Chemical Co., Ltd.) | |

### (1-18) Production of Sample 2118

### Present Invention

Sample 2118 was produced in the same manner as in the production of the sample 1101, except that the receptor layer was made to have the following composition.

Receptor layer

| | |
|---|---|
| Vinyl chloride/vinyl acetate resin | 100 parts by mass |
| (Trade name: Solbin A, manufactured by | |
| Nisshin Chemicals Co., Ltd.) | |
| Amino-modified silicone | 5 parts by mass |
| (Trade name: X22-3050C, manufactured by | |
| Shin-Etsu Chemical Co., Ltd.) | |
| Epoxy-modified silicone | 5 parts by mass |
| (Trade name: X22-300E, manufactured by | |
| Shin-Etsu Chemical Co., Ltd.) | |
| Methyl ethyl ketone/toluene (=1/1, at mass ratio) | 400 parts by mass |
| Ultraviolet absorber polymer | 10 parts by mass |
| (Trade name: Vanaresin UVA-1059G, manufactured | |
| by Shin-Nakamura Chemical Co., Ltd.) | |

### (Image Formation)

The ink sheet of Reference Example and each of the above samples 2101 to 2118 were superposed on each other such that the ink layer of the former one was brought into contact with the receptor layer of the latter one, to output an image by using a thermal transfer type printer. The output image was formed using gradation giving gray to each sample.

### (Test for Light Resistance)

With regard to the above image sample, a test for light resistance was carried out in the same manner as in Example 1-1 to evaluate. The obtained results are shown in Table 3.

TABLE 3

| | | Light | Light |
|---|---|---|---|
| | | resistance | resistance |
| | Ultraviolet | test, after | test, after |
| | absorber | 7 days | 14 days |
| Sample 2101 (Comparative | Tinuvin900 | Δ | X |
| Example) | | | |
| Sample 2102 (Comparative | Tinuvin900 | Δ | Δ |
| Example) | | | |
| Sample 2103 (This invention) | ULS-1935LH | ◯ | ◯ |
| Sample 2104 (This invention) | ULS-1935LH | ⊚ | ⊚ |
| Sample 2105 (This invention) | ULS-933LP | ⊚ | ◯ |
| Sample 2106 (This invention) | ULS-933LP | ⊚ | ⊚ |
| Sample 2107 (This invention) | ULS-935LH | ◯ | ◯ |
| Sample 2108 (This invention) | ULS-935LH | ⊚ | ⊚ |
| Sample 2109 (This invention) | RSA-0002 | ⊚ | ◯ |
| Sample 2110 (This invention) | RSA-0002 | ⊚ | ⊚ |
| Sample 2111 (This invention) | RSA-0124 | ◯ | ◯ |
| Sample 2112 (This invention) | RSA-0124 | ⊚ | ⊚ |
| Sample 2113 (This invention) | RSA-0151 | ◯ | ◯ |
| Sample 2114 (This invention) | RSA-0151 | ⊚ | ⊚ |
| Sample 2115 (This invention) | UVA-1025S | ◯ | ◯ |
| Sample 2116 (This invention) | UVA-1025S | ⊚ | ⊚ |
| Sample 2117 (This invention) | UVA-1059G | ◯ | ◯ |
| Sample 2118 (This invention) | UVA-1059G | ⊚ | ⊚ |

As is clear from the results of Table 3, it was found that the image sample of the present invention had good light resistance.

### Example 2-2

A sample was produced in the same manner as in Example 2-1 except that Solbin CL (trade name, manufactured by Nisshin Chemicals Co., Ltd.) was used in place of Solbin A as the Vinyl chloride/vinyl acetate resin. Solbin CL was used in the same parts by mass as Solbin A as the solid content of a polymer. The test for light resistance was made in the same manner as in Example 2-1, to find that an image sample having good light resistance was also obtained in this example.

### Example 3-1

### Production of an Image-Receiving Sheet

### (1-1) Production of Sample 3101

### Comparative Example

Synthetic paper (trade name: Yupo FPG 200, manufactured by Yupo Corporation, thickness: 200 μm) was used as the support to apply a receptor layer having the following compositions in this order to one surface of this support. The application was carried out such that the amount of the receptor layer after the layer was dried was 4.0 g/m², and the layer was dried at 50° C. for 3 minutes.

Receptor layer

| | |
|---|---|
| Vinyl chloride-series latex | 48 parts by mass |
| (Trade name: Vinybran 609, manufactured by | |
| Nisshin Chemicals Co., Ltd.) | |
| Benzotriazole type ultraviolet absorber latex | 7.5 parts by mass |
| polymer | |
| (Trade name: ULS 1700, manufactured by | |
| Ipposha Oil Industries Co., Ltd.) | |
| Wax montanate | 10 parts by mass |
| (Trade name: J537, manufactured by Chukyo | |
| Yushi Co., Ltd.) | |

### (1-2) Production of Sample 3102

### Present Invention

Sample 3102 was produced in the same manner as in the production of the sample 3101, except that the receptor layer was made to have the following composition.

Receptor layer

| | |
|---|---|
| Vinyl chloride-series latex | 48 parts by mass |
| (Trade name: Vinybran 609, manufactured by | |
| Nisshin Chemicals Co., Ltd.) | |
| Gelatin | 3 parts by mass |
| Benzotriazole type ultraviolet absorber latex | 7.5 parts by mass |
| polymer | |
| (Trade name: ULS 1700, manufactured by | |
| Ipposha Oil Industries Co., Ltd.) | |
| Wax montanate | 10 parts by mass |
| (Trade name: J537, manufactured by Chukyo | |
| Yushi Co., Ltd.) | |

### (1-3) Production of Samples 3103 to 3109 and 3202 to 3206

Samples 3103 to 3109 were produced in the same manner as in the production of the sample 3102 except that the gelatin in the sample 3102 was changed to those shown in Table 4.

Samples 3202 to 3206 were produced in the same manner as in the production of the sample 3102 except that the supports used in the samples 3102 to 3106 were altered to OK Top-Coated Paper (trade name) manufactured by Oji Paper Co., Ltd. as supports having hygroscopicity.

### (Image Formation and Evaluation)

The ink sheet of Reference Example and each image-receiving sheet of the above samples 3101 to 3109 and 3202 to 3206 were superposed on each other such that the ink layer of the former sheet was brought into contact with the receptor layer of the latter sheet, to output an image by using a heat transfer type printer. For the output image, gradations giving gray to each sample were used.

An image was output on each of the image-receiving sheet (A) stored in an environment of 25° C. and 50% before the image was output, and the image-receiving sheet (B) stored in an environment of 50° C. and 80% for 10 days before the image was, output, to evaluate a variation in sharpness associated with the storage prior to outputting.

The sharpness was functionally evaluated by observing both the output of a general image and the output gray fine lines with various line widths and a reflection density of 1.0. As to the output of the general image, a variation between the images of three scenes was evaluated and as to the fine lines, a variation between those having three type of line widths was evaluated by five observers.

Also, as to the image density, an image was output on the samples (3102 or more) in the condition under which the sample 3101 exhibited gray and had a reflection density of 1.5, to measure the density of the image.

Moreover, the above image-receiving sheet (A) on which an image was output was stored in an environment of 60° C. and 70% for 5 days, to evaluate a variation in sharpness associated with the storage prior to outputting in the same manner.

The obtained results are shown in Table 4.

TABLE 4

| | Used water-soluble polymer | | Variation in sharp- | Variation in sharp- | |
|---|---|---|---|---|---|
| Sample | and the amount of use | Image | ness by storage | ness by storage | |
| No. | (parts by mass) | density | before output | after output | |
| 3101 | none | 1.50 | 2 | 3 | Comparative Example |
| 3102 | Gelatin 1 part | 1.50 | 1 | 2 | This invention |
| 3103 | Gelatin 3 parts | 1.48 | 1 | 1 | This invention |
| 3104 | Gelatin 6 parts | 1.47 | 0 | 0 | This invention |
| 3105 | Gelatin 14 parts | 1.47 | 0 | 0 | This invention |
| 3106 | Gelatin 28 parts | 1.38 | 0 | 0 | This invention |
| 3107 | Gelatin 40 parts | 1.30 | 0 | 0 | This invention |
| 3108 | Polyvinyl alcohol | 1.49 | 1 | 2 | This invention |
| | (PVA-105) 3 parts | | | | |
| 3109 | Polyvinyl alcohol | 1.48 | 1 | 1 | This invention |
| | (PVA-105) 6 parts | | | | |
| 3202 | Gelatin 1 part | 1.48 | 2 | 3 | Comparative Example |
| 3203 | Gelatin 3 parts | 1.46 | 2 | 3 | Comparative Example |
| 3204 | Gelatin 6 parts | 1.45 | 2 | 3 | Comparative Example |
| 3205 | Gelatin 14 parts | 1.45 | 1 | 2 | Comparative Example |
| 3206 | Gelatin 28 parts | 1.37 | 1 | 2 | Comparative Example |

Variation in sharpness
0: A variation in sharpness was almost not observed.
1: A variation in sharpness was slightly observed, but it was no problem in practical use.
2: A variation in sharpness was slightly observed, and deterioration of the image quality was recognized.
3: A variation in sharpness was observed, and color bleeding of an image occurred.

As is clear from the results of Table 4, the sample 3101 using a latex polymer without using a water-soluble polymer was reduced in sharpness associated with storing, whereas the samples 3102 to 3109 using a combination of a latex polymer and a water-soluble polymer can be improved in the variation of sharpness associated with storing. However, in the case of the sample 3107 in which the amount of the water-soluble polymer exceeded 30%, the transfer density was slightly dropped though a variation in sharpness was almost not observed. It is found from this result that the effect of improving sharpness is produced even if the amount of the water-soluble polymer to be added is large, but the amount of the water-soluble polymer to be added is preferably 30% or less in view of transfer density.

Further, it was also found that in the case of the samples 3202 to 3206 using the support having no resistance to water, the support absorbed moisture and a trace amount of moisture remained even after drying, causing reduced sharpness even if a combination of the latex polymer and the water-soluble polymer was used.

### Example 3-2

### (2-1) Production of a Sample 3301 (Present Invention) and Evaluation

A sample 3301 was produced in the same manner as in the production of the sample 3102 except that the drying temperature after the application was changed to 110° C.

From the sectional SEM image of the samples 3102 and 3301 after the samples were dried, the grain boundary of a latex was clearly confirmed and the receptor layer was an ununiform film in the case of the sample 3102, whereas in the case of the sample 3301, it was confirmed that the uniformity of a film progressed and a film was formed. These coated products were processed into a 152-mm-wide and 55-m-long roll form with no core, and black solid Dmax print was made by DPB 1500 (trade name, manufactured by Nidec Copal Corporation) to measure visual density. As a result, the following results were obtained.

| | Drying temperature | Density |
|---|---|---|
| Sample 3102 | 0° C. | 1.90 |
| Sample 3301 | 110° C. | 1.81 |

The drying temperature was investigated separately, to confirm from the sectional SEM photography that the latex polymer in the samples 3102 and 3301 was not formed as a film at 90° C. but was formed as a film at 100° C. or more. It was also found that the MFT of each of the samples 3102 and 3301 was 100° C.

Therefore, a higher Dmax is obtained rather in the case that drying at a drying temperature is MFT or less.

### Example 3-3

### (3-1) Production of a sample 3302

### Present Invention

A sample 3302 was produced in the same manner as in the production of the sample 3101 except that the composition of the receptor layer was altered to the following one.

Receptor layer

| | | |
|---|---|---|
| Vinyl chloride-series latex | 48 | parts by mass |
| (Trade name: Vinybran 900, manufactured by | | |
| Nisshin Chemicals Co., Ltd.) | | |
| Gelatin | 3 | parts by mass |
| Emulsion (EMUSTAR) | 1 | part by mass |
| (Trade name: EMUSTAR-042X, manufactured by | | |
| Nippon Seiki Co., Ltd.) | | |
| Hardener (VS-7) | 0.2 | parts by mass |

### (3-2) Production of a Sample 3303

### Comparative Example

A sample 3303 was produced in the same manner as in the production of the sample 3101 except that the composition of the receptor layer was altered to the following one, and the drying temperature after the application was changed to 110° C.

Receptor layer

| | | |
|---|---|---|
| Vinyl chloride-series latex | 48 | parts by mass |
| (Trade name: Vinybran 900, manufactured by | | |
| Nisshin Chemicals Co., Ltd.) | | |
| Gelatin | 3 | parts by mass |
| Emulsion (EMUSTAR) | 1 | part by mass |
| (Trade name: EMUSTAR-042X, manufactured by | | |
| Nippon Seiki Co., Ltd.) | | |
| Hardener (VS-7) | 0.2 | parts by mass |

### (Evaluation)

From the sectional SEM image of the samples 3302 and 3303 after the samples were dried, the grain boundary of a latex was clearly confirmed and the receptor layer was an ununiform film in the case of the sample 3302, whereas in the case of the sample 3303, it was confirmed that the uniformity of a film progressed and a film was formed. These coated products were processed into a 152-mm-wide and 55-m-long roll form with no core, and black solid Dmax print was made by DPB1500 (trade name, manufactured by Nidec Copal Corporation) to measure visual density. As a result, the following results were obtained.

| | Drying temperature | Density |
|---|---|---|
| Sample 3302 | 50° C. | 1.87 |
| Sample 3303 | 10° C. | 1.80 |

Therefore, a higher Dmax is obtained rather in the case that drying at a drying temperature is MFT or less.

### Example 3-4

### (4-1) Production of an Emulsion Dispersion A

The outline of a prepared formulation of an emulsion dispersion A is shown below.

A solution obtained by dissolving the following compounds in ethyl acetate, a high-boiling point organic solvent and a surfactant were added and mixed in a 20% gelatin solution, and the mixture was emulsified using a homogenizer (manufactured by Nippon Seiki Co., Ltd.) to obtain an emulsion.

Emulsion dispersion A

| | |
|---|---|
| 20% gelatin solution | 250 parts by mass |
| EB-9 | 30 parts by mass |
| KF41-410 (trade name, manufactured by | 5 parts by mass |
| Shin-Etsu Chemical Co., Ltd.) | |
| Solv-5 | 9 parts by mass |
| Ethyl acetate | 20 parts by mass |

### (4-2) Production of Sample 3304

### Present Invention

Sample 3304 was produced in the same manner as in the production of the sample 3101, except that the receptor layer was made to have the following composition.

Receptor layer

| | | |
|---|---|---|
| Vinyl chloride-series latex | 48 | parts by mass |
| (Trade name: Vinybran 900, manufactured by | | |
| Nisshin Chemicals Co., Ltd.) | | |
| Gelatin | 3 | parts by mass |
| Emulsion (EMUSTAR) | 1 | part by mass |
| (Trade name: EMUSTAR-042X, manufactured by | | |
| Nippon Seiki Co., Ltd.) | | |
| Hardener (VS-7) | 0.2 | parts by mass |
| Emulsion dispersion A | 8 | parts by mass |

### (4-3) Production of Sample 3305

### Present Invention

Sample 3305 was produced in the same manner as in the production of the sample 3101, except that the receptor layer was made to have the following composition.

| Receptor layer | |
|---|---|
| Vinyl chloride-series latex | 48 parts by mass |
| (Trade name: Vinybran 900, | |
| manufactured by Nisshin | |
| Chemicals Co., Ltd.) | |
| Gelatin | 3 parts by mass |
| Emulsion (EMUSTAR) | 1 part by mass |
| (Trade name: EMUSTAR-042X, | |
| manufactured by Nippon | |
| Seiki Co., Ltd.) | |
| Hardener (VS-28) | 0.2 parts by mass |
| Emulsion dispersion A | 8 parts by mass |

(VS-28)

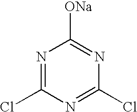

### (4-4) Production of a Sample 3306

### Comparative Example

A sample 3306 was produced in the same manner as in the production of the sample 3101 except that the composition of the receptor layer was altered to the following one, and the drying temperature after the application was changed to 110° C.

Receptor layer

| | | |
|---|---|---|
| Vinyl chloride-series latex | 48 | parts by mass |
| (Trade name: Vinybran 900, manufactured by | | |
| Nisshin Chemicals Co., Ltd.) | | |
| Gelatin | 3 | parts by mass |
| Emulsion (EMUSTAR) | 1 | part by mass |
| (Trade name: EMUSTAR-042X, manufactured by | | |
| Nippon Seiki Co., Ltd.) | | |
| Hardener (VS-7) | 0.2 | parts by mass |
| Emulsion dispersion A | 8 | parts by mass |

### (Evaluation)

From the sectional SEM image of the samples 3304 to 3306 after the samples were dried, the grain boundary of a latex was clearly confirmed and the receptor layer was an ununiform film in the case of the samples 3304 and 3305, whereas in the case of the sample 3306, it was confirmed that the uniformity of a film progressed and a film was formed. These coated products were processed into a 152-nm-wide and 55-m-long roll form with no core, and black solid Dmax print was made by DPB 1500 (trade name, manufactured by Nidec Copal Corporation) to measure visual density. As a result, the following results were obtained.

| | Drying temperature | Density |
|---|---|---|
| Sample 3304 | 50° C. | 1.94 |
| Sample 3305 | 50° C. | 1.95 |
| Sample 3306 | 10° C. | 1.88 |

Therefore, a higher Dmax is obtained rather in the case that drying at a drying temperature is MFT or less.

It was found from the above results that a higher Dmax was obtained by drying at a temperature of MFT or less after the emulsion was applied, than by drying at a temperature of MFT or more after the emulsion was applied. Further, it was also found that when a hardener and an emulsion were added, this effect was produced. Moreover, a high energy saving effect is obtained by dropping the drying temperature into MFT or less.

### Example 4-1

### Production of an Image-Receiving Sheet)

### (1-1) Production of a sample 4101

### Comparative Example

A paper support, on both sides of which polyethylene was laminated, was subjected to corona discharge treatment on the surface thereof, and then a gelatin undercoat layer containing sodium dodecylbenzenesulfonate was disposed on the treated surface. Then, an intermediate layer A having the following composition was applied by a bar coater and dried, and in succession, a receptor layer A having the following composition was applied by a bar coater and dried. The application using a bar coater was carried out at 40° C., and the drying of each layer was carried out at 50° C. for 16 hours. These layers were applied such that the coating amount of each dried layer was made to be as follows: intermediate layer: 1.0 g/m² and receptor layer: 8.0 g/m².

Intermediate layer A

| | | |
|---|---|---|
| Polyester resin | 10 | parts by mass |
| (Trade name: Vylon 200, manufactured by | | |
| Toyobo Co., Ltd.) | | |
| Fluuorescent whitening agent | 1 | part by mass |
| (Trade name: Uvitex OB, manufactured by | | |
| Ciba Specialty Chemicals) | | |
| Titanium oxide | 30 | parts by mass |
| Methyl ethyl ketone/toluene (1/1, at mass ratio) | 90 | parts by mass |

Receptor layer A

| | | |
|---|---|---|
| Vinyl chloride-series latex | 48 | parts by mass |
| (Trade name: Vinybran 609, Nisshin Chemicals | | |
| Co., Ltd.) | | |
| Benzotriazole type ultraviolet absorber latex | 15 | parts by mass |
| polymer | | |
| (Trade name: ULS 1700, manufactured by | | |
| Ipposha Oil Industries Co., Ltd.) | | |
| Wax montanate | 10 | parts by mass |
| (Trade name: J537, manufactured by Chukyo | | |
| Yushi Co., Ltd.) | | |

### (1-2) Production of a Sample 4102

### Comparative Example

A sample 4102 was produced in the same manner as in the production of the sample 4101 except that an intermediate layer B having the following composition was applied by a bar coater such that the amount of the dried intermediate layer B was 15 g/m² and dried, before the intermediate layer A was applied.

Intermediate layer B

| | |
|---|---|
| Hollow latex polymer | 563 parts by mass |
| (Trade name: MH5055, manufactured by | |
| Nippon Zeon Co., Ltd.) | |
| Gelatin | 120 parts by mass |

Here, the hollow latex polymer is a water-dispersion of a polymer having an outside diameter of 0.5 μm and a hollow structure.

### (1-3) Production of a Sample 4103

### Present Invention

A paper support, on both sides of which polyethylene was laminated, was subjected to corona discharge treatment on the surface thereof, and then a gelatin undercoat layer containing sodium dodecylbenzenesulfonate was disposed on the treated surface. Then, an intermediate layer B having the above composition and a receptor layer A were applied simultaneously as a multilayer in the state laminated in this order from the support side, according to the method described in the specification of U.S. Pat. No. 2,761,791. These layers were dried at 50° C. for 16 hours immediately after applied. These layers were applied such that the coating amount of each dried layer was made to be as follows: intermediate layer B: 15 g/m² and receptor layer A: 4.0 g/m².

### (1-4) Production of a Sample 4104

### Present Invention

The simultaneous multilayer coating was carried out in the same manner as in the production of the sample 4103 except that the receptor layer A was altered to the receptor layer B having the following composition. These layers were dried at 50° C. for 16 hours immediately after applied. These layers were applied such that the coating amount of each dried layer was made to be as follows: intermediate layer B: 15 g/m² and receptor layer A: 8.0 g/m².

Receptor layer B

| | |
|---|---|
| Vinyl chloride-series latex | 48 parts by mass |
| (Trade name: Vinybran 609, Nisshin Chemicals | |
| Co., Ltd.) | |
| Benzotriazole type ultraviolet absorber latex | 15 parts by mass |
| polymer | |
| (Trade name: ULS 1700, manufactured by | |
| Ipposha Oil Industries Co., Ltd.) | |
| Wax montanate | 10 parts by mass |
| (Trade name: J537, manufactured by Chukyo | |
| Yushi Co., Ltd.) | |
| Gelatin | 5 parts by mass |

### (Image Formation)

The ink sheet of Reference Example and the image-receiving sheets of the above samples 4101 to 4104 were processed such that each of these sheets could be mounted on a sublimate-type printer (trade name: DPB1500, manufactured by Nidec Copal Corporation) and the printer was set such that a maximum density was obtained in a high speed printing mode to output a black solid image.

### (Dmax Evaluation)

The Visual Density of the Black Solid Image Obtained in the Above Condition was Measured by a Photographic Densitometer (manufactured by X-Rite Incorporated).

### (Evaluation of Image Defects)

The number of white void image defects that can be visually detected on the black solid image obtained in the above condition was measured.

The number of white void image defects 0.5 mm or more in diameter was counted to evaluate the image defect based on the count per one image sheet 12 cm×10 cm in size.

⊚: One or less in the area of 12 cm×10 cm

◯: Two or more and less than 10 in the area of 12 cm×10 cm

Δ: 10 or more and less than 100 in the area of 12 cm×10 cm

x: 100 or more in the area of 12 cm×10 cm

The obtained results are shown in Table 5.

TABLE 5

| | Dmax density | Image defects |
|---|---|---|
| Sample 4101 (Comparative Example) | 1.65 | ◯ |
| Sample 4102 (Comparative Example) | 1.86 | X |
| Sample 4103 (This invention) | 2.15 | ◯ |
| Sample 4104 (This invention) | 2.05 | ◯ |

As is clear from Table 5, the samples 4101 and 4102, which were not obtained by the simultaneous multilayer coating, were respectively reduced in Dmax density and had low sensitivity. Particularly, in the case of the sample 4102 provided with the hollow polymer contained in the intermediate layer, the Dmax density was more slightly improved than in the case of the sample 4101, but a large number of image defects were generated. The reason is that because air cells (air) exist in the intermediate layer containing a hollow polymer after dried in the case of, particularly, the sequential coating carried out every layer by using a bar coater, when it is intended to overlap other layers on the intermediate layer by application in the case of forming the intermediate layer containing a hollow polymer, these air cells form bubbles causing plane defects on the upper layer (receptor layer).

On the other hand, the samples 4103 and 4104 obtained by the simultaneous multilayer coating according to the present invention each had a high Dmax density and high sensitivity. This is because the simultaneous multilayer coating is a cause of decreased plane defects. Moreover, the simultaneous multilayer coating made it possible to produce an image-receiving sheet in a shorter time at a lower cost more efficiently than the sequential coating carried out every layer by using a bar coater.

### Example 4-2

A sample was produced in the same manner as in Example 4-1 except that Vinybran 601 (trade name, manufactured by Nisshin Chemicals Co., Ltd.) was used in place of Vinybran 609 as the vinyl chloride-series latex. Vinybran 601 was used in the same parts by mass as Vinybran 609 as the solid content of a latex polymer. The same evaluation as in Example 4-1 was made to find that good results were also obtained in this embodiment.

### Example 4-3

A sample was produced in the same manner as in Example 4-1 except that Vinybran 270 (trade name, manufactured by Nisshin Chemicals Co., Ltd.) was used in place of Vinybran 609 as the vinyl chloride-series latex. Vinybran 270 was used in the same parts by mass as Vinybran 609 as the solid content of a latex polymer. The same evaluation as in Example 4-1 was made to find that good results were also obtained in this embodiment.

### Example 4-4

A sample was produced in the same manner as in Example 4-1 except that Vinybran 380 (trade name, manufactured by Nisshin Chemicals Co., Ltd.) was used in place of Vinybran 609 as the vinyl chloride-series latex. Vinybran 380 was used in the same parts by mass as Vinybran 609 as the solid content of a latex polymer. The same evaluation as in Example 4-1 was made to find that good results were also obtained in this embodiment.

### Example 4-5

A sample was produced in the same manner as in Example 4-1 except that ULS1635 MH (trade names, manufactured by Ipposha Oil Industries Co., Ltd.) was used in place of ULS1700 as the ultraviolet absorber latex polymer. ULS1635 MH was used in the same parts by mass as ULS1700 as the solid content of a latex polymer. The same evaluation as in Example 4-1 was made to find that good results were also obtained in this embodiment.

### INDUSTRIAL APPLICABILITY

The heat-sensitive transfer image-receiving sheet of the present invention is used in heat transfer recording system.

The heat-sensitive transfer image-receiving sheet of the present invention enables the formation of a high quality image, and is superior in light fastness.

Further, the heat-sensitive transfer image-receiving sheet of the present invention is reduced in transferability changes with time, and can form a recording image reduced in the variation of the transferred image with time.

Further, the heat-sensitive transfer image-receiving sheet of the present invention has high sensitivity, is free from image defects, and can be formed at low costs.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2005-215040 filed in Japan on Jul. 25, 2005, Patent Application No. 2005-216078 filed in Japan on Jul. 26, 2005, Patent Application No. 2005-217593 filed in Japan on Jul. 27, 2005, and Patent Application No. 2005-256698 filed in Japan on Sep. 5, 2005, each of which is entirely herein incorporated by reference.

1. A heat-sensitive transfer image-receiving sheet having a receptor layer comprising:
(a) a polymer or latex polymer including a unit having ultraviolet absorbing ability, or
(b) a latex polymer and a water-soluble polymer.

2. The heat-sensitive transfer image-receiving sheet according to claim 1, wherein the receptor layer comprises the polymer including the unit having ultraviolet absorbing ability.

3. The heat-sensitive transfer image-receiving sheet according to claim 1, wherein the receptor layer comprises the polymer including the unit having an ultraviolet absorbing ability and a receptor polymer capable of being dyed.

4. The heat-sensitive transfer image-receiving sheet according to claim 3, wherein the receptor polymer capable of being dyed is a polymer comprising a vinyl chloride repeating unit as a main chain.

5. The heat-sensitive transfer image-receiving sheet according to claim 1, wherein the receptor layer comprises the latex polymer including the unit having ultraviolet absorbing ability and a receptor latex polymer capable of being dyed.

6. The heat-sensitive transfer image-receiving sheet according to claim 5, wherein the latex polymer including the unit having ultraviolet absorbing ability has a repeating unit less capable of being dyed than the receptor latex polymer capable of being dyed.

7. The heat-sensitive transfer image-receiving sheet according to claim 5, wherein the receptor latex polymer capable of being dyed is a latex polymer comprising a vinyl chloride repeating unit as a main chain.

8. The heat-sensitive transfer image-receiving sheet according to claim 1, wherein at least one said receptor layer comprising the latex polymer and the water-soluble polymer is formed on a waterproof support by application.

9. The heat-sensitive transfer image-receiving sheet according to claim 8, wherein the ratio of the water-soluble polymer is 30% by mass or less of all polymers contained in the receptor layer.

10. The heat-sensitive transfer image-receiving sheet according to claim 8, wherein a drying temperature of the heat-sensitive transfer image-receiving sheet after the application is Minimum Filmforming Temperature (MFT) or less.

11. The heat-sensitive transfer image-receiving sheet according to claim 8, wherein a coating layer formed on the support by application is hardened with a hardener.

12. The heat-sensitive transfer image-receiving sheet according to claim 8, wherein a coating layer formed on the support by application contains an emulsion.

13. A heat-sensitive transfer image-receiving sheet comprising a support and at least one intermediate layer and a receptor layer which are formed in this order on the support, wherein the sheet is formed by applying the intermediate layer and the receptor layer simultaneously as a multilayer on the support.

14. The heat-sensitive transfer image-receiving sheet according to claim 13, wherein the intermediate layer contains a hollow polymer having a particle diameter of 0.1 to 20 μm.

15. A method of producing a heat-sensitive transfer image-receiving sheet, the method comprising forming a receptor layer on a support by applying the following mixture (a) or (b):
(a) a mixture of a latex prepared by suspending a polymer containing a unit having ultraviolet absorbing ability in water, and a latex prepared by suspending a receptor polymer capable of being dyed in water, or
(b) a mixture prepared by dissolving a polymer containing a unit having ultraviolet absorbing ability and a receptor polymer capable of being dyed, in a solvent.

16. The method of producing a heat-sensitive transfer image-receiving sheet according to claim 15, the method comprising preparing a latex by suspending the polymer containing a unit having ultraviolet absorbing ability in water, while preparing other latex by suspending the receptor polymer capable of being dyed in water, and applying a mixture of both latexes on the support to form the receptor layer.

17. The method of producing a heat-sensitive transfer image-receiving sheet according to claim 15, the method comprising forming the receptor layer on the support by applying a mixture prepared by dissolving the polymer including a unit having an ultraviolet absorbing ability and the receptor polymer capable of being dyed, in a solvent.

18. A method of producing a heat-sensitive transfer image-receiving sheet, the method comprising the steps:
applying a coating solution comprising a latex polymer and a water-soluble polymer, on a water proof support to form at least one receptor layer, and
drying the heat-sensitive transter image-receiving sheet after at least one rceptor layer is formed by application on the support at a temperature of Minimum Filmforming Temperature (MFT) or less.

19. The method of producing a heat-sensitive transfer image-receiving sheet according to claim 18, wherein a hardener is added to the coating solution to be applied.

20. The method of producing a heat-sensitive transfer image-receiving sheet according to claim 18, wherein the coating solution contains an emulsion dispersion, and the coating solution is applied on the support.

21. A method of producing a heat-sensitive transfer image-receiving sheet, the method comprising applying at least one intermediate layer and a receptor layer simultaneously as a multilayer on a support.
